(19) United States
(12) Patent Application Publication
(10) Pub. No.: US 2016/0031766 A1
(43) Pub. Date: Feb. 4, 2016

(54) CALCIUM-ALGINATE ENTRAPPED NANOSCALE ZERO-VALENT IRON (NZVI)

(71) Applicants: Achintya BEZBARUAH, (US); Talal Bakheet ALMEELBI, (US); Michael QUAMME, (US); Eakalak KHAN, Fargo, ND (US)

(72) Inventors: Achintya Bezbaruah, West Fargo, ND (US); Talal Bakheet Almeelbi, Yanbu (SA); Michael Quamme, Fargo, ND (US); Eakalak Khan, Fargo, ND (US)

(73) Assignee: NDSU RESEARCH FOUNDATION, Fargo, ND (US)

(21) Appl. No.: 14/775,109

(22) PCT Filed: Mar. 14, 2014
(86) PCT No.: PCT/US14/28469

§ 371 Date: Sep. 11, 2015

Related U.S. Application Data
(60) Provisional application No. 61/791,045, filed on Mar. 15, 2013.

(51) Int. Cl. C05G 3/00; C05D 9/02; C02F 1/28; C05B 17/00

(52) U.S. Cl. CPC C05G 3/0047; C05B 17/00; C05D 9/02; C02F 1/281; C02F 1/288; C02F 2101/105

(57) ABSTRACT

Nanoscale zero-valent iron (NZVI) particles or Ca-alginate-entrapped NZVI, are provided for use in environmental remediation, decontamination, and pollution control. When charged with a sorbed nutrient such as phosphate or selenium, they can be used as fertilizer.

This application claims the benefit of U.S. Provisional Application Ser. No. 61/791,045, filed Mar. 15, 2013, which is incorporated by reference herein.

### STATEMENT OF GOVERNMENT RIGHTS

This invention was made with government support under Grant No. CMMI-1125674, awarded by the National Science Foundation. The government has certain rights in the invention.

### BACKGROUND

In recent years, nanoscale zero-valent iron (Fe^{o}(nZVI) particles have been used for the removal of various groundwater contaminants including chlorinated compounds, pesticides, heavy metals, and explosives, in water. nZVI has received attention because of its unique reactive and sorptive characteristics. The most basic and known form of NZVI is spherical Fe⁽⁰⁾, which has dimensions less than 100 nm. Iron nanoparticles used for environmental remediation have particle sizes in the range of 12.5-80 nm. NZVI particles have much higher reactive surface areas when compared to other larger iron particles, micro particles and iron fillings which make them useful for environmental remediation. The BET surface areas of NZVI reported in literature range between 25-54 m²g⁻¹compared to 1-2 m²g⁻¹ for micro iron particles. Nanoscale zero-valent Iron (NZVI) particles have been used to remediate a wide range of environmental contaminants including chlorinated compounds, heavy metals, pesticides and explosives as well as arsenic (Tanboonchuy et al., 2011, Env. Sci. Poll. Res. 18(6):857-864), methyl orange, cadmium, and lead.

Advantages of nZVI over other zero-valent iron (ZVI) such as microparticles (mZVI) and iron filings include higher reactive surface area (25-54 m²g⁻¹for nZVI and 1 m²g⁻¹for mZVI), faster and more complete reactions, and injectability into the aquifer. However, when used in groundwater remediation, nZVI particles have been known to become undesirably mobile. They can also agglomerate, causing a reduction in the reactive surface area and sedimentation.

Entrapment within calcium (Ca) alginate beads is one of the most common methods for immobilizing living cells in food and beverage industries. Ca-alginate hydrogels and microbeads are also used for drug delivery. In addition, Ca-alginate entrapped bacterial and fungal cells have been used to remediation heavy metals and nitrogen. Alginate entrapped surfactants, activated carbon, and metal hydroxides (Fe³⁺ and Ni²⁺) have been used to recover/treat aqueous copper, organics, and arsenic, respectively. Moreover, alginate is nontoxic, biodegradable, and nonimmunogenic, and produces thermally irreversible and water insoluble gels. See Bezbaruah et al., J. Haz. Mat. 166:1339-1343 (2009), and references cited therein.

Some of the problems associated with bare nZVI, such as their mobility and tendency to agglomerate, have been addressed by entrapping the nZVI within calcium (Ca) alginate beads. Bezbaruah et al. showed that iron nanoparticles can be effectively entrapped in a biopolymer matrix (alginate) without significant reduction in their reactivity. nZVI were entrapped within alginate beads to reduce their mobility/sedimentation in the aquifer, and examined using nitrate as a test contaminant. Bezbaruah et al., J. Haz. Mat. 166:1339-1343 (2009).

Eutrophication of lakes and other natural bodies of water, caused by the presence of excess nutrients, is a growing problem. Phosphate is delivered to surface and ground water as a result of agricultural and feedlot run-offs, and municipal and industrial wastewaters. Treatment of domestic and agro-industrial wastewater often releases large amounts of phosphorus and nitrogen into water. Excess phosphorous concentration (>1.0 mg/L P) in water bodies causes eutrophication of aquatic ecosystems, which results in deterioration of water quality (Smith 2003). Therefore, it is important to reduce phosphorous concentrations in water to improve water quality.

On the other hand, phosphorus is essential for plant growth and is an important constituent of agricultural fertilizers. Phosphorous is typically obtained by mining inorganic phosphate rock, such as apatite, followed by chemical treatment to produce phosphoric acid, thereby generating phosphate. These natural supplies of inorganic phosphate are, however, diminishing. With increasing world population the demand of phosphorous for food production is estimated to peak sometime between 2030 and 2040. It is predicted that world phosphorous production will begin to decline around 2035. The consequent possible shortfall of phosphorous fertilizers is a major concern for global food security.

In recent years phosphate recovery using adsorbent technologies has been gaining momentum. Iron is a non-toxic metal with the capability of adsorbing phosphate efficiently. The most commonly used low cost adsorbents are iron based adsorbents, red mud, natural ores and alum slag. The biggest concern associated with these adsorbents is their low adsorption capacity. Natural ores like calcite are reported to have a sorption capacity of 0.1 mM PO₄³⁻/g (i.e., 3.1 mg PO₄³⁻-P/g). Goethite (FeOOH, 17.3 mg PO₄³⁻-P/g), active red mud (9.8 PO₄³⁻-P/g), and activated carbon (3.02 mg PO₄³⁻-P/g) are the most effective sorbents so far used for the removal of phosphate. Aqueous phosphate removal has also been achieved using bare and calcium-alginate entrapped nZVI. Almeelbi et al., Proceedings of the World Environmental and Water Resources Congress 2011: Bearing Knowledge for Sustainability, Beighley (ed.), Palm Springs, Calif. (2011).

### SUMMARY OF THE INVENTION

The present invention provides compounds, compositions, systems, and methods for dispersing and suspending nanoscale zero-valent iron (NZVI) particles or Ca-alginate-entrapped NZVI in aqueous environments for use in environmental remediation, decontamination, and pollution control. When charged with a sorbed nutrient such as phosphate or selenium, they can be used as fertilizer. Methods of making and using said compounds, compositions, and systems are also provided.

In one aspect the invention provides methods for removing a contaminant from an aqueous medium including contacting the aqueous medium with a remediation material that includes bare NZVI particles or Ca-alginate entrapped NZVI under conditions for a time effective to sorb the contaminant. In some embodiments, the contaminant includes a phosphorous containing compound, a selenium containing compound, an arsenic containing compound, or any combination thereof In exemplary embodiments, the contaminant may include orthophosphate (PO₄³⁻), hydrogen phosphate (HPO₄²⁻), dihydrogen phosphate, (H₂PO₄⁻), magnesium ammonium phosphate (MgNH₄PO₄·6H₂O, struvite), hydroxyapatite, a polyphosphate, an organic phosphate, a selenate, Se(VI), SeO₄⁻², a selenite, Se(IV), HSeO₃, elemental selenium, a selenide, (Se-II), Se²⁻, HSe⁻, As(III), As(V) or any combination thereof.

In some embodiments, the aqueous medium is a eutrophic lake, municipal and industrial wastewater, agricultural runoff, effluent from water or sewer treatment plants, acid mine drainage, sludge, groundwater, a reservoir, well water, a marsh, swamp, a bay, an estuary, a river, a stream, an aquifer, a tidal or intertidal area, a sea or an ocean. In exemplary embodiments, the pH of the aqueous medium is higher than 7.5.

The remediation material may be disposed within a stationary treatment medium including a permeable reactive barrier, a slurry wall, a filtration bed, or a filter. In certain embodiments, the remediation material is formulated as a bead.

The method may include collecting the used remediation material that includes a sorbed contaminant. In some embodiments, the aqueous medium includes surface water or groundwater, and the contaminant includes arsenic. Optionally, the aqueous medium includes an aquifer or well water.

The method may also include applying the used remediation material including a sorbed contaminant including a nutrient to soil as a fertilizer. In an exemplary embodiment, the nutrient includes a phosphorous containing compound, a selenium containing compound, or a combination thereof.

In another aspect the present invention provides a method for increasing the nutrient content of a soil. The method includes applying a remediation material including bare NZVI particles or Ca-alginate entrapped NZVI, and at least one sorbed nutrient, to a soil. The nutrient may include a phosphorous containing compound or selenium containing compound, or combination thereof The method may further include transporting the remediation material to the soil application site. In some embodiments, a plant disposed in the soil takes up at least one nutrient selected from the group consisting of phosphorus, selenium and iron, or a combination thereof, from the remediation material. In some embodiments, the nutrient may be released over time as the remediation material degrades.

In yet another aspect the invention provides a method for making a fertilizer. The method may include collecting a remediation material including bare NZVI particles or Ca-alginate entrapped NZVI and at least one sorbed contaminant including a nutrient from a remediation site. In exemplary embodiments, the nutrient includes a phosphorous containing compound, a selenium containing compound, or a combination thereof.

The invention also provides a NZVI particles or Ca-alginate entrapped NZVI, and at least one sorbed contaminant including a nutrient. In some embodiments of the fertilizer composition, the nutrient includes a phosphorous containing compound, a selenium containing compound, or a combination thereof.

The invention also provides methods of using the fertilizer composition which are useful for increasing the amount of bioavailable phosphate, selenium or iron, or combination thereof, in a soil.

Alternative methods for making the fertilizer composition may include identifying an aqueous medium that includes a phosphorus-containing compound or a selenium containing compound, or both; contacting the aqueous medium with a remediation material that includes bare NZVI particles or Ca-alginate entrapped NZVI, under conditions and for a time effective to sorb the compound onto the remediation material to yield a charged remediation material; and incorporating the charged remediation material into a fertilizer composition.

Unless otherwise specified, “a,” “an,” “the,” and “at least one” are used interchangeably and mean one or more than one.

### BRIEF DESCRIPTION OF THE FIGURES

FIG. 1A shows high-resolution transmission electron microscopy (HRTEM) image of NZVI. FIG. 1B shows particle size distribution of the nanoparticles synthesized was 10-30 nm with an average size of 16.24±4.05 nm (n=109). FIG. 1C shows X-ray diffraction (XRD) spectrum of NZVI with prominent peaks for Fe⁰. Peaks for oxides are from Fe-oxide layer on the NZVI, and the FeCl₃ peak is from residuals of raw materials used in NZVI synthesis.

FIG. 2 shows phosphate removal by NZVI/L from bulk solutions with different initial phosphate concentrations ( [symbol] 10 mg PO₄³⁻-P/L, [symbol] 5 mg PO₄³⁻-P/L , [symbol] 1 mg PO₄³⁻-P/L, [symbol] Blank). NZVI=400 mg/L.

FIG. 3 shows phosphate sorption by NZVI under various pH conditions. Lower pH is more conducive for phosphate adsorption while desorption is the dominant phenomenon at higher pH.

FIG. 4 shows the effect of initial NZVI concentration on phosphate removal. Initial PO₄³⁻-P=5 mg/L.

FIG. 5A shows phosphate removal under different ionic strength conditions ( [symbol] 0 mM ionic strength, [symbol] 5 mM ionic strength, [symbol] 10 mM ionic strength). FIG. 5B shows phosphate removal in the presence of nitrate ( [symbol] 0 mg NO₃⁻-N/L, [symbol] 1 mg NO₃⁻-N/L, [symbol] 5 mg NO₃⁻-N/L, [symbol] 10 mg NO₃⁻-N/L). FIG. 5C shows phosphate removal in the presence of sulfate ( [symbol] 0 mg SO₄²⁻/L, [symbol] 100 mg SO₄²⁻/L, [symbol] 500 mg SO₄²⁻/L, [symbol] 900 mg SO₄²⁻/L). FIG. 5D shows phosphate removal in the presence of natural organic matter ( [symbol] 0 mg NOM/L, [symbol] 1 mg NOM/L, [symbol] 10 mg NOM/L, [symbol] 50 mg NOM/L). FIG. 5E shows phosphate removal in the presence of humic acids [symbol] 0 mg/L, [symbol] 1 mg/L, [symbol] 10 mg/L, [symbol] 50 mg/L). For all figures: [symbol] Blank, NZVI=400 mg/L, Initial PO₄³⁻-P=5 mg/L.

FIG. 6 shows the effect of temperature on phosphate removal by NZVI, [symbol] 4° C., [symbol] 22° C., [symbol] 60° C., [symbol] Blank with only PO₄³⁻ solution). NZVI=400 mg/L, Initial PO₄³⁻-P=5 mg/L. Blank shown here is for 22° C. only. The blanks at other temperatures followed similar trends and not shown here to maintain clarity.

FIG. 7 shows the effect of ZVI particles size on phosphate removal ( [symbol] Micro-ZVI, [symbol] NZVI, [symbol] Blank). MZVI=5 g/L; NZVI=400 mg/L; Equal ZVI surface area concentrations (10 m²/L) were used for both MZVI and NZVI, Initial PO₄³⁻-P=5 mg/L.

FIG. 8 shows phosphate removal and recovery using NZVI ( [symbol] Removal, [symbol] Blank in removal experiment (PO₄³⁻ solution), [symbol] Recovery, [symbol] Control in recovery experiment (pH adjusted DI water+fresh NZVI)). NZVI=400 mg/L, Initial PO₄³⁻-P=5 mg/L. Control for the removal experiment was DI water with NZVI; no phosphate was detected in the sample, and the data points coincided with the control for the recovery experiment.

FIG. 9 shows the adsorption capacity of phosphate adsorption by NZVI.

FIG. 10 shows a schematic of hydroponic system setup

FIG. 11 shows an experimental set-up for the hydroponic system for spinach studies.

FIG. 12 shows a schematic of the experimental design

FIG. 13 shows an XPS spectra of (a) virgin NZVI, (b) spent NZVI, after PO43-adsorption

FIG. 14 shows an HR-XPS survey on the Fe 2p for virgin NZVI and spent NZVI.

FIG. 15A shows an EDS spectrum of Virgin NZVI. FIG. 15B shows an EDS spectrum of spent NZVI

FIG. 16 shows Chl a concentrations at 0 and 28 days. Treatments are as follows: (1) DI Water, (2) All Nutrients, (3) All nutrients (No PO₄³⁻), (4) All nutrients (No PO₄³⁻)+spent NZVI (with PO₄³⁻ sorbed onto NZVI), and (5) All nutrients+Virgin NZVI

FIG. 17A shows germinated seeds after 5 d. The percent of seed germination varied from 72 to 100%. FIG. 17B shows plant seedlings in a sand bed.

FIG. 18 shows the length of roots and shoots after 30 d of hydroponic growth. Control 1: All nutrients, Blank: All nutrients but no PO₄³⁻ and Fe.

FIG. 19 shows plants after 30 d of hydroponic treatment. FIG. 19A shows plants that were supplied with all nutrients. FIG. 19B shows plants that were supplied with all nutrients, but no PO₄³⁻ and Fe. FIG. 19C shows plants that were supplied with all nutrients, but no PO₄³⁻ and Fe, +Spent NZVI.

FIG. 20 shows the weights of roots, stems, and leaves.

FIG. 21 shows Fe and P analysis data in control and spent NZVI treatments. FIG. 21A shows Fe in stems and leaves; FIG. 21B shows P in stems and leaves; FIG. 21C shows Fe and P in roots; FIG. 21D shows total Fe in stems and leaves; FIG. 21E shows total Fe in roots; and FIG. 21F shows total P in stems, leaves, and roots. Biomass was measured for each plant separately.

FIG. 22 shows an SEM image a fresh dry FCA beads.

FIG. 23 shows removal of PO₄³⁻ from WTPE using bare NZVI and FCA beads.

FIG. 24 shows PO₄³⁻ Removal from animal AFLE using NZVI and FCA beads.

FIG. 25 shows PO₄³⁻ Removal from AFLE using NZVI and FCA beads over a 24 h period.

FIG. 26 shows a schematic of zero-valent iron (ZVI) and the adsorption or reduction of selenium.

FIG. 27A shows particles size distribution of the nanoparticles synthesized. FIG. 27B shows the particle size ranged from 9-29 nm and the average size is 16.24±4.05 nm (n=109),=. FIG. 27C shows an XRD spectrum of NZVI with prominent peaks for Fe⁰ at 44.5°. Other peaks for oxides are from Fe-oxide layer on the NZVI, and the FeCl₃ used in NZVI synthesis.

FIG. 28 shows batch study results for selenium samples with an initial concentration of 34 μg/L with bare and Ca-alginate coated NZVI at 3.0 and 12.0 hours.

FIG. 29 shows selenium (Se) removal by NZVI

FIG. 30 shows selenium (Se) Removal by Entrapped NZVI.

FIG. 31A shows bioavailability of spent NZVI. Treatments are as follows: (1). Nutrient solution; (2) Nutrient solution+2 mg L-1 Se; and (3) Nutrient solution+spent NZVI.

FIG. 31B shows bioavailability of spent NZVI. Treatments are as follows: (1) Nutrient solution; (2) Nutrient solution+2 mg L-1 Se; and (3) Nutrient solution+spent NZVI.

FIG. 32 shows a schematic of Ca-alginate bead preparation process.

FIG. 33A shows a synthesized NZVI. The particles are present as agglomerated groups. FIG. 33B shows particle size distribution of the synthesized nanoparticles.

FIG. 34 shows a scanning electron microscopy image of a Ca-alginate bead interior (inset: Ca-alginate bead with entrapped NZVI).

FIG. 35 shows removal of As(V) by bare NZVI ( [symbol] ) and entrapped NZVI ( [symbol] ). Observation of change of pH over time indicate initial increase of pH in the presence of both bare NZVI ( [symbol] ) and entrapped NZVI ( [symbol] ). FIG. 35A shows initial As(V)=1 mgL⁻¹; FIG. 35B shows initial As(V)=5 mgL⁻¹; and FIG. 35C shows initial As(V)=10 mgL⁻¹. The straight lines joining the data points are for ease of reading only and do not represent trend lines. The vertical error bars indicate±standard deviations.

FIG. 36 shows a schematic of possible mechanisms of As(V) removal by NZVI.

FIG. 37 shows X-ray diffraction results for bare NZVI, entrapped NZVI, and alginate beads under different conditions. Alginate-NZVI-As: Alginate entrapped NZVI that sorbed arsenic; NZVI-As: Bare NZVI that sorbed arsenic; NZVI: Bare NZVI not exposed to arsenic; Alginate: Ca-alginate bead (no NZVI inside and no arsenic); Iron: Zero-valent iron (modeling data); Magnetite: Magnetite (modeling data).

FIG. 38 shows FT-IR analysis data for bare NZVI, entrapped NZVI, and alginate beads under different conditions.

FIG. 39 shows types of metal-carboxylate coordination. (a) an ionic or uncoordinated form, (b) unidentate coordination, (c) bidentate chelating coordination, and (d) bidentate bridging coordination

### DETAILED DESCRIPTION OF ILLUSTRATIVE EMBODIMENTS

The present invention provides a remediation material for the collection and sequestration of phosphates, selenium, arsenic and other contaminants from contaminated aqueous environments. Advantageously, phosphate, selenium, and other nutrients thereby collected can be recycled as an agricultural fertilizer. The invention thus provides for both environmental remediation/decontamination, as well as reuse of recovered contaminants. This is a green technology that follows the principles of “reduce, reuse and recycle.” It represents a sustainable practice that facilitates efficient recovery of used or wasted nutrients, and is well suited to the needs of the fertilizer industry, municipalities and pollution control agencies.

### Remediation Material

Nanoscale zero-valent iron (NZVI) particles and polymer-entrapped NZVI, preferably calcium-alginate (Ca-alginate) entrapped NZVI, preferably in the form of beads, are used for the removal and recovery of aqueous contaminants, including but not limited to phosphorus, selenium and arsenic. High flow rates and through put can be achieved, making remediation economically feasible. NZVI and Ca-alginate entrapped NZVI are easy to transport, store, and recover. Moreover, these remediation materials are biodegradable. NZVI and Ca-alginate entrapped NZVI that have been used to adsorb phosphate or selenium from contaminated waters can be recovered and reused, for example as fertilizer. When used a fertilizer, NZVI or Ca-alginate entrapped NZVI supply not only the adsorbed nutrient (e.g., phosphate or selenium), but also iron. Release of nutrients (e.g., phosphate, selenium and iron) takes place over time, thereby providing a time-released action. Additionally, the nutrients are supplied in a bioavailable form and can be effectively taken up by plants and microorganisms.

In one embodiment, the remediation material is composed of bare NZVI particles. Methods for synthesizing NZVI particles are exemplified in the following examples and in Almeelbi et al. (2012 J. Nanopart. Res. 14:900). Typically the nanoparticles are from 10 to 500 nm in diameter, more typically from 10 to 200 nm in diameter, more typically from 10 to 100 nm in diameter.

In another embodiment, the remediation material is composed of NZVI particles entrapped or encapsulated in a polymer, preferably a natural polymer such as alginate, collagen, carboxymethylchitin, chitin, cellulose, pectin, agarose, chitosan, carrageenan, and plant-derived gums, in order to enhance biodegradability and increase the “green” content of the remediation material. Synthetic polymers can be employed as well, in addition to or in place of natural polymers. Examples of suitable synthetic polymers include polyacrylate, poly(methyl methacrylate) (PMMA), polyvinyl acetate, and polyvinyl alcohol. Methods for producing Ca-alginate-entrapped NZVI are exemplified in Bezbaruah et al., 2009 J. Haz. Mat., 166:1339-134, and in the examples below. Methods for producing Ca-alginate-encapsulated NZVI are exemplified in Bezbaruah et al., 2011 J. Nanopart. Res, 13:6673-6681, and in the examples below.

Alginates, natural polysaccharides obtained from brown marine algae and/or seaweed by collection, extraction, or otherwise, are particularly preferred for use in the invention because of their abundance, ease of use, and biocompatibility. Alginates are useful for water remediation because they are inexpensive, non-toxic, porous and biodegradable (Bezbaruah et al., 2009 J. Haz. Mat. 166:1339-1343; Bezbaruah et al., 2011 J. Nanopart. Res., 13:6673-6681). Alginates readily form complexes with cations such as sodium and calcium. In the presence of multivalent cations (e.g., calcium and iron) alginate undergoes a sol-gel transition due to the presence of carboxyl groups.

Entrapment also controls the dispersibility by containing particles to larger polymer structures while we still benefit from the unique properties of nanomaterials (e.g. increased surface area). Furthermore, Ca-alginate polymer is non-toxic, biodegradable and has little to no solubility in water making it ideal for treatment purposes.

### Methods and Systems for Contaminant Recovery

The remediation material of the invention is used for removal of a contaminant from an aqueous medium. The contaminant is sorbed onto the bare NZVI or a polymer-entrapped NZVI such as Ca-alginate-entrapped NZVI, and removed from the aqueous medium. In one embodiment, the contaminant is a phosphorus (P)-containing compound. Phosphates that can be removed, for example, include, but are not limited to, orthophosphates, polyphosphates and organic phosphates. Preferably, the phosphate that is removed is a phosphorous-containing anion, such as orthophosphate (PO₄³⁻), hydrogen phosphate (HPO₄²⁻), dihydrogen phosphate, (H₂PO₄⁻), magnesium ammonium phosphate (MgNH₄PO₄·6H₂O, struvite), hydroxyapatite, a polyphosphate and/or an organic phosphate. In another embodiment, the contaminant that can be removed is selenium, including selenate, Se(VI) (e.g., SeO₄⁻²); selenite, Se(IV) (e.g., HSeO₃); elemental selenium, Se; or selenide, Se(-II), (e.g., Se²⁻, HSe⁻). In yet another embodiment, the contaminant that can be removed is arsenic, particularly As(III) and As(V).

Contact between the remediation material and the contaminated aqueous media can be static, as in a batch process, or can involve the flow of the aqueous media over or through the bare NZVI or a polymer-entrapped NZVI such as Ca-alginate-entrapped NZVI. Aqueous media can flow naturally over or through the remediation material of the invention, or the aqueous media to be decontaminated can be pumped over or through the remediation material. Employment of bare NZVI or a porous polymer-entrapped NZVI such as Ca-alginate-entrapped NZVI as a remediation material allows high flow rates and through put to be achieved, making remediation economically feasible. Because of the fast removal times, the bioremediation material is well suited for applications that involve pumping the aqueous media. Polymer-entrapped NZVI, such as Ca-alginate entrapped NZVI, is particularly useful in high flow settings because the alginate matrix prevents or inhibits agglomeration and/or sedimentation of the NZVI. Bare NZVI or a polymer-entrapped NZVI, such as Ca-alginate-entrapped NZVI, can be used as an environmental remediation agent in any and all remediation methods that are known to the art. For example, the bare NZVI or a polymer-entrapped NZVI beads can be injected into the soil, groundwater or a well, used as a matrix for a filtration mechanism, such as a cylinder, canister, or the like, applied as groundcover or into a trench, and/or utilized as a component of a deposit, layer, treatment zone, permeable or slurry wall or barrier, such as a permeable reactive barrier or slurry wall, filtration bed, or the like.

Examples of aqueous media that can be decontaminated with bare NZVI or a polymer-entrapped NZVI, such as Ca-entrapped NZVI, include eutrophic lakes, municipal and industrial wastewater, agricultural runoff, effluent from water or sewer treatment plants, mine waste including acid mine drainage (AMD), sludge, groundwater, reservoirs, well water, marshes, swamps, bays, estuaries, rivers, streams, aquifers, tidal or intertidal areas, seas, oceans and the like.

Examples of aqueous media that may be high in phosphate and/or selenium include wastewater treatment plant effluent (WTPE) and animal feedlot effluent/runoff (AFLE). High flow rate/high throughput systems that incorporate bare NZVI or a polymer-entrapped NZVI, such as Ca-alginate-entrapped NZVI, can remove phosphate and/or selenium quickly and efficiently from these wastewaters. For example, we have shown that bare NZVI can adsorb up to 130 mg Se per g of bare NZVI. Ca-entrapped NZVI can adsorb 20 mg Se per g of entrapped NZVI. Although the sorption capacity for Ca-entrapped NZVI is lower than for bare NZVI, Ca-entrapped NZVI can be recovered more easily because they are not as mobile as the bare particles. Mining wastewater, such as acid mine drainage (AMD) is also a wastewater that can be quickly and effectively decontaminated using bare NZVI or a polymer-entrapped NZVI, such as Ca-alginate-entrapped NZVI. Typical levels of contaminants found in AMD are 1,300 mg L⁻¹ SO4²⁻, 0.12 mg L⁻¹ PO₄³⁻, and 0.13 mg L⁻¹ As(V).

Example of aqueous media from which arsenic can be removed include groundwater, including aquifers, and drinking water; acid mine drainage can also be efficiently decontaminated using the bioremediation material of the invention.

Fast removal times allow NZVI or a polymer-entrapped NZVI, such as Ca-alginate-entrapped NZVI, to be used for large scale decontamination of lakes and other surface waters, such as by pumping or recycling the water through large filtration systems at water treatment stations. Likewise, fast removal times make the bioremediation materials of the invention well-suited for use at industrial or municipal water treatment facilities, to clean up effluent prior to discharge, or to purify water for industrial or consumer use.

The bioremediation material of the invention is thus well-suited for use in both large and small scale treatment facilities, as well as in field operations. In some embodiments, most (e.g., over 80%, or over 90%, or over 95%) of the phosphate, selenium and/or arsenic is removed with the first 10-30 minutes of contact with bare NZVI or a polymer-entrapped NZVI, such as Ca-alginate-entrapped NZVI. Example 1 describes the use of nanoscale zero-valent iron (NZVI) for phosphate removal and recovery from aqueous media. Phosphate removal in 30-min NZVI batch studies was 96-100%. Maximum phosphate recovery of ˜78% was achieved in 30 min at pH 12. In some embodiments, concentration of NZVI for use as a remediation material ranges for 5 mg/L to 1000 mg/L, 10 mg/L to 1000 mg/L, 20 mg/L to 800 mg/L, 50 mg/L to 500 mg/L or any value in between. In some embodiments, the sorption capacities of NZVI after 10-min interaction with the aqueous solution containing phosphate are between 1 and 50 mg PO₄³⁻-P/g for 1, 5, or 10 mg PO₄³⁻-P/L solutions. When employed in or as a filter or in a filtration system, the detention or hydraulic retention time is therefore short (e.g., less than an hour, more preferably, less than 30 minutes), making bioremediation material of the invention well-suited for use in high flow systems (e.g., with high flow rate pumps).

Two of the major sources of phosphate in surface water are wastewater effluent (point-source) and animal feedlot runoff (nonpoint-source). This effluent with high concentration of P finds its way to lakes and surface waters. Wastewater treatment plant effluent (WTPE) and animal feedlot effluent/runoff (AFLE) samples were tested in phosphate removal studies, as described in the examples. NZVI removed 84% of the PO₄³⁻ in 2 h from WTPE. A fast removal rate was observed with NZVI used to remove phosphate from AFLE (57% in the first hour). The high flow rates that can be used with the bioremediation material of the invention, together with their biodegradability and usefulness in both removal and recovery/reuse of contaminants, position these materials as ideally suited for use in any and all existing water treatment applications.

In applications where there is no further use for the adsorbed contaminant, such as in arsenic removal applications, the NZVI or a polymer-entrapped NZVI, such as Ca-alginate-entrapped NZVI can be readily collected and disposed of Further, in embodiments that utilize polymer-entrapped NZVI, such as Ca-alginate-entrapped NZVI, the contaminant is sequestered within the bead, and its toxicity is thereby reduced.

### Recovery of Nutrients, Bioavailability, and Use as Fertilizer

Bare NZVI or a polymer-entrapped NZVI, such as Ca-alginate-entrapped NZVI that has been used to remove contaminants such as phosphorus and selenium, i.e., which has been “charged” with phosphate, selenium and/or other nutrients, can be used as an agricultural fertilizer. Advantageously, as noted above, alginate is biodegradable; thus, used or spent NZVI or polymer-entrapped NZVI, such as Ca-alginate-entrapped NZVI beads, can be use directly as fertilizer, without the need for extracting the phosphate or other nutrient(s) that have been sorbed onto the particle or bead (although the invention also encompasses extraction or desorption of nutrient from the bead for use as or incorporation into a fertilizer, if desired). The nutrient bound by the bare NZVI or a polymer-entrapped NZVI is bioavailable and accessible without further modification for plant and microbial uptake. The biodegradable particles or beads release the adsorbed nutrient as they degrade, making the nutrient bioavailable on a time release basis for plants and other organisms. Moreover, the iron present in NZVI is also bioavailable and accessible without further modification for plant and microbial uptake. As the particles or beads degrade, iron is made bioavailable for plants and other organisms on a time release basis as well. Thus, charged NZVI or a polymer-entrapped NZVI beads are expected to have utility as possible materials for slow release fertilizers. The charged NZVI-containing particles or beads can be applied in the field using any convenient method, either in the spring prior to planting, during the growing season, or in the fall. They can be mixed with other nutrients, fertilizers, or additives, or applied separately. Illustrative compositions and methods for using a recovered nutrient such as phosphate as fertilizer are described in de-Bashan et al., 2007 First International Meeting on Microbial Phosphate Solubilization, Developments in Plant and Soil Sciences 102:179-184.

Surprisingly, both iron from the NZVI and the adsorbed nutrient (e.g., phosphate and selenium) were found to be released (e.g., by desorption or degradation), readily taken up by plants and algae, and in a bioavailable form that can be effectively utilized by the plant and algae for growth. The nutrient(s) and the iron are released over time, providing a built-in time release mechanism when used as a fertilizer. No further modification to the spent or “charged” bioremediation material is needed; it can be transported, distributed and employed as a fertilizer directly after being used to remove the nutrient(s) from the contaminated water source.

The dual functionality of the NZVI or polymer-entrapped NZVI, such as Ca-alginate-entrapped NZVI, makes them especially valuable. Not only are they useful in environmental remediation, decontamination, pollution control and the like but, when charged with an adsorbed nutrient such as phosphate or selenium, they can be used as fertilizer. The new technology can thus be used to recover phosphates or other anions from eutrophic lakes, agricultural run-offs, and municipal and industrial wastewaters, and the like as detailed herein; after which the particles or beads that have adsorbed a nutrient such selenium or phosphate can be used as a fertilizer in agricultural fields as a source of that nutrient, as well as an iron source.

The following are exemplary embodiments of the invention:

Embodiment 1. A method for removing a contaminant from an aqueous medium comprising contacting the aqueous medium with a remediation material comprising bare nanoscale zero-valent iron (NZVI) particles or Ca-alginate entrapped NZVI under conditions and for a time effective to sorb the contaminant.

Embodiment 2. The method of embodiment 1 wherein the remediation material is formulated as a bead.

Embodiment 3. The method of embodiment 1 or 2 wherein the contaminant comprises a phosphorous containing compound, a selenium containing compound, an arsenic containing compound, or any combination thereof.

Embodiment 4. The method of embodiment 3 wherein the contaminant comprises orthophosphate (PO₄³⁻), hydrogen phosphate (HPO₄²⁻), dihydrogen phosphate, (H₂PO₄⁻), magnesium ammonium phosphate (MgNH₄PO₄·6H₂O, struvite), hydroxyapatite, a polyphosphate, an organic phosphate, a selenate, Se(VI), SeO₄⁻², a selenite, Se(IV), HSeO₃, elemental selenium, a selenide, (Se-II), Se²⁻, HSe⁻, As(III), As(V) or any combination thereof.

Embodiment 5. The method of any of the previous embodiments wherein the aqueous medium is a eutrophic lake, municipal and industrial wastewater, agricultural runoff, effluent from water or sewer treatment plants, acid mine drainage, sludge, groundwater, a reservoir, well water, a marsh, swamp, a bay, an estuary, a river, a stream, an aquifer, a tidal or intertidal area, a sea or an ocean.

Embodiment 6. The method of any of the previous embodiments wherein the pH of the aqueous medium is higher than 7.5.

Embodiment 7. The method of any of the previous embodiments wherein the remediation material is disposed within a stationary treatment medium.

Embodiment 8. The method of embodiment 7, wherein the stationary treatment medium comprises a permeable reactive barrier, a slurry wall, a filtration bed, or a filter.

Embodiment 9. The method of any of the previous embodiments further comprising collecting the used remediation material, wherein the used remediation material comprises a sorbed contaminant.

Embodiment 10. The method of any of the previous embodiments further comprising applying the used remediation material to soil as a fertilizer, wherein the used remediation material comprises a sorbed contaminant, and wherein the sorbed contaminant comprises a nutrient.

Embodiment 11. The method of embodiment 10 wherein the nutrient comprises a phosphorous containing compound, a selenium containing compound, or a combination thereof.

Embodiment 12. The method of any of embodiments 1 to 9, wherein the aqueous medium comprises surface water or groundwater, and wherein the contaminant comprises arsenic.

Embodiment 13. The method of embodiment 12 wherein the aqueous medium comprises an aquifer or well water.

Embodiment 14. A method for increasing the nutrient content of a soil, the method comprising applying a remediation material comprising bare nanoscale zero-valent iron (NZVI) particles or Ca-alginate entrapped NZVI, and at least one sorbed nutrient, to a soil.

Embodiment 15. The method of embodiment 14 wherein the nutrient comprises a phosphorous containing compound or selenium containing compound, or combination thereof.

Embodiment 16. The method of embodiment 14 or 15 further comprising transporting the remediation material to the soil application site.

Embodiment 17. The method of embodiment 14 or 15, wherein a plant disposed in the soil takes up at least one nutrient from the remediation material, wherein the nutrient is selected from the group consisting of phosphorus, selenium and iron, or a combination thereof.

Embodiment 18. The method of any of embodiments 14, 15 or 17 wherein the nutrient is released over time as the remediation material degrades.

Embodiment 19. A method for making a fertilizer comprising collecting from a remediation site a remediation material comprising bare nanoscale zero-valent iron (NZVI) particles or Ca-alginate entrapped NZVI, and at least one sorbed contaminant, wherein contaminant comprises a nutrient.

Embodiment 20. The method of embodiment 19 wherein the nutrient comprises a phosphorous containing compound, a selenium containing compound, or a combination thereof.

Embodiment 21. A fertilizer composition comprising bare nanoscale zero-valent iron (NZVI) particles or Ca-alginate entrapped NZVI, and at least one sorbed contaminant, wherein contaminant comprises a nutrient.

Embodiment 22. The fertilizer composition of embodiment 21 wherein the nutrient comprises a phosphorous containing compound, a selenium containing compound, or a combination thereof.

Embodiment 23. A method for increasing the amount of bioavailable phosphate, selenium or iron, or combination thereof, in a soil, the method comprising contacting the soil with the fertilizer composition of embodiment 21 or 22.

Embodiment 24. A method for making a fertilizer comprising identifying an aqueous medium comprising a phosphorus-containing compound or a selenium containing compound, or both; contacting the aqueous medium with a remediation material comprising bare nanoscale zero-valent iron (NZVI) particles or Ca-alginate entrapped NZVI, under conditions and for a time effective to sorb the compound onto the remediation material to yield a charged remediation material; and incorporating the charged remediation material into a fertilizer composition.

### EXAMPLES

The present invention is illustrated by the following examples. It is to be understood that the particular examples, materials, amounts, and procedures are to be interpreted broadly in accordance with the scope and spirit of the invention as set forth herein.

In the certain of the examples described below, bare NZVI particles and Ca-alginate entrapped NZVI beads were used for the removal and recovery of phosphate. Batch studies indicated a removal of 95-100% phosphate in 30 minutes (1, 5 and 10 mg phosphate-P/L with 400 mg NZVI/L). Phosphate removal efficiency by NZVI was 14 times higher compared to microscale ZVI (MZVI) particles. The successful rapid removal of phosphate by NZVI form aqueous solution is expected to have great ramifications so for cleaning up nutrient rich waters. The presence of sulfate, nitrate and humic substances and the change in ionic strength in the water only marginally affected phosphate removal by NZVI. A maximum phosphate recovery of 78% was achieved in 30 min at pH 12. The NZVI that absorbed the phosphate was then used as a source of phosphate and iron for plants and algae. It was found that phosphate and iron were bioavailable. It is therefore expected that bare NZVI and alginate entrapped NZVI can be used to remove phosphate from aqueous solution, after which the iron media can be used as a phosphate-iron fertilizer.

### Example 1

### Aqueous Phosphate Removal using Bare Nanoscale Zero-valent Iron

Nanoscale zero-valent iron (NZVI) particles have been used for the remediation of a wide variety of contaminants. NZVI particles have high reactivity because of high reactive surface area. In this study, NZVI slurry was successfully used for phosphate removal and recovery. Batch studies conducted using different concentrations of phosphate (1, 5, and 10 mg PO₄³⁻-P/L with 400 mg NZVI/L) removed ˜96 to 100% phosphate in 30 minutes. Efficacy of the NZVI in phosphate removal was found to 13.9 times higher than micro-ZVI particles (MZVI) with same NZVI and MZVI surface area concentrations used in batch reactors. Ionic strength, sulfate, nitrate, and humic substances present in the water affected in phosphate removal by NZVI but they may not have any practical significance in phosphate removal in the field. Phosphate recovery batch study indicated that better recovery is achieved at higher pH and it decreased with lowering of the pH of the aqueous solution. Maximum phosphate recovery of ˜78% was achieved in 30 minutes at pH 12. The successful rapid removal of phosphate by NZVI from aqueous solution is expected to have great ramification for cleaning up nutrient rich waters.

### Introduction

Phosphorus (P) exists in water in both particulate and dissolved forms. The usual forms of P in aqueous solutions are orthophosphates, polyphosphates and organic phosphates (Mezenner and Bensmail, 2009 Chem Eng J 147:87-96). Phosphorus is necessary for the growth of organisms and plants and is an indicator of surface water quality. Excessive P present in natural waters is known to cause eutrophication (Penn and Warren, 2009 Soil Sci Soc Am J 73:560-568). Eutrophication results in the depletion of oxygen that leads to fish death and affects other aquatic life forms adversely. The major point sources that contribute to P built up in aquatic environment include municipal and industrial wastewaters. Run-offs from agriculture, including animal agriculture, are the major non-point sources. The amount of P compounds in these sources should be controlled to prevent eutrophication in lakes and other surface waters. Accelerated eutrophication not only affects the aquatic life but indirectly hinders the economic progress of communities that depend on aquatic food and other resources (Cleary et al., 2009 World Acad Sci Eng Technol 52:196-199). Dissolved phosphate of ˜0.02 mg/L is considered to have potential that lead to profuse algal growth in waters (USEPA, “Ecological Restoration: A Tool to Manage Stream Quality,” 1995 Report EPA 841-F-95-007, US EPA, Washington, DC, USA).

On the other hand, phosphorus is one of the required nutrients for plants. P-based fertilizers are extensively used in food crops and it is intricately related to global food security. Phosphorous for fertilizer production comes predominantly from select mines from Morocco, Western Saharan region, and China (Cordell et al., 2009 Glob Environ Change-Human Policy Dimens 19:292-305). Phosphorus is a nonrenewable resource. While an assessment of future consumption of phosphorus fertilizers indicates that natural phosphate (PO₄³⁻) deposits will last for approximately 60-240 years (Cornel and Schaum, 2009 Water Sci Technol 59:1069-1076), P production rate is predicted to decline sometime in year 2035 while the demand for P-based fertilizers is on the rise (Cordell et al., 2011 Chemosphere 84:747-758). Short supply of P-fertilizer is a major concern in food security area. It is, therefore, essential recover P from ‘wastes’ for possible reuse in agriculture.

Chemical precipitation (de-Bashan and Bashan, 2004 Water Res 38:4222-4246), physico-chemical processes (Mishra et al., 2010 J Sci Ind Res 69:249-253), and enhanced biological phosphate removal (Gouider et al., 2011 Water Environ Res 83:731-738) are the frequently used techniques to remove aqueous phosphate. Among them chemical treatment methods for aqueous phosphate removal are widely practiced using chemicals like lime (Ahn and Speece, 2006 Environ Technol 27:1225-1231), alum (Babatunde and Zhao, 2010 J Hazard Mater 184:746-752), and ferric chloride (Caravelli et al., 2010 J Hazard Mater 177:199-208). However, the high cost of chemicals and problems associated with sludge management make these methods unattractive for waters containing high amounts of phosphate (for example, wastewater with a typical total P of 4-14 mg/L, Tchobanoglous et al., Wastewater Engineering: Treatment And Reuse. 4th ed. 2003 McGraw-Hill, New York, N.Y., USA).

Sorption has emerged as a viable option for phosphate removal from aqueous media. In the recent years considerable amount of emphasis has been put on the use of low cost (ad)sorbents. Cost effectiveness is identified as the prime criterion in the selection of a sorption technology whether it uses synthetic or natural sorbents (Mishra et al., 2010 J Sci Ind Res 69:249-253). Phosphate can be removed from water using sorbents such as oxides of iron, natural ores like calcite, and goethite (FeOOH), active red mud, and activated carbon. One of the problems encountered with these sorbents is that they have very low sorption capacities. For example, sorption capacities of iron oxides are 11.2 mg PO₄³⁻/g (Yan et al., 2010 J Hazard Mater 179:244-250) and 19.02 mg PO₄³⁻-P/g (Cordray, “Phosphorus removal characteristics on biogenic ferrous iron oxides,” 2008 Master's Thesis, Washington State University, USA). Similarly, natural ores like calcite was reported to have a sorption capacity of 0.1 mM PO₄³⁻/g (i.e., 3.1 mg PO₄³⁻-P/g, Karageorgiou et al., 2007 J Hazard Mater 139:447-452). Goethite (FeOOH, 17.3 mg PO₄³⁻-P/g, Chitrakar et al. 2006), active red mud (9.8 PO₄³⁻-P/g, Yue et al., 2010 J Hazard Mater 176:741-748), and activated carbon (3.02 mg PO₄³⁻-P/g, Hussain et al., 2011 Desalination 271:265-272) are so far tried for P removal.

In the last two decades nanoscale zero-valent iron (NZVI) particles have received a lot of attention because of their unique reactive and sorptive characteristics (Bezbaruah et al., 2009 J Hazard Mater 166:1339-1343; Bezbaruah et al., 2011 J Nanopart Res 13:6673-6681; Li et al., 2006 Crit Rev Solid State 31:111-122). NZVI particles show good sorptive characteristics owing to their high surface to volume ratio (Yan et al., 2010 J Contam Hydrol 118:96-104). However, most of the reported work on sorption by NZVI has been on metalloids and heavy metals including some actinides (Giasuddin et al., 2007 Environ Sci Technol 41:2022-2027; Kanel et al., 2005 Environ Sci Technol 39:1291-1298; Klimkova et al., 2011 Chemosphere 82:1178-1184; Scott et al., 2011 J Hazard Mater 186:280:287) and, to the best of authors' knowledge, there is no literature on phosphate removal and subsequent recovery using NZVI.

In this study we evaluated the efficacy of NZVI particles for phosphate removal and recovery from aqueous solutions. Phosphate removal was tried under different environmental conditions (temperature, ionic strength), and in the presence of interfering ions and organic compounds. Effect of particle size on phosphate removal was studied. Batch experiments were conducted under different pH conditions to investigate the optimal pH conditions for phosphate recovery from NZVI.

### Materials and Methods

### Chemicals and Reagents

Iron (III) chloride hexahydrate (FeCl₃·6H₂O, 98%, Alfa Aesar), sodium borohydride (NaBH₄, 98%, Aldrich), methanol (production grade, BDH), calcium chloride (CaCl₂, ACS grade, BDH), monopotassium phosphate (KH₂PO₄, 99%, EMD), potassium nitrate (KNO₃, 99%, Alfa Aesar), sodium hydroxide (5 N NaOH, Alfa Aesar), potassium sulfate (K₂SO₄, ACS grade, HACH), natural organic matter (Suwannee River NOM, RO isolation, IHSS), and humic acid (H1452, Spectrum) were used as received unless and otherwise specified.

### Synthesis of NZVI

NZVI particles were synthesized using sodium borohydride reduction method (Eq. 1, Huang and Ehrman, 2007 Langmuir 23:1419-1426).

2FeCl₃+6NaBH₄+18H₂O→2Fe⁰+21H₂+6B(OH)₃+6NaCl (1)

Ferric chloride hydrate (1.35 g) was dissolved in 40 mL of deoxygenated de-ionized (DI) water (solution A), and 0.95 g of sodium borohydride was dissolved in 10 mL of deoxygenated DI water in a separate beaker (solution B). Then solution A was added drop wise to solution B under vigorous stirring conditions (using a magnetic stirrer). The resultant black precipitates (NZVI) were centrifuged and washed with copious amount of deoxygenated DI water. The NZVI in slurry form was then stored in 20 mL vials in methanol to prevent oxidation, and used for experiments later. NZVI slurry in the vials was withdrawn using a pipette after vigorous stirring. The average weight of dry NZVI present in 1 mL well stirred slurry was measured to be 20 mg±0.6 mg (n=25).

### Phosphate Removal Batch Studies

Batch experiments were conducted using (a) NZVI, and (b) microscale zero-valent iron (MZVI) particles. Phosphate solution (50 mL of 1, 5, and 10 mg PO₄³⁻-P/L) with 20 mg of NZVI (i.e., 400 mg/L) in multiple 50 mL polypropylene plastic vials fitted plastic caps (reactors). The reactors were rotated end-over-end at 28 rpm in a custom-made shaker to reduce mass transfer resistance. One of the reactors was withdrawn at specific time interval (0, 10, 20, 30 and 60 min) and the content was centrifuged at 4000 rpm. Bulk solution was collected for phosphate analysis from this reactor and reactor was sacrificed or used for phosphate recovery study (see ‘Phosphate recovery batch studies’). Ascorbic acid method (Eaton et al., Standard Methods For The Examination Of Water And Wastewater 21st ed. 2005 American Public Health Association, Washington, DC, USA) was used for phosphate analysis. This method depends on the formation phosphomolybdic acid during the reaction between orthophosphate and molybdate. Ascorbic acid reduces phosphomolybdic to form a blue complex. The color was measured in a UV-vis spectrophotometer (HACH, DR 5000) at wavelength of 880 nm. A five-point calibration was done routinely.

### Effect of Initial NZVI Concentration

Batch studies were conducted with six different NZVI concentrations (80, 160, 240, 320, 400, 480, and 560 mg/L) for an initial bulk PO₄³⁻-P concentration of 5 mg/L. The experimental procedure described earlier (see ‘Phosphate removal batch studies’) was followed. Samples were withdrawn for phosphate analysis at 30 min.

### Interference Studies

The effects ionic strength, presence of selected anions and cations, and humic substances were examined Batch studies were conducted in room temperature (22±2° C.) using 400 mg NZVI/L and 40 mL of solution with an initial bulk phosphate concentration of 5 mg PO₄³⁻-P/L. Sampling frequency was maintained as described earlier (see ‘Phosphate removal batch studies’).

The ionic strength was varied from 0 to 10 mM by adding specific amounts of CaCl₂ to the phosphate solution. The range of ionic strength was selected to represent groundwater conditions. The possible interference due to the presence of other important ions was also studied using two important anions (sulfate and nitrate). Potassium sulfate was used as the source of SO₄²⁻ (0, 100, 500, 900 mg/L). The effect of NO₃⁻ (0, 1, 5, 10 mg NO3⁻-N /L) was studied by adding KNO₃. Humic substances present in water may affect phosphate removal by NZVI, and to evaluate such impacts Suwannee River (USA) natural organic matter (0, 1, 10, 50 mg/L) and humic acids (0, 1, 10, 50 mg/L) were used in separate batch experiments. The batch experiments were conducted as described earlier (see ‘Phosphate removal batch studies’).

### Effect of Temperature

Experiments were conducted under deferent temperatures conditions (4, 22, and 60° C.) to find out the effect of temperature change on phosphate removal by NZVI. The temperature of phosphate solution was first adjusted to the desired temperature by keeping it in the specific environment for long enough periods (˜24 h). NZVI particles (400 mg/L) were added to phosphate solution (40 mL, 5 mg/L) once the specific temperature was reached. Samples were shaken at 100 rpm under temperature-controlled environment using an incubator-cum-orbital shaker (Thermo Scientific, MaxQ4000).

### Effect of Particle Size

Effect of zero-valent iron (ZVI) particle size on phosphate removal was evaluated using NZVI particles synthesized within this research and microscale zero-valent iron (MZVI) particles purchased from a supplier (Aldrich, 99.9% purity, used as received). ZVI reactions are known to be surface mediated (Thompson et al., 2010 Environ Eng Sci 27:227-232), and as such it was ensured that the same surface area concentrations were used in the experiments conducted with NZVI and MZVI. The NZVI particles used in this experiment had a surface area of ˜25 m²/g (Bezbaruah et al., 2009 J Hazard Mater 166:1339-1343) and MZVI had a surface area of ˜2 m²/g (reported by the manufacturer). NZVI and MZVI surface area concentration of 10 m²/L (400 mg/L NZVI and 5 g/L MZVI) was used in the study.

### Phosphate Recovery Batch Studies

An initial batch study was conducted to find out the pattern of desorption (recovery) of phosphate into water from NZVI used for phosphate removal. Batch experiments were run first in 50 mL plastic vials fitted a plastic cap (reactors) with 400 mg/L NZVI and 50 mL of 5 mg PO₄³⁻-P/L to get the phosphate sorbed onto NZVI. The batch reactors were withdrawn after 60 min and centrifuged to separate the spent NZVI (i.e., NZVI particles with phosphate sorbed onto them). The bulk solution was decanted out and phosphate concentration was measured. A 50 mL DI water was added to the spent NZVI and the pH was manipulated (2-12) with either 0.1 N HCl or NaOH. The reactors were closed and rotated end-over-end for 30 min. The reactors with the samples were then centrifuged and concentration of phosphate was measured in the bulk solution. The optimal pH for phosphate recovery (i.e., when maximum phosphate recovery) was determined based on this initial batch study results, and the rest of the phosphate recovery experiments were conducted at that particular (optimal) pH.

Additional batch studies were conducted in sacrificial reactors at the optimal pH, and phosphate recovery was monitored over time (0, 10, 20, and 30 min). The data obtained from the removal experiments were normalized with respect to the original bulk phosphate concentration. For the data sets from the recovery studies, the initial phosphate concentration was calculated based on the mass of phosphate sorbed onto the NZVI and the data were normalized with respect to that.

### NZVI Characterization

X-ray diffraction (XRD) was done to find out NZVI composition. The samples were placed in stainless steel sample holders and XRD patterns were recorded using CuKα radiation (λ=1.5418A°) on a Philips X'Pert diffractometer operating at 40 kV and 40 mA between 5° and 90° (2θ) at a step size of 0.0167° (Xi et al., 2010 Mater Res Bull 45:1361-1367).

High-resolution transmission electron microscopy (HRTEM, JEOL JEM-2100-LaB6 TEM) was used to observe the shape of NZVI particles and determine their particle size. NZVI particles were vacuum dried and the dry particles were placed in ethanol and sonicated for 5 min to achieve proper dispersion. Drops of the resulting solution were placed onto lacey carbon grids (Electron Microscopy Sciences, USA) and allowed to dry. Images were taken using a Gatan ORIUS large format CCD camera.

### Quality Control

All experiments were done in triplicates during this research and the average values are reported along with the standard deviations. Blanks with only phosphate (without NZVI/MZVI) were run along with the NZVI and MZVI experiments. The analytical instruments and tools were calibrated before the day's measurements. One-way ANOVA tests were performed to compare the variance between data sets as needed. Additionally, Dunnett Method was used to compare control with rest of the treatment data. Minitab 16 software (Minitab, USA) was used for all statistical analyses.

### Results and Discussion

### NZVI Synthesis and Characterization

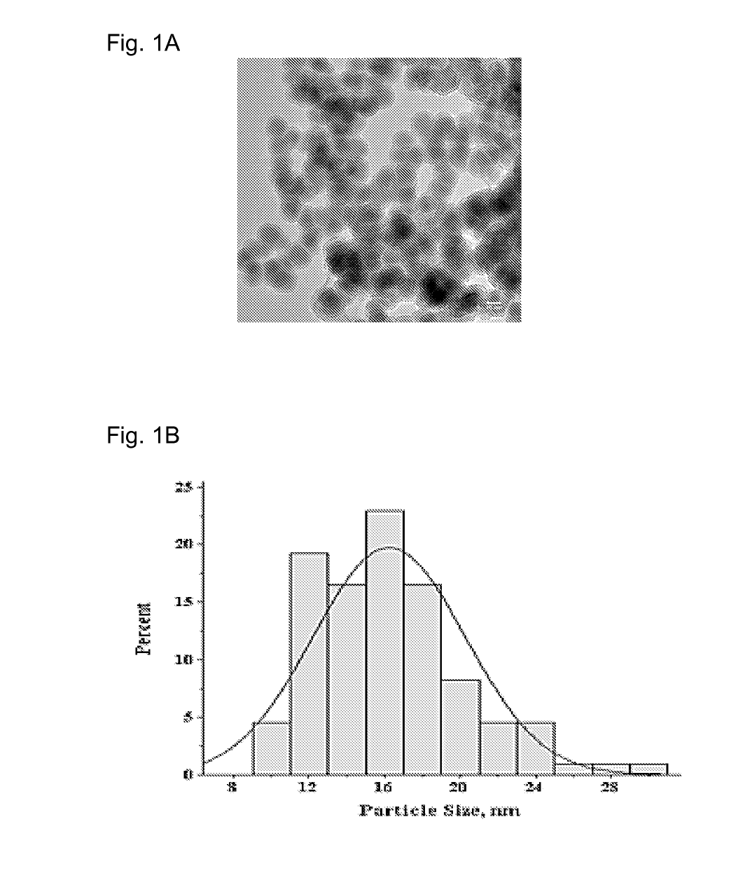

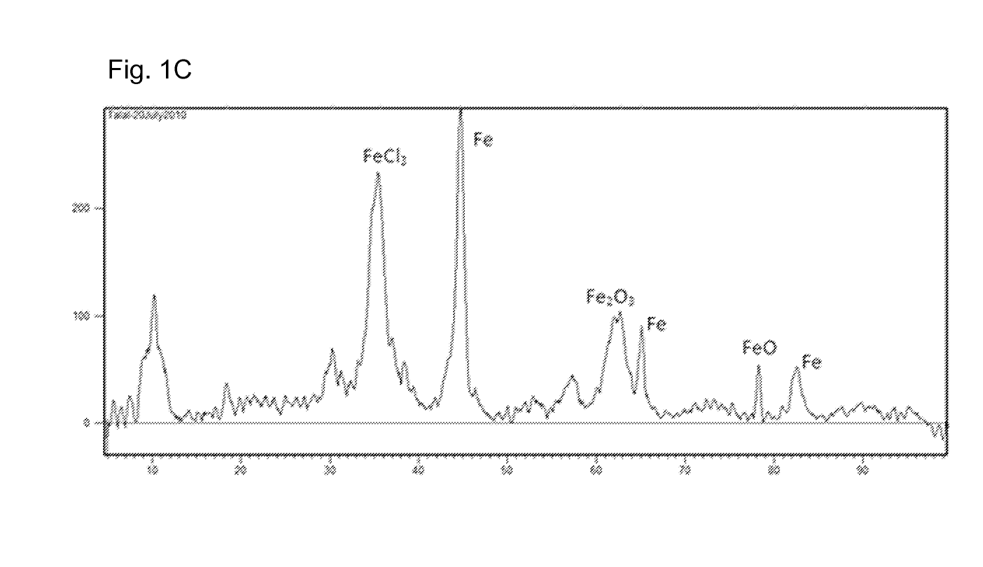

NZVI synthesized (FIG. 1a) during this research were mostly spherical in shape and had particle size distribution from 10 nm to 30 nm with an average size of 16.24±4.05 nm (n=109, FIG. 1b). Huang and Ehrman (2007 Langmuir 23:1419-1426) reported particle size of 20 nm using the same method. The XRD spectrum (FIG. 1c) for the particles synthesized during this study shows three peaks of zero-valent iron (Fe⁰). A couple of iron oxide peaks were also observed which might be because of exposure of the particles to air during the XRD experiment. During the synthesis of NZVI, the particles were not bled with air as in Bezbaruah et al. (2009 J Hazard Mater 166:1339-1343; and 2011 J Nanopart Res 13:6673-6681) but there is still a possibility that a thin oxide layer around the particles was formed due to reaction with atmospheric oxygen. A peak for iron chloride was also observed which might be from the left over reactants used for the synthesis of NZVI (see Eq. 1).

### Phosphate Removal

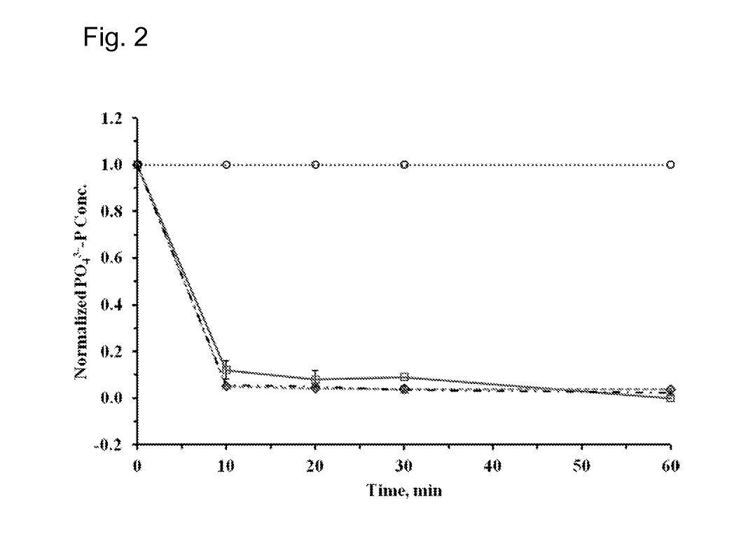

Batch experiments were conducted for phosphate removal using 400 mg/L NZVI and different phosphate concentrations (1, 5, 10 mg PO₄³⁻-P/L). Rapid phosphate removal was observed in the first a few minutes of the experiment for all three concentrations. About 88-95% of phosphate was removed within the first 10 min and only minimal removal was observed beyond that (FIG. 2). Blanks didn't show any removal of phosphate. Three consecutive data points (20, 30, and 60 min) showed no major change (maximum 2.7% variation) in phosphate removal for the two higher concentrations (5 and 10 mg PO₄³⁻-P/L) while a much larger variation (˜7.8% from 20 to 60 min) was observed for 1 mg PO₄³⁻-P/L. While complete (100%) phosphate removal was observed for 1 mg PO₄³⁻-P/L solution, 96.29±0.13 and 97.53±0.16 percent removals were observed for 5 and 10 mg PO₄³⁻-P/L, respectively. The sorption capacities at 60 min were found to be 2.27±0.00, 12.00±0.02, and 24.38±0.04 mg/g for 1, 5, and 10 mg PO₄³⁻-P/L, respectively. The sorption capacity increased linearly (R²=0.9999) with the increase in phosphate concentration.

For 5 mg PO₄³⁻-P/L, 30 min was found to be long enough time to achieve equilibrium with 400 mg NZVI/L. As such all experimental data for 5 mg PO₄³⁻-P/L and 400 mg NZVI/L were collected up to 30 min. Iron-based removal techniques are reported by others where 15-100% phosphate removal has been achieved (Table 1). Hydroxides of iron were found to be most effective in the removal process but a wide range of efficiency (15-100%) has been reported (Chitrakar et al., 2006 J Colloid Interf Sci 298:602-608; Cordray, “Phosphorus removal characteristics on biogenic ferrous iron oxides,” 2008 Master's Thesis, Washington State University, USA; Mezenner and Bensmaili, 2009 Chem Eng J 147:87-96; Yan et al., 2010 J Hazard Mater 179:244-250). Synthetic goethite (α-FeOOH) was found to remove up to 1 mg P/L completely (100%) from NaH₂PO₄ solution (Chitrakar et al., 2006 J Colloid Interf Sci 298:602-608). Again 100% phosphate removal was observed with akaganeite (β-FeOOH) up to 0.3 mg P/L. It took 2-8 h to reach equilibrium in most of the reported phosphate removal experiments done with DI/distilled/wastewater (Mezenner and Bensmaili, 2009 Chem Eng J 147:87-96; Chitrakar et al., 2006 J Colloid Interf Sci 298:602-608; Xiong et al., 2008 J Hazard Mater 152:211-215; Yan et al., 2010 J Hazard Mater 179:244-250) but took 24 h to reach equilibrium in seawater (Chitrakar et al., 2006 J Colloid Interf Sci 298:602-608). It is pertinent here to discuss treatment time in other sorption systems for comparison purposes. Hussain et al. (2011 Desalination 271:265-272) reported 95% removal of phosphate with granular activated carbon over a 150-min period. Sorption of ˜95% of phosphate on calcite in 45 min was reported by Karageorgiou et al. (2007 J Hazard Mater 139:447-452).

In the present study, very fast removal of phosphate (88-95% in 10 min) was achieved, and that makes this research very relevant for continuously flowing (pumped) water (i.e., required contact time will be short). The sorption capacities of NZVI after 10-min interaction with the aqueous solution containing phosphate were found to be 2.20±0.06, 11.87±1.20, and 23.62±0.11 mg/g for 1, 5, and 10 mg PO₄³⁻-P/L solutions, respectively. The sorption capacities of 3.02-19.02 mg PO₄³⁻-P/g reported by others (Chitrakar et al., 2006 J Colloid Interf Sci 298:602-608; Cordray, “Phosphorus removal characteristics on biogenic ferrous iron oxides,” 2008 Master's Thesis, Washington State University, USA; Hussain et al., 2011 Desalination 271:265-272; Karageorgiou et al., 2007 J Hazard Mater 139:447-452; Yan et al., 2010 J Hazard Mater 179:244-250; Yan et al., 2010 J Contam Hydrol 118:96-104) are comparable to the sorption capacities achieved for the NZVI in this study. However, the reaction time is much shorter with NZVI.

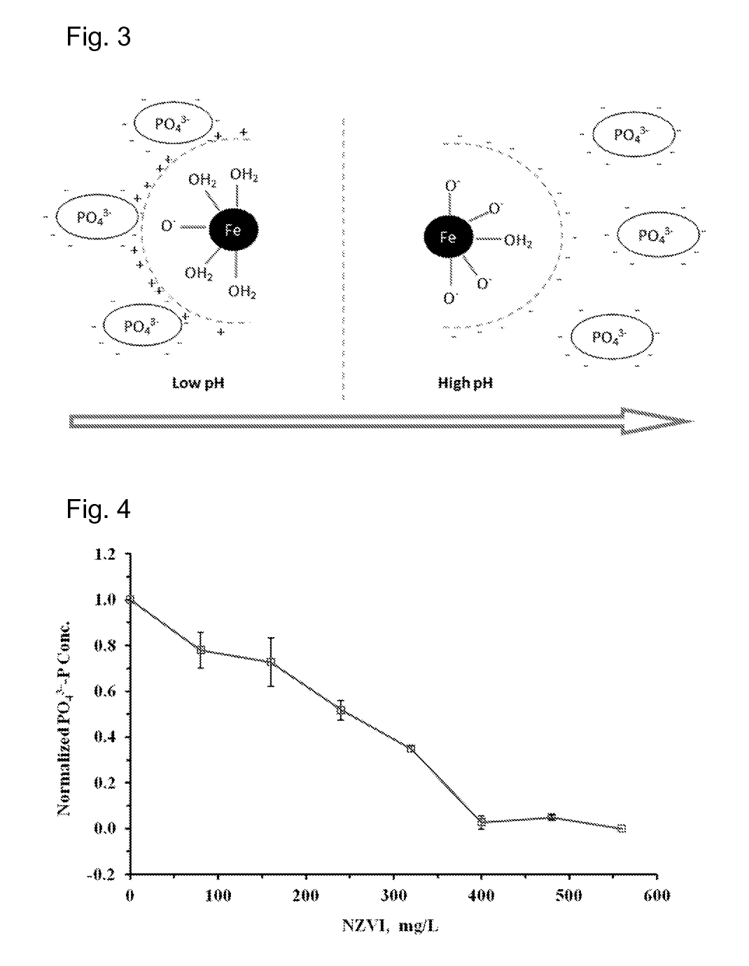

The mechanism of phosphate removal by NZVI in the present study can be explained based on point of zero charge (PZC) and ligand exchange (Eq. 2, Karageorgiou et al., 2007 J Hazard Mater 139:447-452, and FIG. 3). PZC for NZVI is around 7.7 (Giasuddin et al., 2007 Environ Sci Technol 41:2022-2027), and when pH is less than PZC the surface of NZVI is positively charged which makes the surface suitable for anion (PO4³⁻) sorption. The initial pH of the test solutions used in this study was ˜4.0 and final pH after 60 min reaction was ˜7.5 which was still lower than the PZC of NZVI. The pH environment maintained in the reactor was ideal for PO₄³⁻ sorption and that is why 97.53-100% removal was achieved in this study.

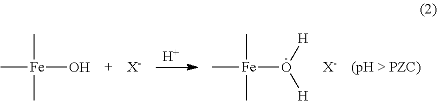

### Effect of Initial NZVI Concentration

The removal of phosphate (C₀=5 mg/L) was found to increase with increase in the initial NZVI concentration (FIG. 4) and followed a linear trend (R²=0.9539) as NZVI concentration increased from 0 to 560 mg/L. NZVI concentration beyond 400 mg/L didn't improve PO₄³⁻ removal significantly. Phosphate removal of 100% was obtained for using 560 mg NZVI/L. When the initial NZVI concentration was increased from 80 to 560 mg/L, the removal of phosphate increased by ˜78%. The increase in phosphate removal efficiency with the increase in NZVI concentration was expected as the contaminant removal by NZVI is a surface area mediated process. When NZVI concentration increased from 0 to 560 mg/L the reactive iron surface area in solution increased from 0 to 14 m²/L (NZVI surface area=25 m²/g). The observations are consistent with findings by others with sorption media where surface area controls the sorption of phosphate (Mezenner and Bensmaili, 2009 Chem Eng J 147:87-96).

### Interference Studies

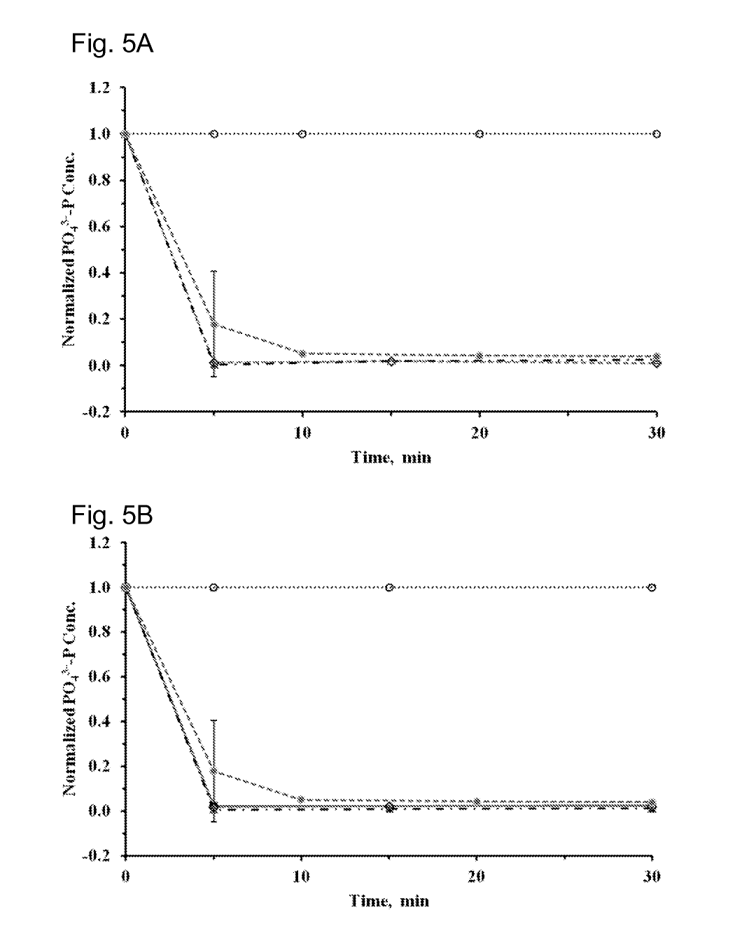

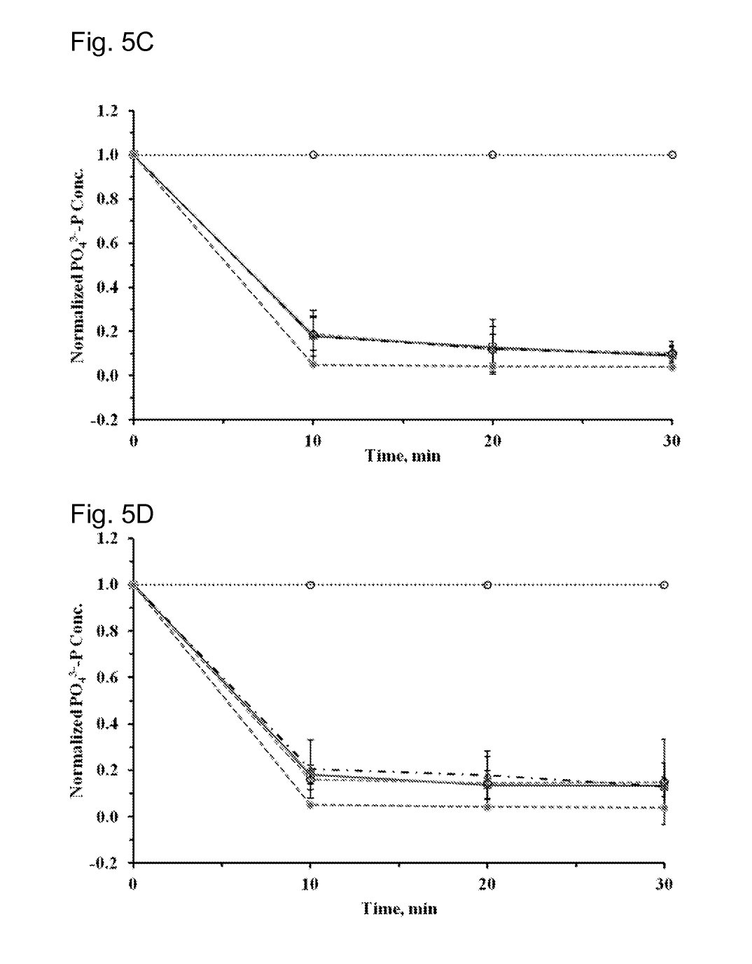

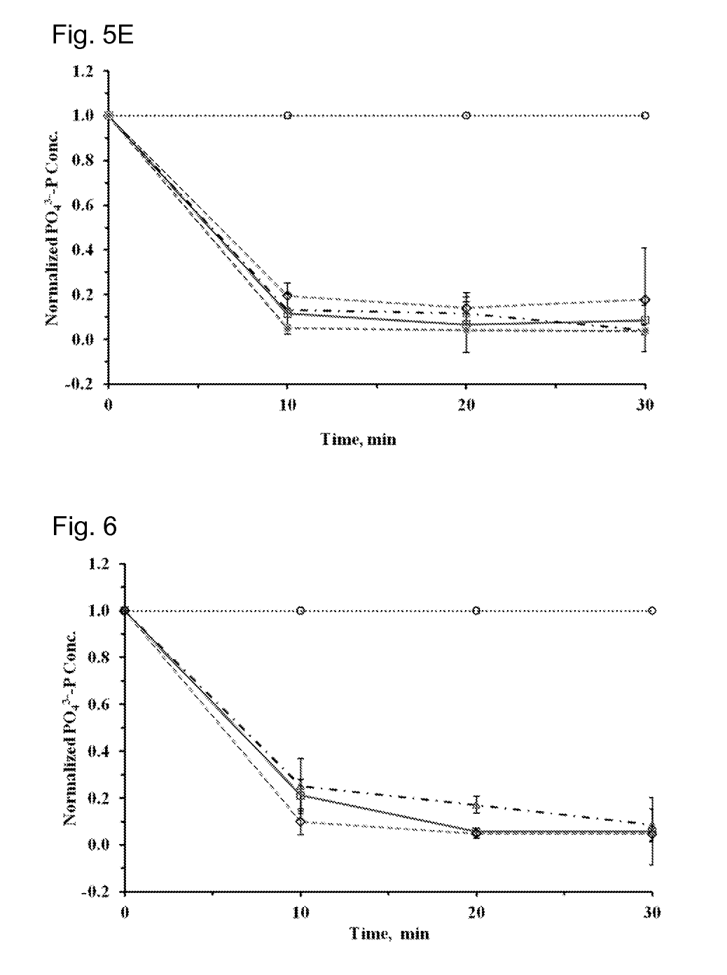

The interferences of various ions and organic matters on phosphate removal were studied with an objective to understand how NZVI is going to behave during real field applications. Ionic strength (varied from 0 to 10 mM) did not have any statistically significant effect on phosphate (C₀=5 mg/L) removal by NZVI (FIG. 5a, α=0.005, p=0.225). However, analysis of variance (ANOVA) showed statistically significant differences in the treatment data for nitrate (α=0.005, p=0.001), sulfate (0-900 mg/L, α=0.005, p=0.00), humic acid (0-50 mg/L, α=0.005,p=0.00), and NOM (0-50 mg/L, α=0.005, p=0.00). Dunnett method was used to further compare the control with rest of the treatment data. All nitrate concentrations (1, 5, 10 mg NO₃⁻-N/L, FIG. 5b) were found to significantly interfere in phosphate removal from aqueous solution. However, this statistically significant increase in phosphate removal (1.40-2.77%) may not have any practical significance bring very marginal. Again, the treatment data were significantly different from the control for all sulfate concentrations (100, 500, 900 mg/L). Phosphate removal by NZVI decreased by 5.16-6.27% in the presence of sulfate in the solution (FIG. 5c). While the presence of NOM (1, 10, 50 mg/L, FIG. 5d) decreased phosphate removal by 6.01-11.03% (all statistically significant), the presence of humic acid showed mixed results. The presence of 1 mg/L humic acid (FIG. 5e) significantly reduced (13.86%) phosphate removal but interference was not statistically significant when humic acid concentration was increased (10 and 50 mg/L).

Liu et al. (2011) have reported interference due to ionic strength during phosphate removal with lanthanum-doped activated carbon fiber. They increased ionic strength from 0 to 10 mM and observed an 8.1% drop in phosphate removal (from 98.8 to 90.7%). Even 10 mM ionic strength did not affect the phosphate removal efficiency in the present study, and a removal of 96.0-98.5% was achieved in all cases (ionic strength varied from 0 to 10 mM). Introducing competing anions was expected to have negative effects on phosphate adsorption (Liu et al., 2011 J Colloid Interf Sci 364:490-496). Fe⁰ was successfully used by others to remove nitrate from aqueous solution (Bezbaruah et al., 2009 J Hazard Mater 166:1339-1343; Hwang et al., 2011 J Hazard Mater 185:1513-1521) and so it was expected that nitrate will compete with phosphate for reactive/sorption sites on NZVI. Nitrate was found to interfere in phosphate removal in layered double hydroxides (Das et al., 2006 Appl Clay Sci 32:252-260) and ˜12% reduction in phosphate removal in the presence of nitrate was reported. Xue et al. (2009 J Hazard Mater 162:973-980), however, did not find any interference of NO₃⁻ during phosphate removal using basic oxygen furnace slag. In the present study slight increase (1.40-2.77%) in phosphate removal (though not environmentally significant) was observed. Further research would be needed to find out the possible reason for this increase but the authors would like to hypothesis that nitrate reacted with NZVI to produce iron (hydr)oxides with a higher affinity for phosphate. Sulfate was also reported to interfere with phosphate and reduced phosphate removal by 24.5% in layered double hydroxides (Das et al., 2006 Appl Clay Sci 32:252-260). In this study, sulfate retarded the phosphate removal process and reduced removal efficiency as high 6.27%. The adsorption of phosphate in presence of humic acid was studied by Antelo et al. (2007 Geoderma 138:12-19) and found that phosphate adsorption onto the surface of goethite decreased by 45 and 25% in the presence of humic acid at pH of 4.5 and 7, respectively. This can be explained by the competition of the humic acids functional groups with phosphate for the sorption sites where the humic acid outcompeted the phosphate. Also, the sorption sites on the surface could be blocked by the relatively large size of humic acids (˜15 Å in diameter, Simeoni et al., 2003 Appl Geochem 18:1507-1515), thus less sorption sites will be available for phosphate (˜2.56 Å in diameter) (Antelo et al., 2007 Geoderma 138:12-19). Similar results were reported by others (Shuai et al., 2009 Sci Soc Am J 73:2013-2020). In the presently study only low concentration (1 mg/L) of humic acid affected phosphate removal while higher concentration did not. This happened possibly because of increased sorption of phosphate onto NZVI due to lowering of solution pH (see FIG. 3) at higher humic acid concentrations. Additional experiments are needed to investigate why the presence of the humic substances did not adversely affect phosphate removal by NZVI, the authors feel that NZVI reacts very fast with phosphate in the first 10 min or so the possible inferring compounds are not competitive enough. In this study, phosphate removal in the presence of Suwannee River NOM (1, 10, 50 mg/L) was found to be significantly different from the control (without NOM). Phosphate removal efficiency of NZVI reduced by 9.01-11.03% in the presence of NOM. This result was expected as NOM negatively impacts NZVI reactivity. Li et al. (2010 Environ Sci Technol 44:3462-3467) reported the minimum concentration of NZVI that inhibited E. coli growth after 24 h exposure as 5 mg NZVI/L. However, in the presence of NOM, the NZVI concentration had to be increased to 100 mg/L to achieve the same degree of inhibition. This happened possibly because the NZVI particles' reactive surfaces were covered with NOM and, thus, reducing the overall reactivity of NZVI. Chen et al. (2011 Water Res 45:1995-2001) also observed a 23% reduction in trichloroethylene (TCE) degradation by NZVI in the presence of Suwannee River NOM.

### Effects of Temperature

Experiments were conducted at 4, 22 and 60° C. during this study. The removal of phosphate at 4 and 22° C. was relatively slower than the removal at 60° C. However, after 30 min, the removal was the more or less same (91.4-95.3%) for all temperatures (FIG. 6) and there was no significant differences between the values (one-way ANOVA: α=0.005, p=0.144). This is in contrast to findings by others. Increasing the temperature from 25 to 45° C. increased the phosphate adsorption capacity of granular ferric hydroxide from 3.6 to 5.1 M P/g (i.e., 0.11-0.16 mg/g, Saha et al. 2010). Liu et al. (2011 J Colloid Interf Sci 364:490-496) also reported increase adsorption capacity in lanthanum-doped activated carbon fibers from 8.54 to 9.41 mg/g of with the increase of temperature from 20 to 50° C. Mezenner and Bensmaili (2009 Chem Eng J 147:87-96) reported ˜60% increase in phosphate adsorption onto iron hydroxide-eggshell waste when the temprature was increased from 20 to 45° C. Fast phosphate removal that takes place within the first 10 min may be the reason why no distinction could be made between removal achieved in three different temperatures.

### Effect of Particle Size

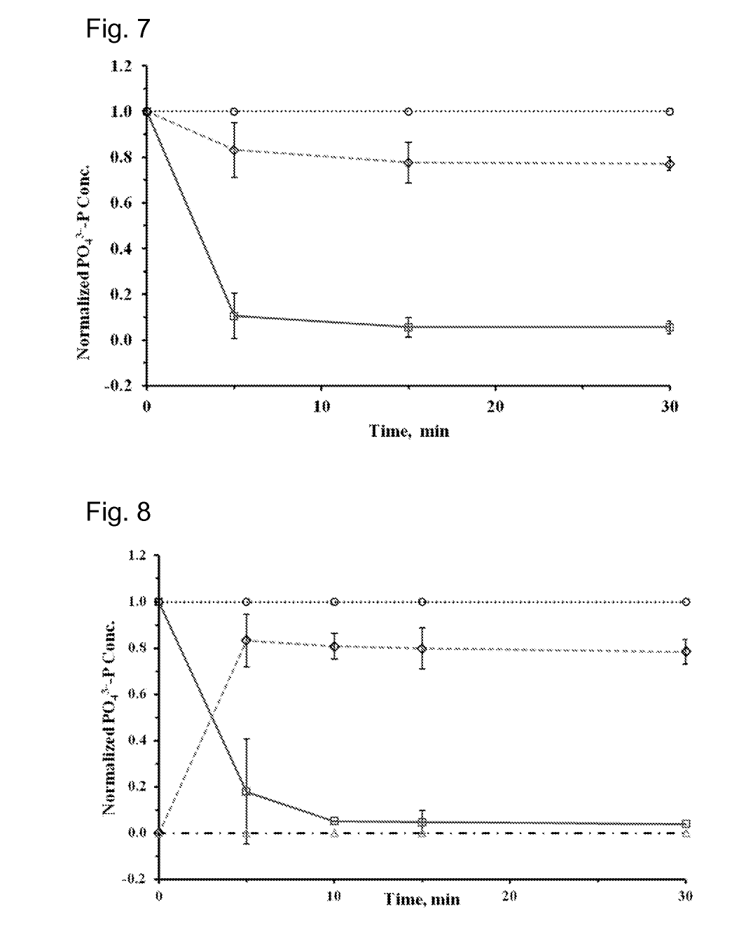

Sorption is dependent on surface area and, hence, in this study the same surface area (10 m²/L) was used for the comparison of phosphate removal by NZVI (particle size ˜16 nm) and MZVI (<10 μm). MZVI removed only 23% of phosphate (C₀=5 mg PO₄³⁻-P/L) in 30 min whereas NZVI removed ˜96% of phosphate over the same time period (FIG. 7). NZVI was 13.9 times more efficient than MZVI in removing aqueous phosphate. Others reported similar observations with NZVI for other contaminants. Surface area normalized rate constant (kₛₐ) of NZVI (surface area ˜30-35 m²/g) for tetrachloromethane degradation was reported as over two orders of magnitude higher than that of MZVI (Li et al., 2006 Crit Rev Solid State 31:111-122). Also, removal capacity of Cr(VI) using NZVI was more than 100 time that of the removal capacity using MZVI (Li et al., 2006 Crit Rev Solid State 31:111-122). Kanel et al. (2005 Environ Sci Technol 39:1291-1298) reported that the kₛₐ for As(III) removal by NZVI was 1-3 orders of magnitude higher than MZVI. While using NZVI, kₛₐ of alachlor degradation was found to be ˜10 times that with MZVI (k_{sa-NZVI}=38.5×10⁻⁵ and k_{sa-MZVI}=3.8−7.7×10⁻⁵ L h⁻¹m⁻², Thompson et al., 2010 Environ Eng Sci 27:227-232).

### Phosphate Recovery

In the initial batch study ran to find out the optimal pH for phosphate recovery maximum phosphate recovery was achieved at pH 12, and the recovery was minimal at acidic pH (data not shown). In the follow up phosphate desorption (recovery) batch studies conducted at pH 12, 78.4% phosphate recovery was obtained (FIG. 8). The 78.4% recovery is based on the mass of phosphate sorbed onto NZVI during removal experiment. If the recovery is calculated based on the mass of the phosphate present in the original bulk solution from which removal was achieved than the phosphate removal is 74.5%. In terms of practical applications, if 5 mg/L phosphate is present in bulk solution 4.80 mg/L (96% removal, see ‘Phosphate removal’ under ‘Results and discussion’) will be removed by NZVI and 3.73 mg/L (74.5% recovery) can be recovered back from the NZVI. Better phosphate recovery at higher pH was achieved possibly because of the abundantly present hydroxide ions at a higher pH. The presence of these hydroxide ions would result in a net negative surface charge to which few phosphate anions would be bound. The opposite phenomena would occur at a lower pH which would result in more sorption. Poor recovery of phosphate at pH 4 and 6 supports the previously proposed mechanism where an electrostatic attraction between the phosphate ions and the surface of NZVI occur resulting in phosphate sorption on the surface of NZVI. Also, pH 12 is higher than PZC of NZVI and particles are negatively charged resulting in desorption of phosphate (Eq. 3, Karageorgiou et al., 2007 J Hazard Mater 139:447-452, and FIG. 3). Research indicate that phosphate can be recovered from sorptive media under high pH conditions (Babatunde and Zhao, 2010 J Hazard Mater 184:746-752; Cordray, “Phosphorus removal characteristics on biogenic ferrous iron oxides,” 2008 Master's Thesis, Washington State University, USA; Karageorgiou et al., 2007 J Hazard Mater 139:447-452; Liu et al., 2011 J Colloid Interf Sci 364:490-496). Similar results were reported by others using other forms of iron oxides (Yan et al., 2010 J Hazard Mater 179:244-250; Zeng et al., 2004 Water Res 38:1318-1326).

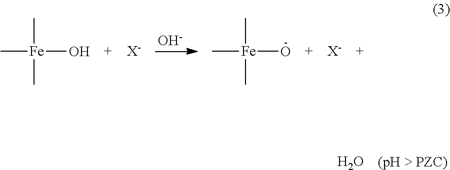

### Conclusions

Results from the batch studies conducted during this study demonstrate the effectiveness of NZVI for phosphate removal and recovery with different initial phosphate concentrations (1, 5, 10 mg PO₄³⁻-P/L). Phosphate removal of 88-95% was achieved in the first 10 min itself and 96-100% removal was achieved after 30 min. Increase in phosphate removal efficiency improved with the increase in initial NZVI concentration use and followed a linear trend (R²=0.9539). When the initial NZVI concentration was increased from 80 to 560 mg/L, the removal of phosphate increased by ˜78% (C₀=5 mg/L). Little interference was observed in phosphate removal due to ionic strength and temperature change. Sulfate and natural organic matters had statistically significant negative impacts but nitrate marginally improved phosphate removal. The phosphate removal efficiency was also not affected by high concentrations of humic acid. Phosphate sorbed onto NZVI was successfully recovered (˜78%). The phosphate recovery process was found to be pH dependent with maximum recovery achieved at pH 12.

### Environmental Significance

Phosphate removal using NZVI has potential applications in wastewater treatment plants, where phosphate removal is otherwise not very efficient. The speed of phosphate removal using NZVI (88-95% removal in the first 10 min) gives the nanoparticles an advantage over other sorbents. The high speed of phosphate removal by NZVI can be used to engineer a commercially viable treatment process with low detention time and minimal infrastructure.

TABLE 1
Different iron-based adsorbents used for phosphate removal
and their performance data

| | Type of Wa- | Removal | % Re- | |
|---|---|---|---|---|
| Type of Iron | ter/Phosphate | (%, time) | covery | Source |
| Hydroxy- | DI/KH₂PO₄ | 90%, | — | Yan et al., 2010 J |
| iron | | 5.83 h | | Hazard Mater 179: |
| | | | | 244-250 |
| Iron ore | wastewater | 97%, | — | Guo et al., 2009 |
| | | 15 d | | Biochem Eng J 46: |
| | | | | 223-226 |
| Iron hy- | Distilled | 73%, | | Mezenner et al., 2009 |
| droxide- | water/ | 3.67 h | | Chem Eng J 147: |
| eggshell | KH₂PO₄ | | | 87-96 |
| waste | | | | |
| Steel slag | Distilled | 71-82%, | — | Xiong et al., 2008 J |
| | water/ | 2 h | | Hazard Mater 152: |
| | KH₂PO₄ | | | 211-215 |
| Synthetic | NaH₂PO₄ | 40-100%, | ~82% | Chitrakar et al., 2006 |
| Goethite | | 2-8 h | | J Colloid Interf Sci |
| | | | | 298:602-608 |
| Akaganeite | NaH₂PO₄ | 15-100%, | ~90% | Chitrakar et al., 2006 |
| | | 4-8 h | | J Colloid Interf Sci |
| | | | | 298:602-608 |
| Synthetic | Sea water + | 60%, | — | Chitrakar et al., 2006 |
| Goethite | NaH₂PO₄ | 24 h | | J Colloid Interf Sci |
| | | | | 298:602-608 |
| Akaganeite | Sea water + | 30%, | — | Chitrakar et al., 2006 |
| | NaH₂PO₄ | 24 h | | J Colloid Interf Sci |
| | | | | 298:602-608 |
| Iron oxide | DI/KH₂PO₄ | 71%, | 13-14% | Zeng et al., 2004 |
| tailing | | 24 h | | Water Res 38:1318- |
| | | | | 1326 |
| Biogenic | DI/KH₂PO₄ | 100%, | 49% | Cordray, “Phospho- |
| iron oxide | | 24 h | | rus removal charac- |
| | | | | teristics on biogenic |
| | | | | ferrous iron oxides,” |
| | | | | 2008 Master's Thesis, |
| | | | | Washington State |
| | | | | University, USA |
| This study- | DI/KH₂PO₄ | 96-100%, | ~80% | |
| NZVI | | 60 min | | |

### Example 2

### Iron Nanoparticle-Sorbed Phosphate: Bioavailability and Impact on Spinacia Oleracea and Selenastrum Capricornutum Growth

The possible shortfall of phosphorous fertilizers is a major concern for global food security. It is predicted that world phosphorous production will decline around 2035. While there is no way of increasing the amount of natural phosphorous supply, the spotlight has been shifted to sustainable practices including efficient recovery of used/wasted phosphates.

Bioavailability of the NZVI sorbed phosphate was investigated with algae (Selenastrum capricornutum) and spinach (Spinacia oleracea). Enhanced plant and algae growth was observed when NZVI sorbed phosphate used as the only source of phosphate and iron. These data show potential applications of NZVI for phosphate recovery from polluted waters and reuse in agriculture, potentially as a matrix for a slow release fertilizer.

In this study, nanoscale zero-valent iron (NZVI) particles have been used for phosphate recovery from aqueous solutions. The bioavailability of the sorbed phosphate onto NZVI particles was determined by supplying these particles to Spinach (Spinacia oleracea) and algae (Selenastrum capricornutum) grown in hydroponic solution. Spent NZVI (particles after phosphate adsorption) were added to the algae growth media as the only source of P and Fe. The concentration of algae increased by 5.7 times when the only source of phosphate was spent NZVI as compared to algae grown in standard all-nutrient media (including phosphate). Again, removing PO₄³⁻ from the growth media decreased the algae concentration 3 fold when compared to algae grown in all-nutrient media. In the spinach study, plant biomass increased in the presence of spent NZVI (where nanoparticles the only source of phosphate) by 4 time than the plant treated with all-nutrient solution. Iron and phosphorus uptakes by plants were determine in the presence of spent NZVI as the only source of P and Fe. Results indicated 20, 11, and 7 times more Fe content in the roots, stems, and leaves of the plant treated with spent NZVI, respectively, as compared to the controls. Amount of P in the biomass also found to be significantly higher in the plants treated with spent NZVI.

### Introduction

Phosphorus (P) is a vital macronutrient for plants. Plants and other organisms mostly uptake dissolved aqueous orthophosphate, and incorporate it into their tissues (Zhang et al., 2011 J Environ Sci (China) 23:199-205). Dissolved organic phosphate (DOP) cannot be used by plants in the organic form. DOP is transformed into orthophosphate due to enzymatic hydrolysis, and is available for plants (Walker, 2012).

Phosphorus is an essential element for food production and there is no substitute for P (Cordell et al., 2011 Chemosphere 84:747-758). The amount of P in plants ranges from 0.05% to 0.30% of total dry weight. Although P is abundant in the most types of soils, only a tiny fraction is available for plants uptake (Vanec 2011). Low-phosphorus availability for plants has been tackled by addition of phosphate fertilizers to the soil. However, the amount of bioavailability of phosphate is reduced due to chemical immobilization of some of it in soil matrix (Zhang et al., 2011 J Environ Sci (China) 23:199-205). The extensive application of P fertilizers leads to a P buildup in the soil which in turn increases the potential for P loss to surface waters through surface or subsurface run-off. Increase in phosphate concentration in water bodies leads to eutrophication.

Undesired loss of P and resulting non-point source pollution is only one aspect of the bigger problem. The major issue is the impact of excessive use of fertilizers on global food security given the fact that phosphorus is a nonrenewable resource. Phosphorous fertilizers are produced predominantly from ores from select mines in Morocco, Western Saharan region, and China (Cordell et al., 2009 Glob Environ Change-Human Policy Dimens 19:292-305). Phosphorus bearing ore production rate is predicted to decline starting around 2035 (Cordell et al., 2011 Chemosphere 84:747-758) the use of P fertilizers will be increasing under the current agriculture practices (Gilbert, 2009 Nature, 461:716-718). The possible short supply of P fertilizers is a major concern for global food security. While there is no way of increasing the amount of natural phosphorous supply, the spotlight has been shifted to sustainable practices related to P fertilizers including efficient recover and reuse of phosphates.

Almeelbi and Bezbaruah (2012 Journal of Nanoparticle Research, 14:1-14) reported up to 100 removal rates of phosphate using nanoscale zero-valent iron (NZVI) particles and found them to be more efficient than larger size particles. Others have used iron oxide nanoparticles to remove (70-90%) phosphate (Jianbo et al., 2013 Powder Technology, 233:146-154; Martin et al., 2009 Water Sci Technol, 60:2637-2645; Pan et al., 2009 Water Res, 43:4421-4429; Zach-Maor et al., 2011 J Colloid Interface Sci 363:608-614). Phosphate removal by NZVI and iron oxide nanoparticles is known to be a sorptive process and the sorbed phosphate remains in the nanoparticles. It was hypothesized in this research that the sorbed phosphate would be bioavailable to plants.

Selenastrum capricornutum is a group of common green algae (Chlorophyceae) found in most fresh waters. It is readily available from suppliers and can be easily cultured, and, hence, has been widely used in the laboratory for growth inhibition and standard toxicity studies (Abouwaly et al., 1991 Bull. Environ. Contam. Toxicol, 46:223-229; Brown and Button, 1979 J Phycol, 15:305-311; Scherfig and Dixon, 1979; Errécalde et al., 2000 J Phycol, 36:473-483; Francko, 1989 J Phycol, 25:305-313; ISO 8692, “Water Quality—Fresh Water Algal Growth Inhibition Test with Scendemus subspicatus and Selenastrumcapricornutum,” 1989 International Organization of Standardization, Geneva, Switzerland; Hall and Golding, “Standard methods for whole effluent toxicity testing: development and application,” 1998 Report no. MFE80205. NIWA report for the Ministry for the Environment, Wellington, New Zealand; Gutierrez-Wing et al., 2012 Engineering in Life Sciences, 12:79-88). Higher plants like Allium cepa (onion bulbs) Lolium perenne (ryegrass), Cucurbita pepo (zucchini), Cucurbita mixta (pumpkin), and others in hydroponic systems have been used by others for growth studies (Ghodake et al., 2011 J Hazardous Mat 186:952-955; Lin and Xing, 2008 Environ Sci & Technol 42:5580-5585; Stampoulis et al., 2009 Environ Sci & Technol, 43:9473-9479; Wang et al., 2011 Nanotoxicology, 5:30-42).

In this study we examined bioavailability of phosphate from spent NZVI (used for phosphate removal) using Selenastrum capricornutum and Spinacia oleracea (Spinach).

### Materials and Methods

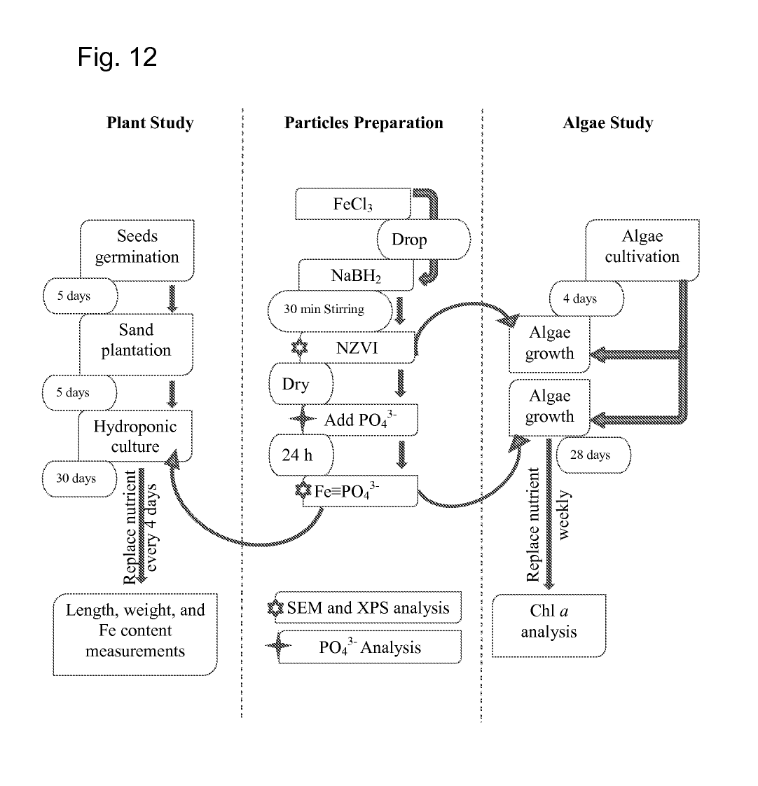

A schematic of the experimental design is shown in FIG. 12.

### Chemicals

Chemicals (Table 2) were used as received unless and otherwise specified.

### Synthesis and Preparation of Iron Nanoparticles

NZVI Synthesis: NZVI particles were synthesized using sodium borohydride reduction method (Eq. 1, Huang and Ehrman, 2007 Langmuir 23:1419-1426; Almeelbi and Bezbaruah, 2012 J Nanoparticle Res, 14:1-14).

2FeCl₃+6NaBH₄+18H₂O→2Fe⁰+21H₂+6B(OH)₃+6NaCl (1)

Ferric chloride hydrate (1.35 g) was dissolved in 40 mL of deoxygenated de-ionized (DI) water (solution A), and 0.95 g of sodium borohydride was dissolved in 10 mL of deoxygenated DI water in a separate beaker (solution B). Then solution A was added drop wise to solution B under vigorous stirring conditions (using a magnetic stirrer). The resultant black precipitates (NZVI) were centrifuged and washed with copious amount of deoxygenated DI water and methanol (Almeelbi and Bezbaruah, 2012) to remove the undesired chemicals. The washed NZVI were dried in vacuum oven under nitrogen environment and then were ground using a mortar and pestle.

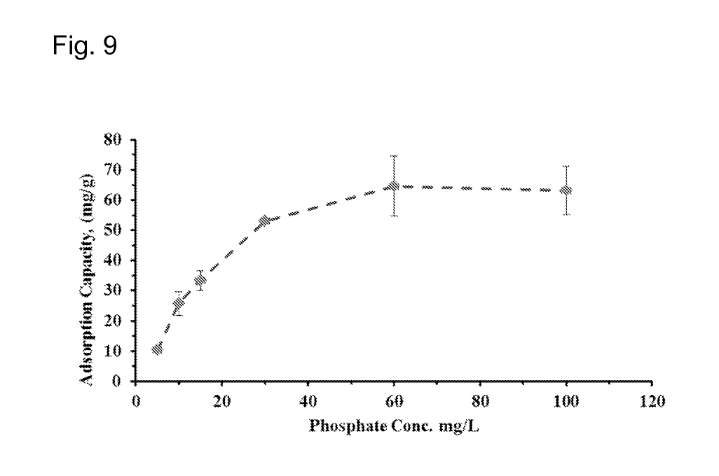

Phosphate adsorption: NZVI (20 mg) was added to phosphate solution (50 mL of 100 mg PO₄³⁻-P /L) in multiple 50 mL polypropylene plastic vials fitted plastic caps (reactors). The concentration of 100 mg/L for phosphate was decided based adsorption capacity studies (FIG. 9).

The reactors were rotated end-over-end at 28 rpm in a custom-made shaker for 24 h and then content was centrifuged at 4000 rpm. The supernatant was collected for phosphate analysis. Ascorbic acid method (Eaton et al., 2005) was used for phosphate analysis. The precipitated iron particles were dried in vacuum oven under nitrogen environment and ground using mortar and pestle. Others have reported that phosphate gets sorbed on NZVI (Almeelbi and Bezbaruah, 2012). The dried particles were characterized using X-ray photoelectron spectroscopy (XPS) and Energy Dispersive X-Ray Spectrometer (EDS). The dried particles were used in algae and plants growth studies.

TABLE 2
List of chemicals used in this study

| | | | Grade/ |
|---|---|---|---|
| Chemical Formula | Chemical Name | Supplier | Purity |
| NaOH | Sodium Hydroxide | BDH | ACS |
| Ca(NO₃)₂•4H₂O | Calcium Nitrate | BDH | ACS |
| | Tetrahydrate | | |
| KNO₃ | Potassium nitrate | Alfa Aesar | 99% |
| KH₂PO₄ | Potassium Phosphate | BDH | ACS |
| | Monobasic | | |
| MgSO₄ | Magnesium Sulfate | Aldrich | +97% |
| K₂SiO₃ | Potassium Silicate | Alfa Aesar | >99% |
| FeCl₃•6H₂O | Iron(III) Chloride | Mallinckrodt | ACS |
| | Hexahydrate | | |
| MnSO₄•4H₂O | Manganese Sulfate | Alfa Aesar | 99% |
| CuSO₄ | Copper(II) Sulfate | Alfa Aesar | 99% |
| ZnSO₄ | Zinc Sulfate | Alfa Aesar | ACS |
| | Heptahydrate | | |
| H₃BO₃ | Boric Acid | Alfa Aesar | ACS |
| Na₂MoO₄•2H₂O | Sodium Molybdate | J.T. Baker | ACS |
| | Dihydrate | | |
| HNO₃ | Nitric Acid | BDH | ACS |
| NaNO₃ | Sodium Nitrate | Fluka | >99% |
| CaCl₂•2H₂O | Calcium Chloride | BDH | ACS |
| | Dihydrate | | |
| K₂HPO₄ | Potassium Phosphate | BDH | ACS |
| | Dibasic | | |
| NaCl | Sodium Chloride | EMD | ACS |

### Algae Studies

All glassware were washed with phosphate-free detergent and rinsed thoroughly with tap water, soaked in acid bath (10% HCl) overnight, rinsed with deionized (DI) water, and autoclaved for ˜20 minute before use.

Cultivation of Algae: S. capricornutum (UTEX 1648) was obtained from the University of Texas Culture Collection (Austin, Tex., USA) (UTEX, 2012). Erlenmeyer flask of 500 mL (nursery reactors) was used to culture the algal in liquid Bristol medium (Table 3). The culture was aerated and illuminated with cool-white fluorescent light on a 12-h light and 12-h dark cycle at room temperature (22±2.0° C.). The light intensity was 3.17 log Lum m⁻² (HOBO U12-012 temp/RH/light external data logger, Onset Computer Corporation, Bourne, Mass., USA). Exponential growth phase was maintained as per the supplier's instructions through repetitive subculturing with freshly prepared medium every 4 days.

Growth Studies: Glass bottles (500 mL) were used as reactors, and 400 mL of different growth media and 5 mL of algae seed (S. capricornutum) obtained from the laboratory culture (see ‘Cultivation of Algae’ above) were added to the reactor. The algae were incubated for 28 days in the reactors illuminated with cool-white fluorescent light. During the incubation period, the reactors were manually shaken and aerated for 10 min once every day to maintain aerobic conditions. Five different growth nutrient solutions were used and algae growth was measured at the end of the test period. Each experiment was repeated three times. The five nutrient solutions used were: (1) Only DI water, (2) Bristol medium (Table 3, no virgin NZVI added), (3) Bristol medium with virgin NZVI, (4) Bristol medium without PO₄³⁻ (no NZVI), and (5) Bristol medium without PO₄³⁻ but with spent NZVI. The only DI water (nutrient solution 1) was used to check whether residual nutrients from the laboratory algae culture were affecting algae growth. Additional nutrients (from the stock solution) were and nanoparticles are added once every week. Samples (10 mL) were collected from each reactor for biomass analysis after 28 days and analysis were preformed immediately.

TABLE 3
Composition of Bristol media used for algae growth (Source: UTEX, 2012)

| | Stock Solution | Volume used | Molar Conc. |
|---|---|---|---|
| Salt | g/400 mL DI H₂O | mL/L | used mM |
| NaNO₃ | 10 | 10 | 2.94 |
| CaCl₂•2H₂O | 1 | 10 | 0.17 |
| MgSO₄•7H₂O | 3 | 10 | 0.3 |
| K₂HPO₄ | 3 | 10 | 0.43 |
| KH₂PO₄ | 7 | 10 | 1.29 |
| NaCl | 1 | 10 | 0.43 |

### Spinach Studies

Germination and Plant Preparation: Spinach (Tyee spinach, Spinacia oleracea, Lake Valley Seed Company, Boulder, Col.) seed was purchased from a local outlet. Seeds were washed then soaked in DI water over night. The seeds were then placed on moist filters paper in petri-dishes and kept in the dark at room temperature until germination. The germinated seeds were planted on sand in a glass tray. Nutrients solution (Table 4) was added to the growth media (sand) every day and the plants were illuminated with cool-white fluorescent light (12-h light and 12-h dark). The light intensity was 3.17 log Lum m⁻².

TABLE 4
Composition of hydroponic growth nutrient solution (USU, 2012)

| | Stock solution Conc. | Starter | Pre-anthesis | Post-anthesis |
|---|---|---|---|---|
| Salt | mM | mL/10 L | | |
| Ca(NO₃) | 1000 | 10 | 10 | 5 |
| K(NO₃) | 1000 | 10 | 40 | 20 |
| KH₂PO₄ | 500 | 10 | 10 | 10 |
| MgSO₄ | 500 | 10 | 10 | 5 |
| K₂SiO₃ | 100 | 10 | 10 | 0 |
| FeCl₃ | 50 | 2 | 0.5 | 0.5 |
| MnSO₄ | 60 | 0.5 | 1 | 0.5 |
| CuSO₄ | 20 | 1.5 | 1 | 1 |
| ZnSO₄ | 20 | 3 | 1.5 | 1.5 |
| H₃BO₃ | 40 | 0.5 | 0.25 | 0.1 |
| Na₂MoO₄ | 1 | 1 | 0.5 | 0.5 |
| HNO₃ | 1000 | 0.5 | 0.5 | 0.5 |

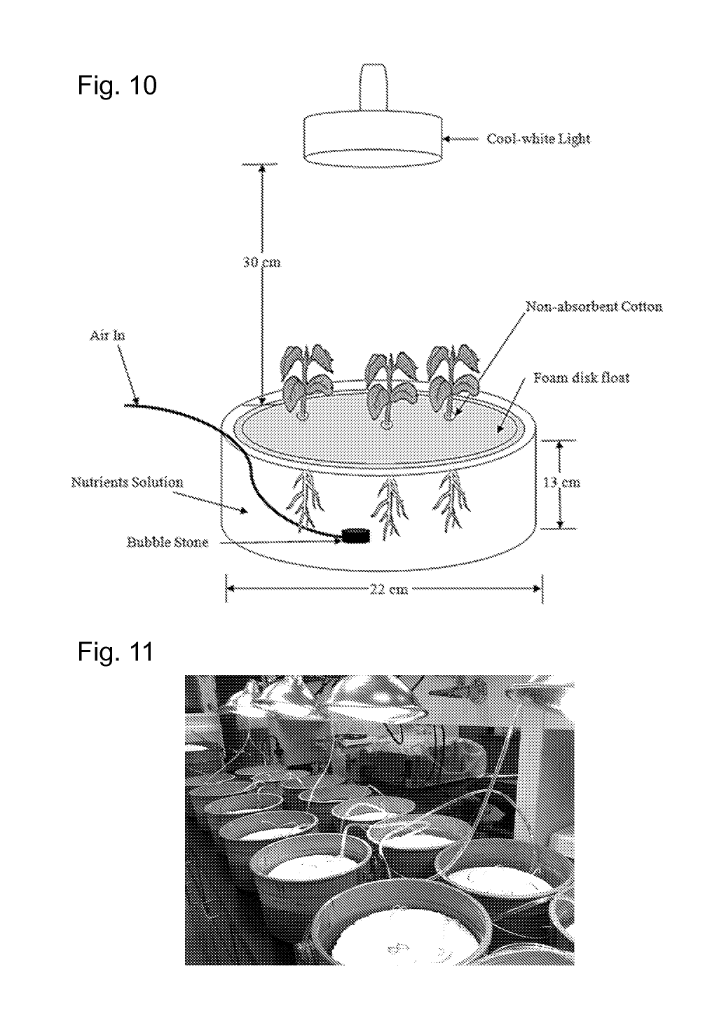

Growth Studies: After 5 days (during the early stage of stem and leaf formation) the seedlings were removed from the sand media, roots were thoroughly washed with DI water, and transplanted into hydroponic reactors (FIGS. 10 and 11). Plastic containers (2 L nutrient solution) were used for hydroponic culture. Three plants were placed into a foam disk float with the shoots supported above with non-absorbent cotton and roots below the disk (Jacob et al., 2013 Int J Phytoremediation, 15:142-153). The floats with the plants were then placed in the reactors. The arrangement of putting the plants in the floats ensured continuous root contact with the nutrient solution. The nutrient solution was aerated constantly with air throughout the experiment and the solution was replaced every 4 days. Light was provided in 14-h light 10-h dark cycles with cool white bulbs with a light intensity of 3.17 log Lum m⁻². Three different treatments were run to study the effects of spent iron nanoparticles (NZVI that sorbed PO₄³⁻) on plants. Treatment 1 was 0.15 g. The amount of nanoparticles was decided based on the concentration of sorbed PO₄³⁻ on the particles. Spent iron (0.15 g) was used in the reactor. Equivalent amount of PO₄³⁻ in the nutrients solution was added each time. In another container (treatment 2 or control 1) all nutrients was used (Table 4). The last treatment was all nutrient except PO₄³⁻ and Fe³⁺ (Control 2). Each treatment was run in triplicate. The assignments of the reactor's place and plants were randomized. First the containers were numbered and each place was assigned a number randomly. Then plants were picked from sand washed thoroughly with DI-water then places randomly in a container until the last plant was places in the last container.

### Analytical Procedures

Algae measurement: Algae samples were collected and algae biomass was estimated by measuring chlorophyll a (Chl a) concentration using a pigment extraction method (Globbelaar et al., 1984; Lorenzen, 1967). Ten milliliters of algal culture was filtered using a Whatman GF/F glass fiber filters (pore size 0.5 to 0.7 μm, 47 mm diameter). Pigment (chlorophyll) extraction was done by soaking the filter (with algal biomass retained on them) in 5 mL of 95% ethanol and keeping it in the dark for 20 h. The solvent was then filtered through a GF/F a glass fiber filter. Absorbance of the extracted sample (solvent with the pigment dissolved) was measured on a DR 5000 UV spectrophotometer using a 1-cm path length cuvette at 665 nm and 750 nm. The sample was then treated with 1N HCl and absorbance was measured again at 665 nm and 750 nm. The following equation was used to calculate Chl a concentration (Globbelaar et al., 1984; Lorenzen, 1967):

$$Chl a ( mg / {m}^{3} or μg / L ) = \frac{26.7 \times ( {E}_{665 o} - {E}_{665 a} ) x V}{{V}_{f} \times L} \qquad ( 4 )$$

where,
V=volume of ethanol used for extraction (mL)
V_{f}=water filtered (L)
L=path length of cuvette (cm)
E_{665 0}=turbidity-corrected absorption at 665 nm before acidification (A₆₆₅ₒ-A₇₅₀ₒ)
E_{665 a}=turbidity-corrected absorption at 665 nm after acidification (A₆₆₅ₐ-A_{750 a})

To ensure reproducibility and data reliability this experiments was ran in triplicate at different times and concentration of Chl a was measured in triplicate for each treatment.

Plant measurement: Plants were harvested after 28 days of hydroponic growth. The harvested plants were washed with DI water, and the height of shoots and roots were recorded. Roots were washed with 10 mM CaCl₂ solution to remove NZVI physically attached onto the surface (Jacob et al., 2013 Int J Phytoremediation, 15:142-153). Roots, stem and leafs were separated and then dried at 80° C. for 48 h before measuring the weight (Bezbaruah and Zhang, 2009 Water Sci Technol, 59:1179-1184). The similar parts (e.g., roots) of plants from each reactor (3 plants each) were combined together and the combined weight has been reported and further analyses were done assuming such combined mass as one entity.

Iron measurement: The dry plant tissue (roots, stems, shoots) were ground and digested in a CEM Mars Xpress microwave digester using. Concentrated nitric acid (HNO₃, 3 mL) was added to the ground plant tissue or standard reference material (NCS DC 73350 leaves of poplar, China National Analysis Center of Iron and Steel) in a 55 ml PFA venting vessel. Weight of plant tissue was measure before digestion. Samples were divided into three groups based on their weight and reference samples were prepared accordingly. DI waster (3 mL) was added after 20 min of pre-digestion then the samples were digested at 200° C. for 15 minutes at 1600 W 100% power (for 28 vessels) after 10 minutes ramp time. The digests were analyzed for Fe and P with a Spectro Genesis ICP-OES with Smart Analyzer Vision software (v. 3.013.0752), crossflow nebulizer (three replicate measurements, 21 seconds integration time). Analysis of control standard was done after every 10 samples and checked whether it was within acceptable limits (10%).

Statistical Analysis: Analysis of variances (ANOVA) and Bonferroni Simultaneous Tests were used to analyze the result using Minitab 16 software.

### Results and Discussion

### Particles Characterization

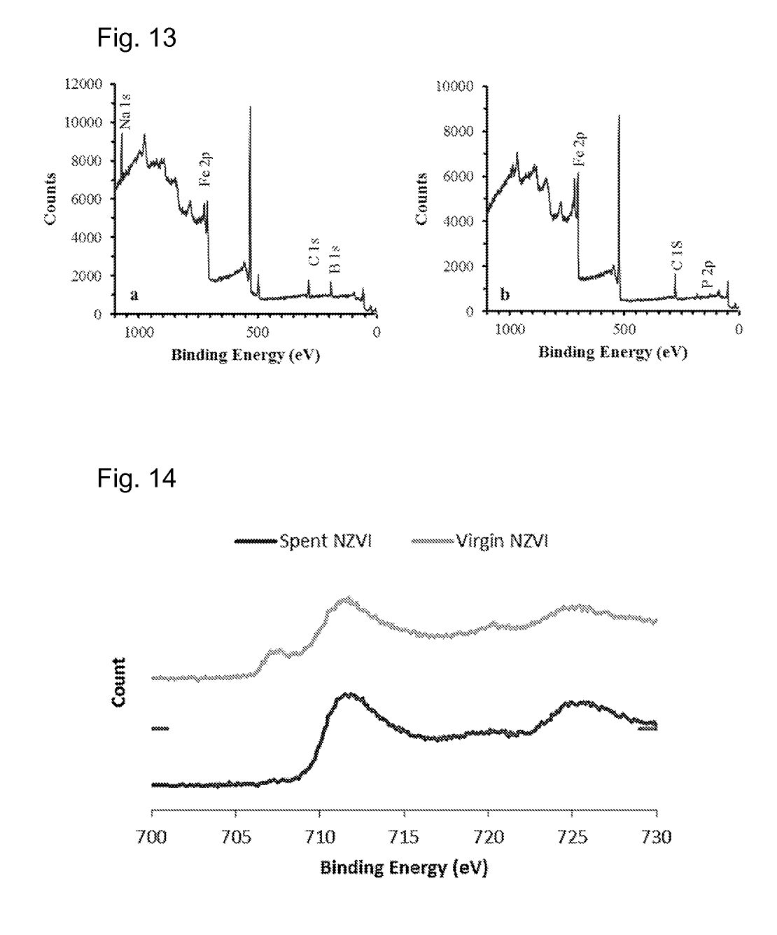

Average particles size of virgin NZVI was found to be 16.24±4.05 nm (Almeelbi and Bezbaruah, 2012). NZVI particles were synthesized and analyzed using XPS and EDS to confirm the presence of the phosphate (FIGS. 13 and 14). High Resolution X-ray Photoelectron Spectroscopy (HR-XPS) was performed on a Surface Science SSX-100 spectrometer with an Al anode (Kα X-rays at 1486.66 eV) operated at 10 kV and 20 mA. Samples were mounted on the sample stage using conductive carbon sticky tape and transferred to the analysis chamber (with a pressure below 1×10⁻⁸ ton).

From XPS spectrum of the new NZVI (FIG. 13a), peaks at 711 and 725 eV represent the binding energies of 2p_{3/2}, and 2p_{1/2}, respectively which can be assigned to the metallic Fe⁰ and the oxide layer on the metal core. In addition, O 1 s peak at 531 and adventitious carbon on the sample peak at 285 eV BE. Peaks at 1071 and 192 eV BE from Na 1 s and B 1 s, respectively, indicate considerable concentrations of Na and B from residual NaBH₄. This finding is in agreement with others (Jabeen et al., 2011 Nanoscale, 3:3583-3585; Li and Zhang, 2006 Langmuir, 22:4638-4642; Martin et al., 2008 Langmuir, 24:4329-4334). The new peak at 133 eV (FIG. 13b) is attributed to the presence of phosphate adsorbed onto the surface of the spent NZVI particles (Jianbo et al., 2013 Powder Technology, 233:146-154; Zach-Maor et al., 2011 J Colloid Interface Sci 363:608-614). The HR-XPS spectra of Fe 2p (FIG. 14) shows a small shoulder at around 707 eV for virgin NZVI only which can be assigned to 2p_{3/2} peaks of Fe⁰. Since the nanoparticle surface is covered with an oxidized iron layer (Krajangpan et al., 2012 Environ Sci Technol 46:10130-10136), only small amount of Fe⁰ is exposed to XPS (5-50 Å in depth) (Li and Zhang, 2006 Langmuir, 22:4638-4642).

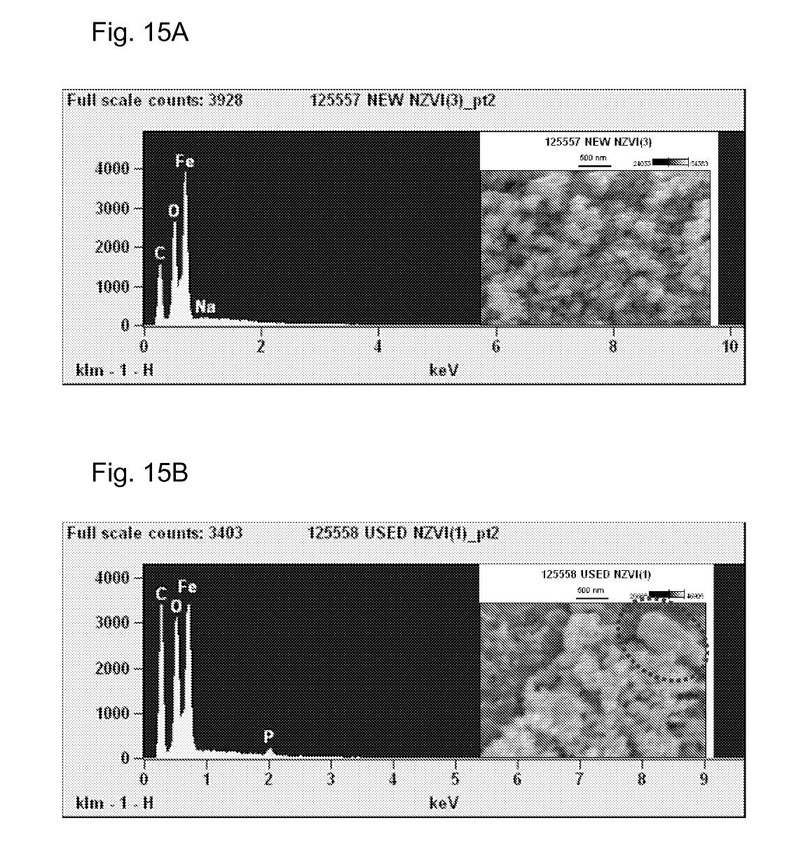

Elemental composition of virgin spent NZVI was determined using scanning electron microscopy with energy dispersive spectroscopy (SEM/EDS, JEOL JSM-6300, JEOL Ltd.). The percentage of oxygen in the virgin NZVI was 12.10%. The amount of oxygen in the spent NZVI varied between 13.02 and 25.15% due to oxidation and phosphate sorption. Cao et al (2008 Environ Sci & Technol, 42:3780-3785) reported 8.21% oxygen in fresh NZVI which increased to 26.14% after an hour of purging with air. Krajangpan et al. (2012 Environ Sci Technol 46:10130-10136) also reported 15.66% of oxygen in NZVI. While there was no phosphorus in the virgin NZVI, the percentage was found to be 7.95, 2.10, and 1.67% at three different parts in the spent sample (Table 5 and FIG. 15b). The highest percentage of P (7.95%) was at the part number 1 which was a relatively large particle (circled in FIG. 15b). The isotherm experiments also determined adsorption capacity of NZVI as 63 mg PO₄³⁻P/g NZVI (i.e., 6.3%). The presence of a very low amount (0.51%, Table 5 and FIG. 15) of sodium was observed in the virgin NZVI but was not present in the spent NZVI. Sodium was possibly left as the residual from sodium borohydride (NaBH₄) used in the NZVI synthesis process.

TABLE 5
Weight percentage of elements present in virgin and spent NZVI.

| | Part | % Weight | | | |
|---|---|---|---|---|---|
| Particles Type | Number* | O | Fe | Na | P |
| Virgin NZVI | 1 | 12.10 | 87.39 | 0.51 | 0.00 |
| | 2 | 10.37 | 89.32 | 0.31 | 0.00 |
| | 3 | 10.90 | 88.70 | 0.39 | 0.00 |
| Spent NZVI | 1 | 25.15 | 66.90 | 0.00 | 7.95 |
| | 2 | 13.13 | 84.77 | 0.00 | 2.10 |
| | 3 | 13.02 | 85.31 | 0.00 | 1.67 |

*The part numbers used for analysis are identified in the SEM images (FIGS. 15a and 15b)

### Algae Growth

The concentration of chlorophyll a (Chl a) is an indicator of algae health and a measure of growth. Chl a increased substantially when virgin NZVI and PO₄³⁻ sorbed NZVI used as compared to other treatments (Table 6 and FIG. 15). Bonferroni test (α=0.05) identified two groups of experimental data based on the statistically significant differences. The first group included results from algae treated with DI water, all nutrients, and all nutrients expect PO₄³, and the second group was treated with virgin and spent NZVI particles. The algae batches treated with DI water provided the baseline data for comparison. There was slight increase in the concentration of Chl a when all nutrients expect PO₄³⁻ were added as the growth media (from 21 to 107 μg/L). The increase was very similar to what was seen in the DI water batch (from 21 to 108 μg/L). It should be noted all treatments (including DI water batch) had some initial growth nutrients as the seed algae was grown in Bristol media (Table 3), and the nutrients got transferred to each batch when 5 mL of seed was taken from the nursery reactor. The presence of the PO₄³⁻ the Chl a concentration increased 1.8 times as compared to the batch without PO₄³⁻. The results from the second batch showed significant difference with the first group. The algae batch treated with all nutrients and virgin NZVI showed an increase of algae concentration from 21 to 1673 μg/L. When spent NZVI particles (with PO₄³⁻ sorbed onto them as the PO₄³⁻ source) were used the algae growth was even more profuse (from 21 to 2003 μg Chl a/L). It is very evident that the presence of iron nanoparticles significantly increased the growth of algae. The growth of algae was profuse when spent NZVI apparently supplied the PO₄³⁻needed for algae growth and the final algae concentration was 5.7 times more that the batch with all nutrients (no NZVI).

The presence of nanoparticles definitely played a major role in algae growth as has been evident from the comparison of data obtained from the two groups. However, it is difficult to postulate a reason for that. Bioavailability of iron from NZVI may be another possible reason for enhanced algae growth. It is worth mentioning that the Bristol media do not contain iron as a nutrient for algal growth. Kadar et al., (2012 Sci Total Environ, 439:8-17) have reported a normal growth of three different types of marine algae (Pavlova lutheri, Isochrysis galbana and Tetraselmis suecica) in the presence of NZVI. In particular Tetraselmis suecica showed 30% higher growth rate in the presence of NZVI. Another study (Liu et al., 2008 Bioresource Technol, 99:4717-4722) has also indicated that iron content in the growth media affected the algae growth of marine micro-algae (Chlorella vulgaris). However, Ruangsomboon, (2012 Bioresource Technol, 109:261-265) reported no significant effect of iron on green algae (Botryococcus braunii) biomass using FeSO₄ as source of iron. In this study, the comparison between the two batches in the second group indicates that PO₄³⁻ sorbed onto NZVI was possibly bioavailable for algal growth. Phosphate plays a major role in algae growth as could be observed from the Chl a growth in batches 1-B and 1-C (Table 6). The final concentration of Chl a without PO₄³⁻ (108 μg Chl a/L in 1-C) was ˜3 times less than Chl a concentration when the nutrient solution contained PO₄³⁻ (300 μg Chl a/L in 1-B). Others have also reported PO₄³⁻ as a limiting nutrient for algal growth (Meeuwig, 1996). Fried et al., (2012 Tillers, 4:21-24) reported a positive effect of PO₄³⁻ on algae growth. Based on this logic it is reasonable to say that PO₄³⁻ sorbed in NZVI was bioavailable to algae and that is why similar growths were observed in batches 2-A and 2-B (Table 6).

TABLE 6
Concentrations of chlorophyll α at 0 and 28 days of algae growth

| | | Chlorophyll α concentration (μg/L) | |
|---|---|---|---|
| Batch | Growth Medium | 0 d | 28 d |
| 1-A | DI-Water | 20.80 ± 1.83 | 81.58 ± 22.84 |
| 1-B | All Nutrients | 20.80 ± 1.83 | 300.38 ± 14.59 |
| 1-C | All nutrients (No PO₄³⁻) | 20.80 ± 1.83 | 107.54 ± 45.73 |
| 2-A | All nutrients (No-PO₄³⁻) + | 20.80 ± 1.83 | 2002.50 ± 981.45 |
| | Spent NZVI | | |
| 2-B | All nutrient + Virgin NZVI | 20.80 ± 1.83 | 1673.20 ± 270.10 |

### Plant Growth

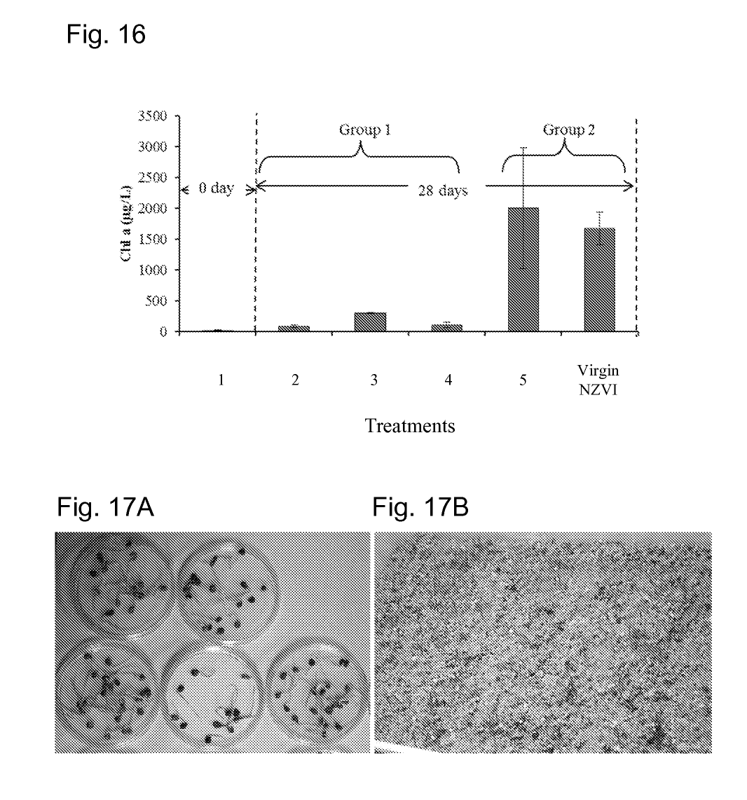

Seeds germination started after 5 d and continued till 10 d. The percent of seed germination varied from 72 to 100%. Plant with similar germination time and growth were selected for the batch studies (FIG. 17).

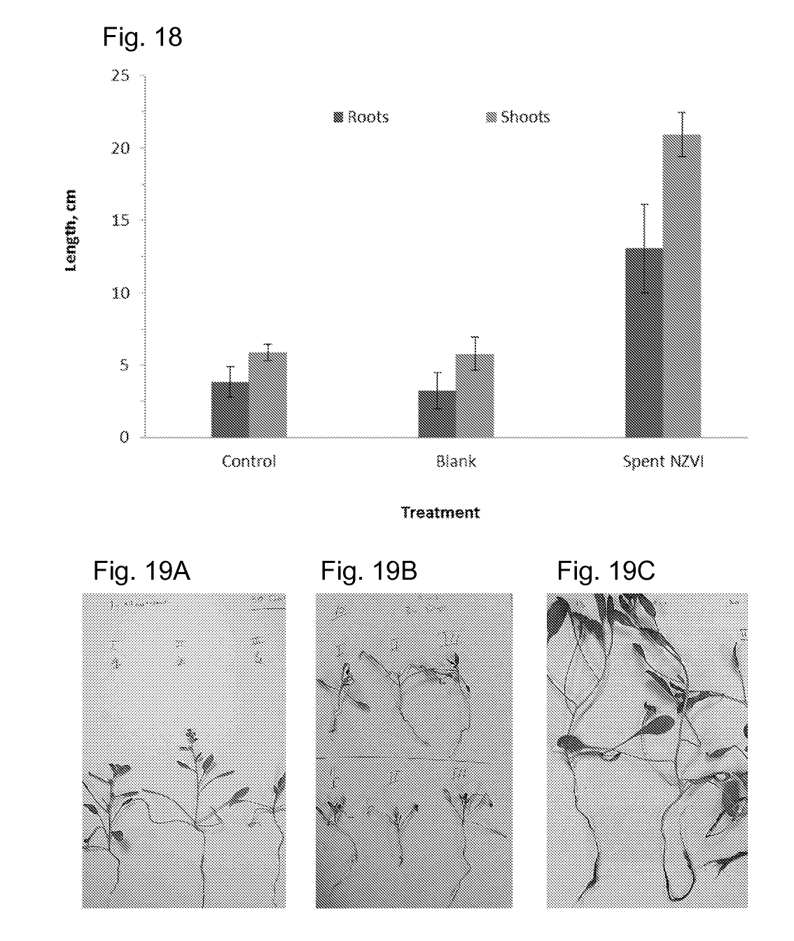

Root and shoot lengths: Spinacia oleracea plants were harvested after 30 d of hydroponic growth. The length of shoots and roots were recorded immediately after harvesting (Table 7 and FIG. 18). In the plants treated with spent NZVI particles (with PO₄³⁻ sorbed onto them) the lengths of roots and shoots were 13.1±2.8 and 20.9±0.3 cm, respectively. The lengths of roots and shoots in Control 1 (plants treated with all nutrients, Table 4) were 3.8±1.0 and 5.9±0.6 cm, respectively, while the corresponding values for Control 2 (all nutrient but no PO₄³⁻ and Fe) were 3.2±0.5 and 5.8±1.0 cm. Bonferroni test (α=0.05) put the data sets into two groups with data from spent NZVI in the first group and data from the two controls in the second group based on the statistically significant differences. Plants treated with only DI water showed no growth and died in 10 d. When the length of roots and shoots from the NZVI treated plants with those from Control 1 it was evident that the present of the spent NZVI had a major impact on plant growth. The roots and shoots of the plants treated with spent NZVI were ˜3.5 longer than those from the plants in Control 1. This observation, however, does not help in concluding that PO₄³⁻ and Fe from NZVI was bioavailable given the fact that there are no significant differences in data obtained from Control 1 and Control 2. However, visual observation (FIG. 19) indicate that plants supplied with PO₄³⁻ and Fe (Plate 3a and Plate 3c) were healthier and the leaves were vibrant green, while Control 2 (no PO₄³⁻ and Fe, Plate 3b) has weathered leaves and the stems were skinner. Ewa et al., (2012) reported plants (Avena sativa L. Arab, Polar, and Szakal) deprived of PO₄³⁻ showed a reduction in shoot growth with simultaneous root elongation. It is, there, safe to conclude that plants treated with spent NZVI and Control 1 (all nutrients) had taken up PO₄³⁻ and Fe.

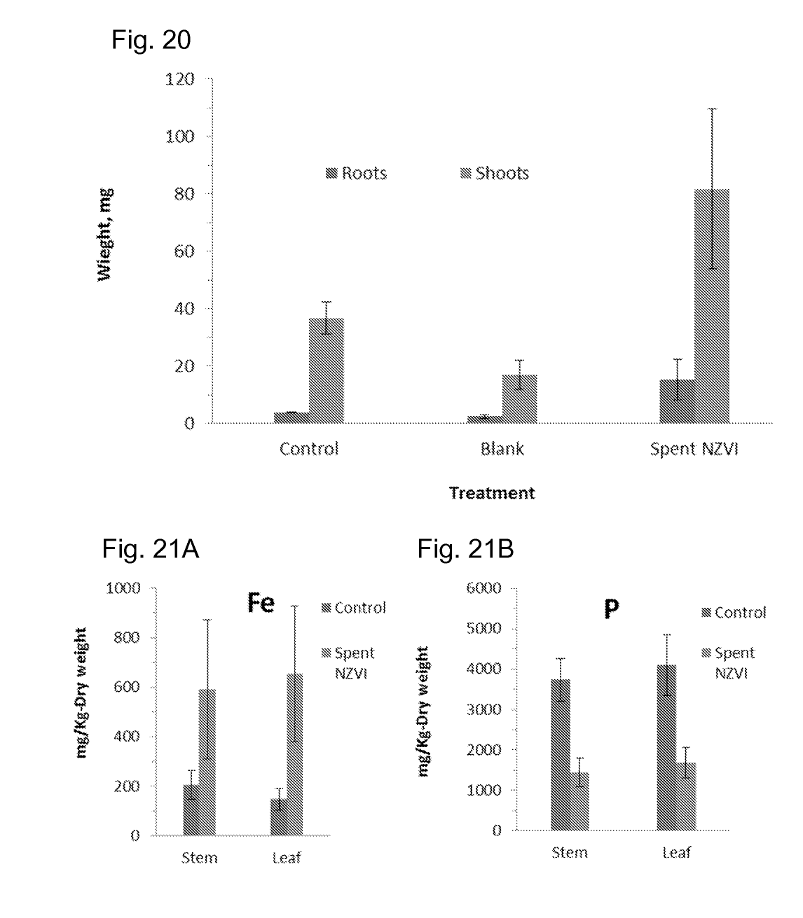

Plant biomass: Average shoots and roots biomass of individual plants from each of the three groups of plants after 30 d was measured (Table 7 and FIG. 20). Plants grown in only DI-water died after 10 d and no measurement could be made.

In the plants treated with spent NZVI particles (with PO₄³⁻ sorbed onto them) the average biomass of roots and shoots (per plant) were 15.3±7.0 and 81.7±2.8 mg, respectively. The biomass of roots and shoots in Control 1 (plants treated with all nutrients, Table 4) were 3.8±0.3 and 36.7±5.6 mg, respectively, while the corresponding values for Control 2 (all nutrient but no PO₄³⁻ and Fe) were 2.5±0.6 and 16.9±5.2 mg. Bonferroni test (α=0.05) put the data sets into two groups with data from spent NZVI in the first group and data from the two controls in the second group based on the statistically significant differences. The treatment with nanoparticles had a significant effect on plant biomass. The plants treated with NZVI had ˜4 times more root biomass that Control 1, and similarly had ˜2.2 times higher shoot biomass. The most effect of nanoparticles was on roots weight with increase 3 times as compared to controls 1. Shoots also has increased by 1.22. Other researchers have reported both positive and negative impacts of different nanoparticles on plants (Table 8).

TABLE 7
Length and weight of plants parts for each treatment

| | Length (cm) | | Weight (mg) | |
|---|---|---|---|---|
| Treatment | Roots | Shoots | Roots | Shoots |
| Blank* | Seedling died in 10 d | | | |
| Control 1** | 3.8 ± 1.04 | 5.89 ± 0.59 | 3.8 ± 0.3 | 36.7 ± 5.6 |
| Control 2*** | 3.22 ± 0.54 | 5.78 ± 0.96 | 2.5 ± 0.6 | 16.9 ± 5.2 |
| PO₄³⁻ sorbed NZVI | 13.06 ± 2.76 | 20.94 ± 0.35 | 15.3 ± 7.0 | 81.7 ± 2.8 |

*DI-Water,
**All nutrients
***All nutrients but (PO₄³⁻ and Fe)

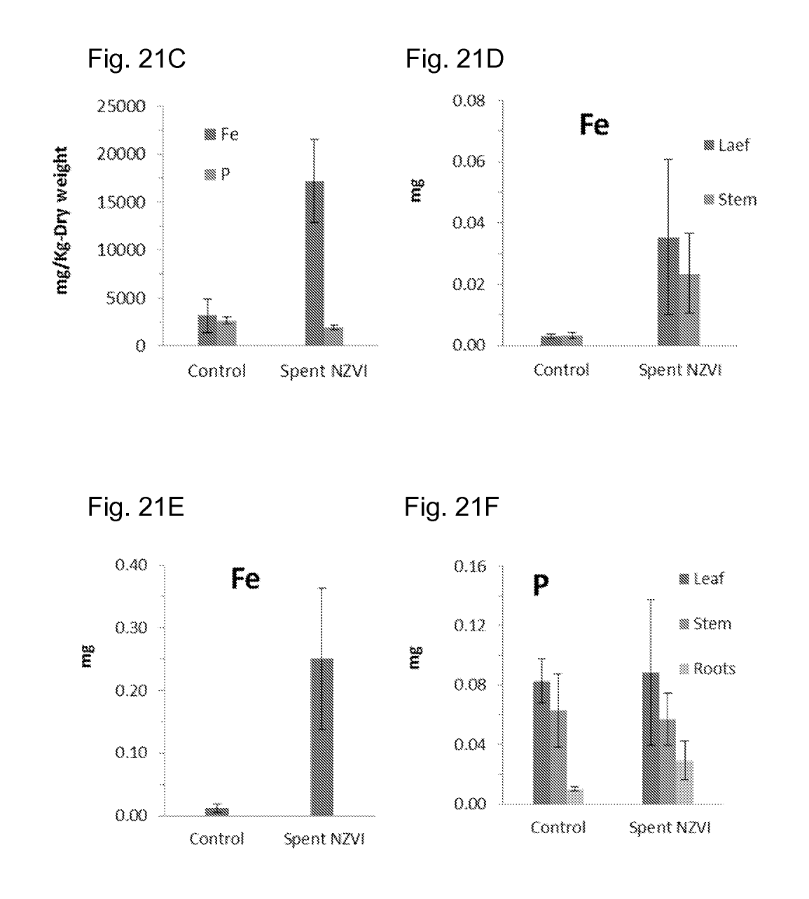

Iron and Phosphorus analysis: Iron and phosphorus contents in plant were analyzed. There was significant differences in Fe and P concentrations between control and NZVI treatments in roots and leaves, however, in stems concentration of Fe was not significant (FIG. 21 and Table 8). Concentration of Fe in the stem increased by 1.9 times in the plants treated with spent NZVI (590.54±279.54) when compared to the control (205.34±57.72).

Concentration of Fe was expressed in mg of Fe or P/kg of the dry weight. In the case of P concentration there was higher concentration in all plant parts of the control but after calculating the amount of P present in the biomass of the plant there was more P in plants from spent NZVI treatment than those from controls. The results are strong evidence that the adsorbed PO₄³⁻ was bioavailable for plant uptake. In the roots total Fe uptake increased ˜20 times from in control 0.012±0.006 to 0.251±0.011 mg in the presence of spent NZVI, respectively. In the stems and leaves, Fe increased by ˜7 and 11 times in the presence of NZVI. The significant increase of Fe concentration in the plant tissues indicates that the Fe from NZVI was bioavailable as well.

TABLE 8
ANOVA analysis for Fe and P concentrations in plant parts.

| | | P-value | |
|---|---|---|---|
| Plant Part | Element | mg/kg-dry weight | mg/biomass |
| Root | Fe | 0.006 | 0.01 |
| | P | 0.066 | 0.033 |
| Stem | Fe | 0.080 | 0.052 |
| | P | 0.003 | 0.000 |
| Leaf | Fe | 0.042 | 0.017 |
| | P | 0.027 | 0.002 |

Significance level is (P < 0.05)

TABLE 9
Nanoparticle-plant interactions.

| Nanoparticle | Plant | Medium | Effects | Source |
|---|---|---|---|---|
| TiO₂ | Triticum (Wheat) | Murashige and | Accumulation of nanoparticles in the roots, | Camille et al., 2012 |
| | | Skoog (MS) | No major impact on seed germination and | |
| | | | vegetation development | |
| Multiwall carbon | Solanum lycopersicum | MS | Increase in germination and growth rate | Khodakovskaya et al., 2009 ACS |
| nanotubes | (Tomato) | | | Nano, 3:3221-3227 |
| CuO and ZnO | Triticum (Wheat) | Soil | Reduction on roots growth Bioaccumulation of | Christensen et al., 1979 Water |
| | | | NP were detected in the shoots | Res. 13:79-92 |
| ZnO | Lolium perenne (ryegrass) | Hydroponic | Significant reduction of biomass, NPs | Lin and Xing, 2008 Environ Sci |
| | | | aggregation in the roots, inhibition of the | & Technol 42:5580-5585 |
| | | | seedling growth | |
| CoOx and ZnO | Allium cepa (Tnion) | Hydroponic | Roots inhibition by both, and roots damaged by | Gajanan et al., 2011 |
| | | | ZnO accumulation | |
| Al₂O₃, SiO₂, | Arabidopsis thaliana | MS | Phytotoxicity: ZnO > Fe₃O₄ > SiO₂ | Lee et al., 2010 Environ Toxicol |
| Fe₃O₄, and ZnO | (mouseear cress) | | Al₂O₃ was found to be not Phytotoxic | Chem, 29:669-675 |
| NZVI | Linum usitatissimum (Flax), | Soil and | Complete inhibition of germination at 1-2 g | El-Temsah and Joner, 2012 |
| | Lolium perenne (ryegrass) | hydroponic | NZVI/L | Chemosphere, 89:76-82 |
| | Hordeum vulgare (barley) | | | |
| Fe₃O₄ | Cucurbita maxima | Hydroponic | NPs translocateed, and accumulated in the | Zhu et al., 2011 |
| | | and sand | plant tissues. Level of uptake and accumulation | |
| | | | in hydroponic was more than soil | |
| TiO₂ and ZnO | Triticum (Wheat) | Soil | NPs are found to reduce biomass. Zn was | Du et al., 2011, J Environ Monit |
| | | | dissolved in the soil increasing Zn uptake by | 13:822-828 |
| | | | the plant | |
| Ag and Cu | Cucurbita pepo (zucchini) | hydroponic | Ag and Cu reduced biomass by 57 and 90%, | Stampoulis et al., 2009 Environ |
| | | | respectively | Sci & Technol, 43:9473-9479 |

### Conclusions

In this study the bioavailability of phosphate and iron from PO₄³⁻ sorbed iron nanoparticles was examined using Selenastrum capricornutum (algae) and Spinacia oleracea (Spinach). NZVI was synthesized and used for phosphate removal from aqueous solution. The particles characterization using XPS and SEM/EDS confirmed the presence of the PO₄³⁻ on the surface of nanoparticles. Algae Growth increased significantly in the presence of the iron nanoparticles (virgin and spent NZVI). Algae growth when spent NZVI was the only source of PO₄³⁻ increased by 5.7 times more than the algae growth in standard all-nutrient solution. It can be concluded that the PO₄³⁻ sorbed onto spent NZVI was bioavailable for algal growth. Spinach growth experiment also produced similar results where presence of spent NZVI enhanced the growth of the plants and increased the plant biomass by 4 times as compared to control where PO₄³⁻ was supplied from the all-nutrient hydroponic solution. Fe content significantly increased in all plant parts (roots, stems, and leaves) when NZVI was added. Roots of the plants exposed to spent NZVI had the heights concentration of Fe (increased ˜20 times as compared to the control). Fe content also increased in the stem and leaves of the plant treated with spent NZVI by 7 and 11 times as compared to the control, respectively. All parts of plants treated with spent NZVI also had higher content of P than the control plants. It is evident that Fe and P was bioavailable for plants when the only source of P and Fe was the spent nanoparticles. Further research is needed to consolidate the finding and evaluate phosphate sorbed NZVI particles as fertilizer and Fe fortifier.

### Example 3

### Bare NZVI and Iron Cross-Linked Alginate Beads: Applications for Phosphate Removal From Actual Wastewaters

Applications of nanoscale zero-valent iron (NZVI) and iron cross-linked alginate (FCA) beads were explored in this study for phosphate removal from actual wastewaters. Wastewater treatment plant effluent (WTPE) and animal feedlot effluent/runoff (AFLE) samples were used in the phosphate removal studies. While FCA beads removed 97% of the PO₄³⁻ in 2 h from WTPE, NZVI removed 84%. However, the difference was not statistically significant. Fast removal rate was observed with FCA used to remove phosphate from AFLE (˜77% removal at the end of 15 min). The FCA beads continued to remove phosphate faster than NZVI until ˜60 min. Results have indicated that FCA beads were more efficient (85%) as compared to NZVI particles (57%) in the first hour. The overall PO₄³⁻ removal by FCA beads reduced from 85% in 1 h to 75% at 24 h. This removal rate has possible application in the field with high flow rate systems.

### Introduction

Excessive discharge of phosphorus (P) in surface water causes deterioration of water quality. Nutrient (P) richness in surface water bodies results in eutrophication of the water bodies. Eutrophication has significant economic impacts on local communities.

Two of the major sources of phosphate in surface water are wastewater effluent (point-source) and animal feedlot runoff (nonpoint-source). The estimated contributions of P sources to municipal wastewater from human wastes, laundry detergents, and other cleaners are 0.6, 0.3, and 0.1 kg P/capita/year, respectively (Sengupta et al 2011). Municipal wastewater contains adequate amount (5-15 mg/L) of P (Blackall et al., 2002 Antonie Van Leeuwenhoek Int J Gen Mol Microbiol 81:681-691). Even though the contribution of laundry detergents in increasing P in wastewater successfully reduced nowadays, P concentration in WWT effluent would reduce by only to 4-5 mg/L P (USGS “Phosphorus in a Ground-Water Contaminant Plume Discharging to Ashumet Pond, Cape Cod, Mass.,” 1999 Northborough, Mass.). This effluent with high concentration of P finds its way to lakes and surface waters. Various studies have indicated that concentrations of P above 0.02 mg/L accelerate eutrophication of water bodies (Sharpley et al., Agricultural Phosphorus and Eutrophication, Second Ed. 2003 United States Department of Agriculture, Agricultural Research Service; Seviour et al., 2008 J Microbiol 46:115).

### Materials and Methods

### Chemicals

Iron (II) chloride tetrahydrate (FeCl₂·4H₂O, reagent grade, J. T. Baker), calcium chloride (CaCl₂, ACS grade, BDH), monopotassium phosphate (KH₂PO₄, 99% pure, EMD), sodium alginate (production grade, Pfaltz & Bauer), potassium nitrate (KNO₃, 99%, Alfa Aesar), sodium hydroxide (NaOH, ACS Grade, BDH), sodium borohydride (NaBH₄, 98%, Aldrich), methanol (production grade, BDH) were used as received unless and otherwise specified.

### NZVI Synthesis

NZVI was prepared as described by (Almeelbi et al., 2012 J Nanopart Res, 14:1-14). Briefly, FeCl₃ solution was dropped into sodium borohydride solution and stirred for 30 min. The black resultant black precipitate (NZVI) was separated, washed by methanol and water using a centrifuge. The washed (NZVI) particles were dried using a vacuum oven under N₂ environment overnight and then ground using a mortar and pestle. The fine black powder was stored in a 20 mL vial for later use. Particles were not stored more than two weeks. The detailed method of NZVI has been reported by Almeelbi and Bezbaruah (2012 J Nanopart Res, 14:1-14).

### Beads Synthesis

Alginate solution (5 mL of 2% w/v) was dropped into FeCl₂ solution (35 mL of 2% w/v) in a 50 mL polypropylene plastic vial using a pump with very small tube track to reduce the loss of alginate. Moreover, the first batch was sacrificed to ensure eliminate any effect of alginate volume reduction due to alginate that might have remained within the tubings. Beads were kept in the FeCl₂ solution for at least 6 h with vial was capped.

### Samples Collection and Storage

Municipal Wastewater Treatment Plant (WTPE) Effluent: Samples were obtained from the City of Moorhead Wastewater Treatment Plant (Moorhead, Minn. USA). Moorhead follows a pure oxygen activated sludge treatment scheme. The secondary treated wastewater is subjected to tertiary treatment that involved nitrogen removal and additional polishing for organics and suspended solids. Tertiary treated wastewater samples from the effluent sampling point in outlet leading to the Red River outfall were collected in plastic containers (˜8 L). The WTPE was filtered through a 1.2 μm pore-size Whatman glass microfiber filter (GF/C) before use in the experiments or stored in the refrigerator at 4° C. for later use. Stored samples were used within a month.

Animal Feedlot Effluent (AFE): Samples were collected from a privately owned cattle feedlot at Sargent County, N.D., USA. Unfiltered samples were used immediately or stored in a plastic container (˜8 L) in the refrigerator at 4° C. for later use. Stored samples were used within a month.

### Batch Studies

WTPE and AFLE samples were used in PO₄³⁻ removal studies with NZVI and FCA beads as the sorbents. One batch of FCA beads (0.121 g dry weight) or 0.02 g NZVI were added to 50 mL of wastewater in multiple polypropylene plastic vials fitted plastic caps (reactors). The reactors were rotated end-over-end at 28 rpm in a custom-made shaker to reduce mass transfer resistance. A set of sacrificial reactors was withdrawn at specific time interval. The phosphate concentration in the bulk solution was measured and reported as average (with standard deviations) of readings from three replicate studies.

### Phosphate Analysis

Ascorbic acid method (Eaton et al., Standard Methods For The Examination Of Water And Wastewater 21st ed. 2005 American Public Health Association, Washington, DC, USA) was used for phosphate analysis. This method depends on the direct reaction of orthophosphate with molybdate anions to form a yellow-colored phosphomolybdate complex. Ascorbic acid reduces phosphomolybdic to form molybdenum blue species that has a broad absorbance range in between 700 nm to 900 nm. The color was measured in a UV-vis spectrophotometer (HACH, DR 5000) at wavelength of 880 nm. A five-point calibration was done routinely.

### Quality Control

All experiments were done in triplicates during this research and the average values are reported along with the standard deviations. Blanks with only wastewater/runoff (without NZVI/FCA beads) were run along with the NZVI and FCA bead experiments. The analytical instruments and tools were calibrated before the day's measurements. One-way ANOVA tests were performed to compare the variance between data sets as needed. Minitab 16 software (Minitab, USA) was used for all statistical analyses.

### Results and Discussion

### Beads Characterization

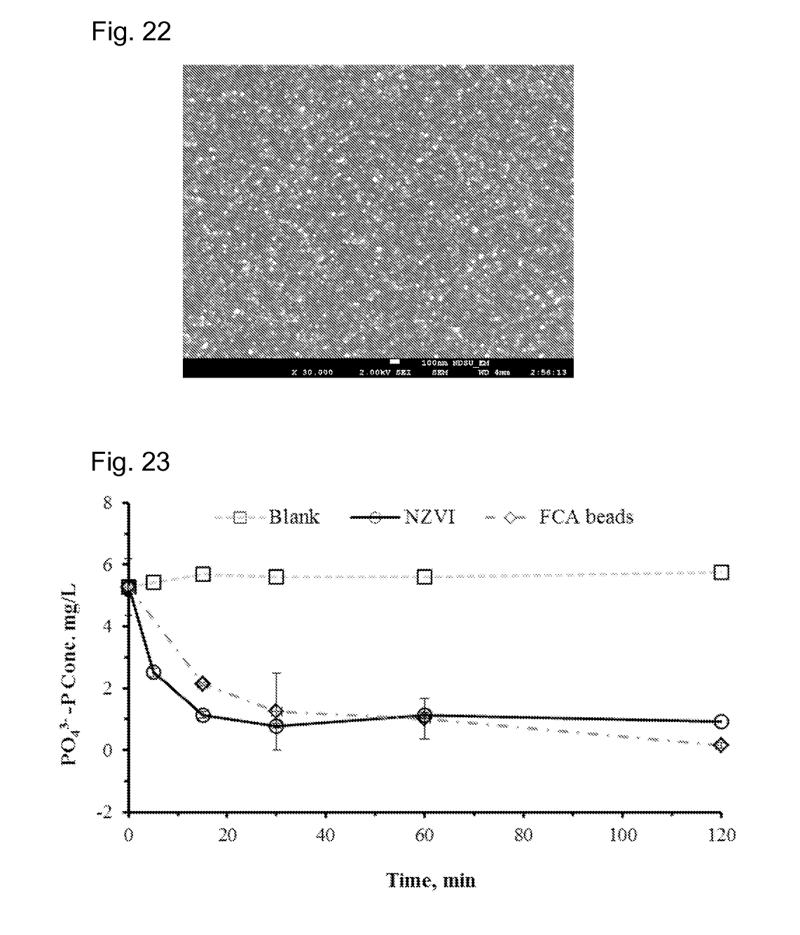

Beads were approximately spherical in shape with average diameters of 3.09±0.16 mm and each batch of dry FCA beads weighted 0.121±0.002 g. SEM analysis of the beads were done after drying the beads for 24 h in a vacuum oven under nitrogen environment. Iron nanoparticles was observed inside the dried the beads (FIG. 22), and the nanoparticles had an average size of 74.45±35.60 nm (n=97).

### NZVI Characterization

Almeelbi and Bezbaruah (2012 J Nanopart Res, 14:1-14) have used TEM to determine the size of NZVI and reported the particle size as 16.24±4.05 nm (n=109).

Phosphate Removal from WTPE

In batch studies conducted using NZVI and FCA beads for PO₄³⁻ removal from WTPE, FCA beads removed 97% of the PO₄³⁻ in 2 h while NZVI removed only 84% (FIG. 23). NZVI was faster in removing PO₄³⁻ as compared FCA in the first 15 min, and removed 80% PO₄³⁻ while FCA beads removed only 63%. NZVI continued to perform better till ˜30 min beyond which FCA removed PO₄³⁻ at better rate than NZVI. However, ANOVA analysis indicates that there is no significant difference between the PO₄³⁻ removal efficiencies by NZVI and FCA beads after 2 h (p =0.629). The finding is important from field application perspective. While it may be difficult to use and then recover NZVI particles (average diameter ˜16 nm) in wastewater treatment plant or similar set-ups, the FCA beads which are much larger (average diameter ˜3 mm) will be easily recoverable. Further, there are still a number of unknowns about the toxicity of NZVI. Saleh et al., (2008 Environ. Sci. Technol, 42:3349-3355) found that coated NZVI can remain mobile in aqueous media even after 8 months of application and may be toxic to humans. There are also other reports on toxicity of NZVI (Keller et al., 2012 PLoS ONE 7 8:e43983; Li et al., 2010 Environ Sci Technol 44:3462-3467; Phenrat et al., 2009 Environ. Sci. Technol., 43:195-200; Xiu et al., 2010 Environ. Sci. Technol, 44:7647-7651) that call for caution in wide scale application of the bare or unmodified nanoparticles.

Phosphate removal from AFLE

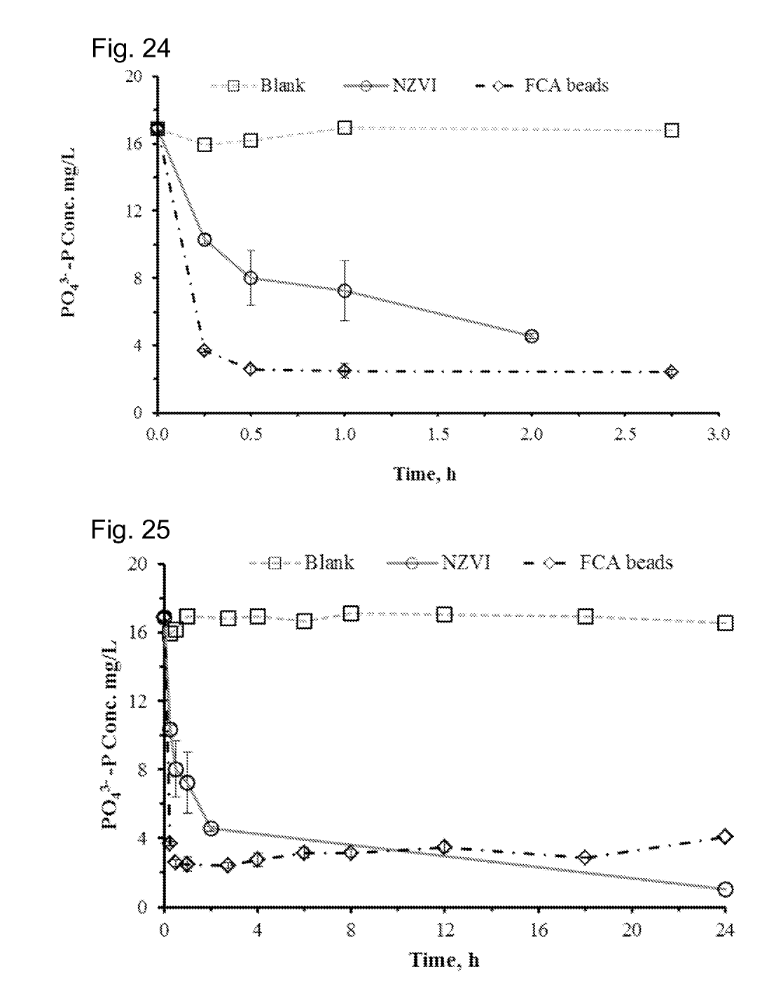

Batch study results have indicated that FCA beads were more efficient (85%) as compared to NZVI particles (57%) in the first hour (FIG. 24) of reaction in removing PO₄³⁻ from animal feedlot effluent (AFLE). Statistical analysis indicate that the results from these two sets of experiments are significantly different (one-way ANOVA, p=0.00). Data points could not be collected exactly at 2 h for all the samples due to management issues and, therefore, have not been compared.

The batch studies with the AFLE were continued till 24 h and it was observed that the overall PO₄³⁻ removal by FCA beads reduced from 85% in 1 h to 75% at 24 h (FIG. 25). There is no immediate explanation for this behavior of the beads till further research is conducted. However, a possible reason may have to do with the presence of orthophosphate in the particulate form. AFLE was used as received (without any filtration) for PO₄³⁻ removal using NZVI and FCA beads. A layer of visible black particles was observed on the beads at the end of the reaction which may be the particulate PO₄³⁻ and they might have contributed to the increase in PO₄³⁻ concentration. Further studies may be needed to understand this behavior of the beads. It is, however, clear that FCA beads can be used to remove phosphate from AFLE. PO₄³⁻ removal was ˜77% at the end of 15 min (Table 10). The short contact time needed for PO₄³⁻ removal is expected to have major ramifications as FCA beads can possibly be used in high flow system (e.g., pumped system).

TABLE 10
PO₄³⁻ removal from AFLE using NZVI and FCA beads

| | % PO₄³⁻ Removal | |
|---|---|---|
| Time, h | FCA | NZVI |
| 0.25 | 76.85 | 35.23 |
| 0.50 | 84.07 | 50.39 |
| 1.00 | 85.27 | 57.22 |
| 2.75 | 85.66 | 72.91 |
| 4.00 | 83.80 | — |
| 6.00 | 81.05 | — |
| 8.00 | 81.67 | — |
| 12.00 | 79.50 | — |
| 18.00 | 83.03 | — |
| 24.00 | 75.21 | 94.06 |

Data at 4, 6, 8, 12, and 18 h were not collected for NZVI studies

### Conclusions

NZVI and FCA beads successfully removed PO₄³⁻ from both municipal wastewater (WTPE) and animal feedlot effluent (AFLE). The fact that FCA beads could remove 63% and 77% PO₄³⁻ from WTPE and AFLE, respectively, within the first 15 min provides a huge advantage for their application in high flow systems. NZVI particles were also effective in removing PO₄³⁻ from waters. However, FCA beads performed better with AFLE. More experiments need to be conducted to determine the possibility of PO₄³⁻ recovery from FCA beads.

### Example 4

### Aqueous Selenium Removal Using Bare and Ca-Alginate Entrapped NZVI

Bare nanoscale zero-valent iron (NZVI) particles and NZVI entrapped in calcium (Ca) alginate beads were tested for the remediation of selenium (Se) species in aqueous solution. The study has demonstrated that NZVI is a very effective medium for the remediation of Se. In batch studies, bare NZVI reduced Se from 34 micrograms per liter (34 μg/L) to less than 1 μg/L (over 97% removal) in 3 h. The Ca-alginate entrapped NZVI achieved a slower yet effective removal (over 85% in 12 h). While the collection and disposal of spent bare NZVI were very difficult, the Ca-alginate entrapped particles were easier to be collected and disposed of. Ca-alginate entrapment appears to be a promising method for application in aqueous Se removal. Permeable reactive barriers with entrapped NZVI can be installed for groundwater remediation, and batch application method can be practiced for surface water, and filtration beds can be used for drinking water treatment. NZVI-sorbed Se was bioavailable to plants and can be used to fortify vegetables and grains with selenium, an essential micronutrient for humans.

### Introduction

Selenium (Se) is an essential micronutrient for both humans and animals, but there is a fine line between healthy and toxic levels. The USEPA has set the MCL for Se at 50 μg/L while the national recommended water quality criterion for surface waters is 5 μg/L. This 5 μg/L limit is recommended to account for possible bioaccumulation of Se through the aquatic food chain and sensitivity of aquatic species to elevated Se levels.

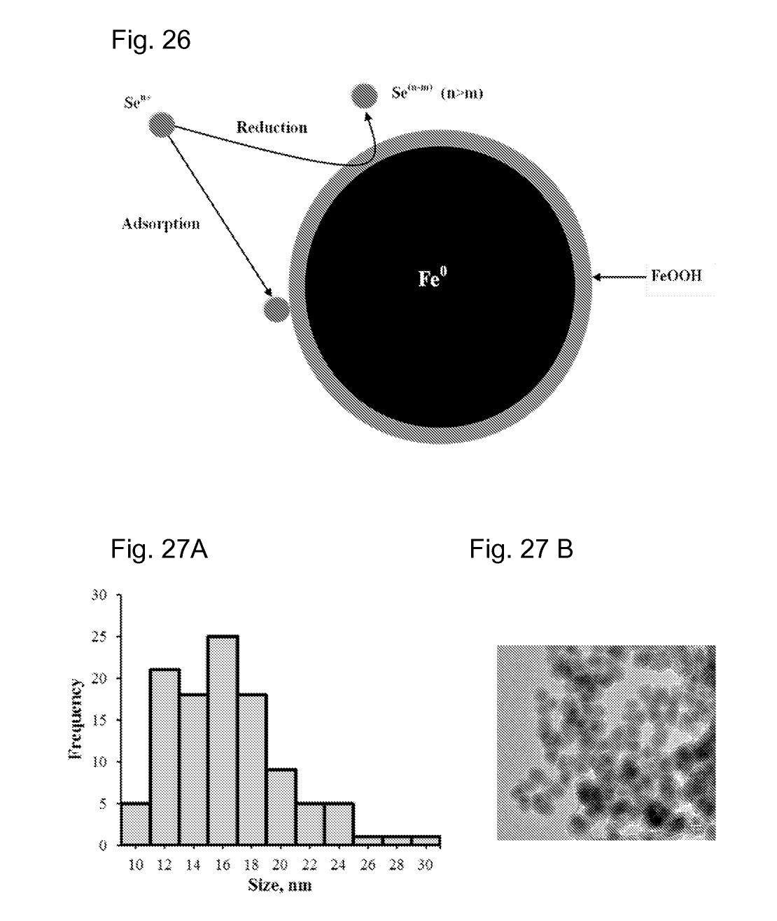

Selenium contamination in the environment is most commonly caused by runoff from mining operations where Se containing rocks become oxidized thus making them mobile as elemental Se(Se⁰) is insoluble and highly immobile. Contamination in surface waters is most commonly found in the soluble Se form as selenite (SeO₃²⁻) and selenate (SeO₄²⁻). Selenate is much more stable than selenite and thus more difficult to remove from surface waters. Olegario et. al.(2009) noted that the use of zero-valent iron (ZVI) is effective in the removal of selenate due to the reductive and adsorptive properties of ZVI. ZVI reduces the highly stable selenate to Se⁰ as well as adsorbs it onto it. The reduction of Se also increases the adsorption affinity by destabilization of the molecule, further increasing removal of Se (FIG. 26).

There have been several successful investigations into the use of ZVI for adsorption of Se from surface waters (Olegario et al., 2010 J Nanoparticle Res 12:2057-68; Zhang et al., 2008 Sci Total Environ 407:89-96; Ponder et al., 2000 Environ. Sci. Technol. 34:2564-69), but minimal research has been conducted on the use of zero-valent iron nanoparticles (NZVI). Mondal et al. (2004 Ind & Eng Chem Res 43:4922-34) conducted a study on the removal of selenate using NZVI with an average size of 17.7 μm. The achieved significant removals (90.2%) of selenate but removal was severely decreased with the introduction of competing ions. This reduces the viability of NZVI use in the environment where there are several anions competing in surface waters.

### Results

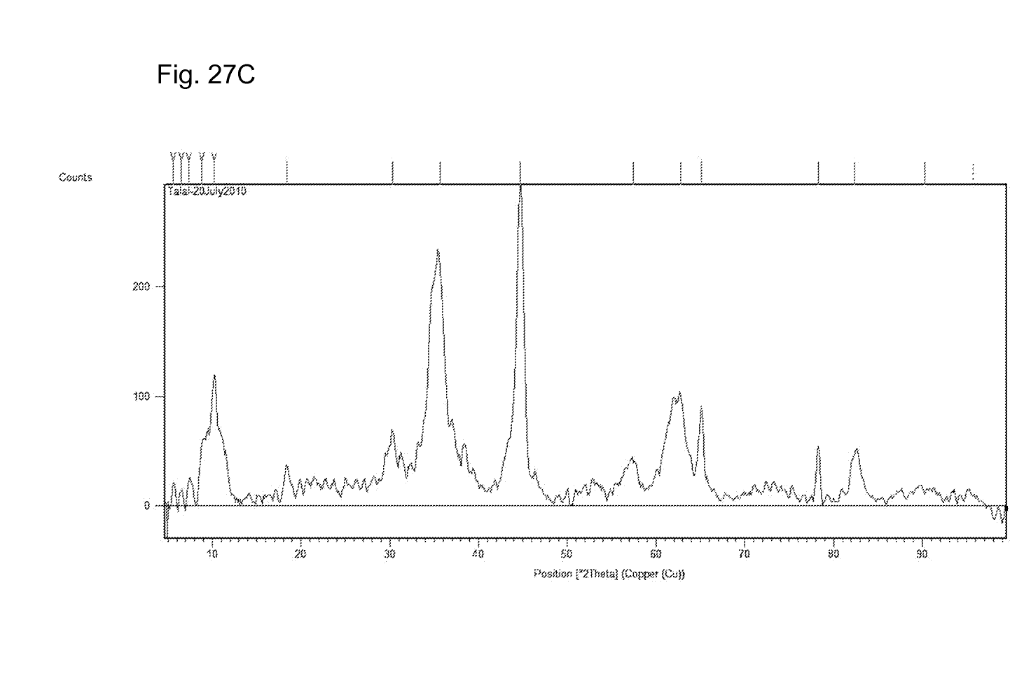

NZVI was synthesized in this study using the sodium borohydride method. This method produces nanoparticles with an average size of 16.45 μm (FIG. 27) significantly increasing specific surface area thus increasing the number of sites available for reaction with Se.

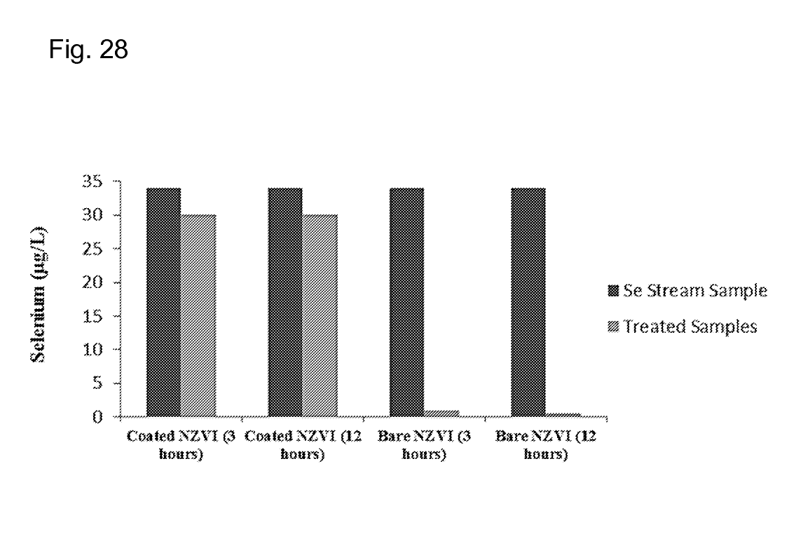

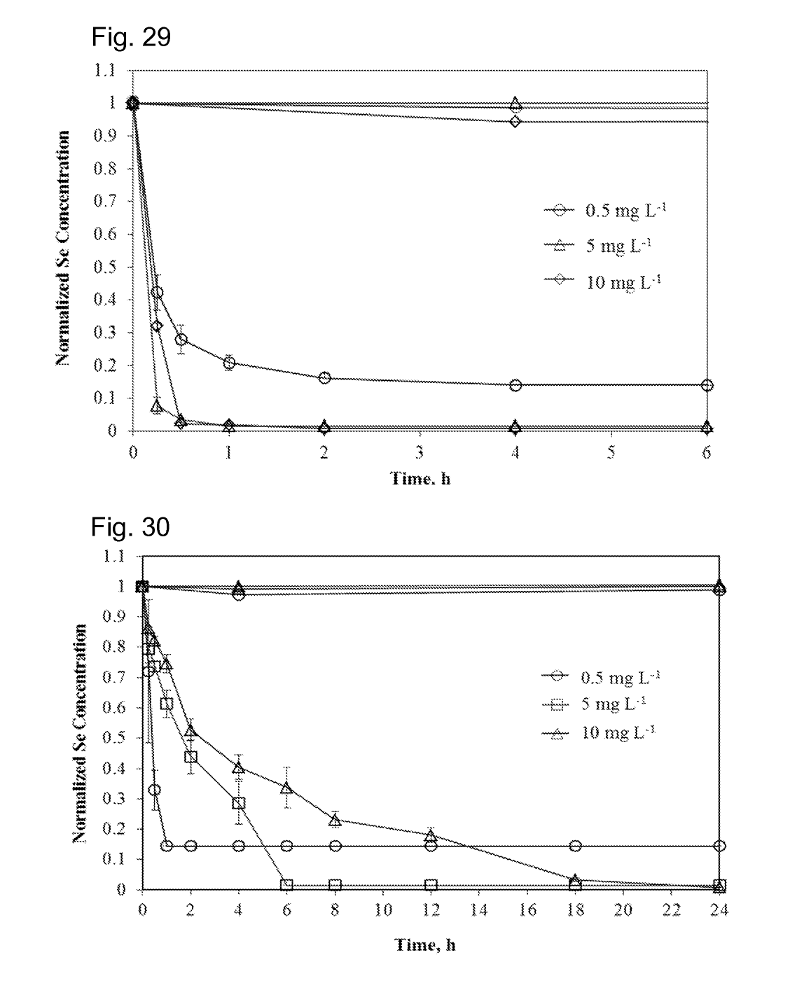

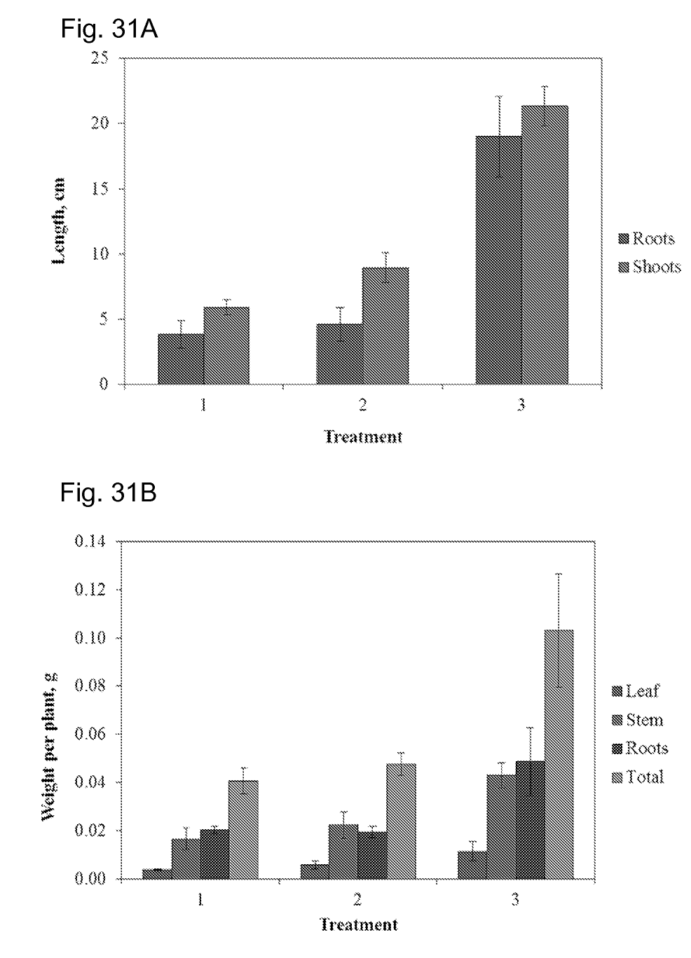

Preliminary batch tests were conducted with a solids concentration of 1 g NZVI/L. The samples tested were from a contaminated stream having an initial Se concentration of 34 μg/L with removal reaching the detection limits (<1 μg/L) after 3 h (FIG. 28). This demonstrates a great affinity for Se to NZVI even in the presence of interfering ions. Immobilized (coated) NZVI in biopolymer was also tested with inferior results and improvements of immobilization are to be investigated further.

### Example 5

### Aqueous Arsenic Removal Using Bare and Ca-Alginate Entrapped NZVI: Treatability and Mechanism Studies

The use of nanoscale zero-valent iron (NZVI) entrapped in calcium (Ca) alginate beads shows great promise for water and wastewater treatment. This research evaluated Ca-alginate entrapped NZVI as an advanced treatment technique for aqueous arsenic removal. Arsenic is a serious threat to human health and millions of people are affected by arsenic contamination in various parts of the world including the United States. In bench scale batch studies with initial As(V) concentrations of 1-10 mgL⁻¹, ˜80-100% arsenic removal was achieved within 2 h. While the reaction kinetics differ between bare and entrapped NZVI, the overall reductions of arsenic are comparable. Surface normalized arsenic reduction reaction rate constants (kₛₐ) for bare and entrapped NZVI were 3.40-5.96×10⁻³ and 1.90-4.43×10⁻³ L m⁻² min⁻¹, respectively. The entrapment process reduces mobility of the nanoparticles by confining them within the biopolymer matrix while also reducing their agglomeration. X-ray diffraction (XRD) and Fourier transform infrared spectroscopic (FT-IR) techniques have been used understand the mechanism of arsenic removal by the entrapped NZVI. Ca-alginate polymer is an excellent choice as an entrapment medium as it is non-toxic and has little solubility in water. After treatment entrapped particles can be more easily separated from liquid stream as well.

### Introduction

As our ability to provide safe potable water to an increasing world population has become more challenging, the demands for advanced water treatment techniques have intensified. One of these challenges is to reduce arsenic concentrations to an acceptable level in finished water. Long-term ingestion of arsenic has been linked to a number of debilitating health problems in humans including cancer (Marshall et al., 2007 J Natl Cancer Inst 99:920-928). More recently arsenic exposure has been linked with uterine function damage (Akram et al. 2010) as well as higher heart stroke rates (Lisabeth et al., 2010 Stroke 41:2499-2504). Water with ˜150 μgL⁻¹ arsenic caused cancer in 1% of men over the age of 30 in Chile which increased to 3% with ˜450 μgL⁻¹ arsenic and increased bladder cancer occurrences¹. Similar incidences have been reported from countries like Argentina, Bangladesh, India, Japan, United States, and Vietnam that have arsenic contamination (Mandal and Suzuki, 2002 Talanta 58:201-235). Long term ingestion of water containing arsenic, even at significantly lower concentrations, may result in unacceptable adverse chronic health risks (Shiber, 2005 Water Air Soil Poll 160:327-34105).

In 2006, the United States Environmental Protection Agency (U.S. EPA) reduced the maximum contaminant level (MCL) for arsenic in drinking water from 50 to 10 μgL⁻¹ (USEPA, “National primary drinking water regulations: arsenic and clarifications to compliance and new source contaminants monitoring: delay of effective date,” 2001 Federal Register 66:28342-28350). The stringent new MCL has challenged many water utilities particularly the small facilities as they do not have the resources needed to achieve the new treatment goal (USEPA, “Basic Information About the Arsenic Rule,” 2013, available on the World Wide Web at water.epa.gov/lawsregs/rulesregs/sdwa/arsenic/Basic-Information.cfm). As many as 3,000 community water systems serving 11 million people in the United States are reported to be not in compliance with the present MCL (USEPA, “Basic Information About the Arsenic Rule,” 2013, available on the World Wide Web at water.epa.gov/lawsregs/rulesregs/sdwa/arsenic/Basic-Information.cfm).

The most commonly used treatment techniques for arsenic remediation in drinking water include chemical precipitation (using iron or aluminum salts), coagulation/filtration, and ion exchange (USEPA, “Capital Costs of Arsenic Removal Technologies U.S. EPA Arsenic removal technology Demonstration Program Round 1,” 2004 (Chen et al.). EPA/600/R-04/201, Cincinnati, Ohio). Chemical precipitation works effectively in large treatment facilities, but small treatment units cannot generally adopt this process because of space and resource limitations (Farrell et al., 2001 Environ Sci Technol 35:2026-2032). Coagulation calls for increased infrastructure as it needs to be followed by sedimentation and filtration, and it is not very effective in arsenic removal (Mohan and Pittman, 2007 J Hazard Mater 142:1-53). Ion-exchange is very effective in arsenic removal but oftentimes results in a high operational and maintenance cost as well as produces toxic concentrates and solid wastes (Mohan and Pittman, 2007 J Hazard Mater 142:1-53).

Nanoscale zero-valent iron (NZVI) particles have evolved into a very versatile material for aqueous contaminant remediation including chlorinated compounds (Bezbaruah et al., 2011 J Nanopart Res 13:6673-6681; Krajangpan et al., 2012 Environ Sci Technol 46:10130-10136), explosives (Kim et al., 2007 Environ Pollut 147:634-641), heavy metals (Moraci and Calabro, 2010 J Environ Manage 91:2336-2341), pesticides (Thompson et al., 2010 Environ Eng Sci 27:227-232), and inorganics (Almeelbi and Bezbaruah, 2012 J Nanopart Res 14:1-14; Bezbaruah et al., 2009 J Hazard Mater 166:1339-1343) to name a few. NZVI is characterized by smaller particle size (<100 nm) and higher surface area (22-54 m²g⁻¹, Bezbaruah et al., 2009 J Hazard Mater 166:1339-1343; Liu et al., 2005 Environ Sci Technol 39:1338-1345) as compared to micro ZVI (MZVI) which has a size in the μm range and surface area of 1-2 m²g⁻¹(Thompson et al., 2010 Environ Eng Sci 27:227-232). Contaminant remediation by NZVI is known to be a surface mediated process (Li et al., 2006 Crit Rev Env Sci Tec 36:405-431) and NZVI nanoparticles can react approximately 1,000 times faster than MZVI (Kanel et al., 2005 Environ Sci Technol 39:1291-1298; Kanel et al., 2006 Environ Sci Technol 40:2045-2050).

NZVI is capable of removing arsenic from groundwater by surface precipitation or adsorption when arsenic is in a pentavalent oxidation state [As(V), Su et al., 2001 Environ Sci Technol 35:1487-1492]. Trivalent arsenic [As(III)] removal by NZVI can be attributed to spontaneous adsorption and co-precipitation of iron oxides/hydroxides which are formed due to oxidation of NZVI (Kanel et al., 2005 Environ Sci Technol 39:1291-1298). While NZVI particles are very effective in remediating arsenic to low concentrations there are certain disadvantages associated with their small particle size. NZVI particles quickly become dispersed and mobile in the aquifer. They may also agglomerate if present in high concentrations resulting in the formation of larger particles which tend to precipitate out in the pores of the aquifer materials (Krajangpan et al., 2012 Environ Sci Technol 46:10130-10136). Reactivity of nanoparticles is reduced as the particles lose some of their reactive surface area due to such agglomeration. The nanoparticles may also pose danger to micro and higher organisms if present in unreacted (ZVI) stage (Phenrat et al., 2009 Environ Sci Technol 43:195-200). Further, arsenic sorbed onto NZVI may still be potent toxicant to human and other ecosystem components. Lack of control over the particles' dispersion behavior and their mobility makes it difficult to use them on cases where a stationary treatment medium (e.g., a permeable reactive barrier) is needed.

Calcium (Ca) alginate is a popular material used for entrapping microbial cells used in the food and beverage industries (Roy et al., 1987 J Dairy Sci 70:506-513), pharmaceutical industries (Brachkova et al., 2010 Eur J Pharm Sci 41:589-596), and water treatment (Hill and Khan, 2008 Water Air Soil Poll 195:23-33). In recent years Ca-alginate has been used to entrap or encapsulate NZVI to treat nitrate (Bezbaruah et al., 2009 J Hazard Mater 166:1339-1343) and trichloroethylene (Bezbaruah et al., 2011 J Nanopart Res 13:6673-6681; Kim et al., 2010 J Hazard Mater 176:1038-1043). Ca-alginate is porous enough to allow contaminants to diffuse through it and come in contact with the entrapped materials. Alginate is nontoxic, non-immunogenic and relatively insoluble in water making it an ideal material for environmental applications (Hill and Khan, 2008 Water Air Soil Poll 195:23-33).). Bezbaruah et al. (2009 J Hazard Mater 166:1339-1343) have demonstrated that NZVI particles do not lose their reactivity when entrapped in Ca-alginate beads. This paper reports removal of pentavalent arsenic [As(V)] by NZVI entrapped in Ca-alginate beads and discusses mechanism of removal.

### Materials and Methods

### Chemicals and Reagents

Iron(II) sulfate heptahydrate (FeSO₄·7H₂O, 99% pure, Alfa Aesar), sodium borohydride (NaBH₄, 98%, Aldrich), calcium chloride (CaCl₂, ACS grade, BDH), sodium hydroxide (5 N NaOH, Alfa Aesar), sodium (Na) alginate (production grade, Pfaltz & Bauer), diarsenic pentoxide (As₂O₅, Alfa Aesar), nitric acid (HNO₃, 68%, J. T. Baker), methanol (production grade, BDH), and ethanol (ACS grade, Mallinckrodt Chemicals) were used as received unless otherwise specified.

### NZVI Synthesis and Entrapment Procedure

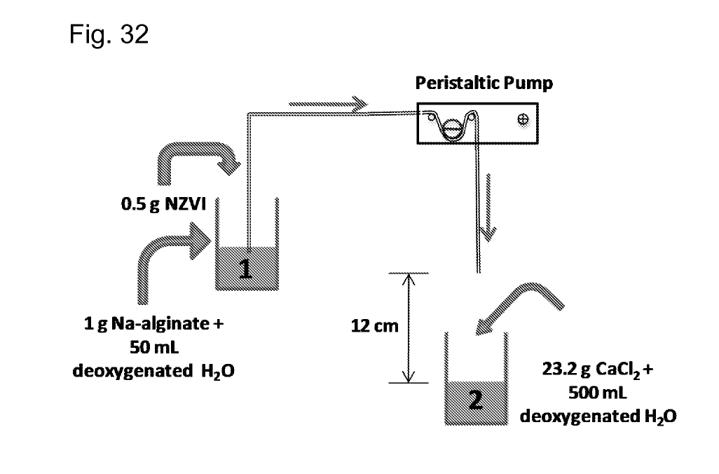

ZVI nanoparticles were produced using the borohydride reduction of ferrous iron (Bezbaruah et al., 2009 J Hazard Mater 166:1339-1343; Liu et al., 2005 Environ Sci Technol 39:1338-1345; Thompson et al., 2010 Environ Eng Sci 27:227-232). Ca-alginate beads were made (FIG. 32) following method described by others (Bezbaruah et al. 2009). One gram of Na-alginate was dissolved in 50 mL deoxygenated deionized (DI) water (2% w/v) at room temperature (˜22±2° C.), and mixed using a magnetic stirrer for 3-5 h, until solution appeared uniform. After mixing was achieved the Na-alginate solution was allowed to sit for an additional period of no less than 30 min to allow any air bubbles to escape from the solution. NZVI (0.5 g) was then added expeditiously (to avoid oxidation) to the Na-alginate solution and stirred with a glass rod to get a well-mixed solution (Solution 1). A deoxygenated aqueous calcium chloride solution was prepared separately by adding 23.2 g of CaCl₂ to 500 mL of deoxygenated DI water (Solution 2). Next, Solution 1 was added drop-wise into Solution 2 using a peristaltic pump (Masterflex, Cole Parmer, 0.5 mm ID tubing, 2.5 mL min⁻¹ flow rate) from a height of 12 cm (optimized based on a number of trials) to form Ca-alginate beads. Solution 1 was continuously stirred with a glass rod while pumping it to ensure that almost all NZVI was transferred into the beads. Additional amount of Na-alginate solution was used if needed to ensure that all NZVI particles were transferred to the beads. About 0.19% NZVI might not have been possibly transferred in this process (Bezbaruah et al., 2009 J Hazard Mater 166:1339-1343). The beads were allowed to harden in the CaCl₂ solution for 6-9 h to achieve adequate hardness and porosity (Bezbaruah et al., 2009 J Hazard Mater 166:1339-1343), and then rinsed and stored in deoxygenated DI water.

### Batch Studies

Batch arsenic removal studies were performed under anaerobic conditions in reactors made of 500 mL commercial grade polyethylene terephthalate bottles fitted with a sleeve type silicone septum seal. The minimal head space left after 500 mL solution was added to the reactor was purged with N₂ gas to flush out air (oxygen). A 100 mgL⁻¹ As(V) stock solution was prepared using As₂O₅, and used to make solutions with initial As(V) concentrations of 1, 5, and 10 mgL⁻¹. Four study groups were analyzed with different concentrations of arsenic. Group 1 used 0.5 g bare NZVI particles; Group 2 used Ca-alginate entrapped NZVI particles (0.5 g NZVI); Group 3 had only Ca-alginate beads (made from 50 mL Na-alginate) with no entrapped NZVI; and Group 4 consisted of blanks run with only arsenic solution (no NZVI or Ca-alginate beads). The reactors were rotated end-over-end at 28 rpm in a custom-made shaker. The samples were collected at 0, 5, 15, 30, 45, 60, 90, 120 min using a syringe (10 mL, Beckton-Dickinson) fitted with a needle. This technique protected against possible oxygenation of the test solution in the reactors during sample collection. The samples were then filtered using a syringe filter (Whatman ANOTOP 25, 0.02 μm) to remove any leaked out NZVI from the beads, and preserved using nitric acid for ICP analysis later. All experiments were conducted in triplicate (for each study group).

### Analysis and Characterization

ICP Analysis: The concentration of arsenic was measured using Spectro Genesis SOP ICP-OES (Scott double-pass nebulizer). SmartAnalyzer (version v.3.013.0752) software was used. The machine was set with a specific plasma power (1,425 watts), constant flow (13.5 Lmin⁻¹), auxiliary flow (1.2 Lmin⁻¹), nebulizer flow (0.9 Lmin⁻¹), and the integration time of 21 s. A 4-point standard calibration was done using single element standards with a matrix of 5% HNO₃. All samples were randomized prior to analysis and the results were reported as the mean of 3 replicate measurements. A control check standard was analyzed after every 20 samples to ensure that the values measured were within 10% of the expected value.

XRD Analysis: Powder X-Ray Diffraction (PXRD) analysis was done to determine the crystalline materials [e.g., magnetite (Fe₃O₄) and iron (Fe⁰)] in alginate beads, NZVI, NZVI that sorbed arsenic (NZVI-As), alginate entrapped NZVI (Alginate-NZVI), and alginate entrapped NZVI that sorbed arsenic (Alginate-NZVI-As beads). The samples were dried in vacuum oven under nitrogen environment for two days. The dried samples were ground finely using a mortar with pestle. The powdered samples were placed/spread on micro slides (15×15 mm) and experiments were performed on Philips X'Pert MPD system with Cu Kα radiation. Bragg-Brentano para-focusing optics (fix divergence slit=1°, receiving slit=0.2 mm, 15 mm mask) was used for all 5 samples, which were scanned by an applied current of 40 mA and a voltage of 45 kV with 2 theta step 0.05° and step time 5s.

FT-IR Analysis: FT-IR spectra were obtained with a Nicolet 6700 FT-IR Spectrometer operated with OMNIC software. The spectra were observed from 400 to 4000 cm⁻¹ using potassium bromide (KBr) as a background. The samples were dried in vacuum oven under nitrogen environment for two days. The dried samples were mixed with KBr corresponding to approximate mass ratio of 1:10 (sample:KBr) for pellet preparation. Spectra were recorded at a resolution of 4 cm⁻¹ with each spectrum corresponding to the coaddition of 64 scans. The background collected from KBr was automatically subtracted from the sample spectra. The spectral information were collected and plotted in the same scale on absorbance axis.

### Results and Discussion

### NZVI Synthesis and Entrapment in Ca-alginate Beads

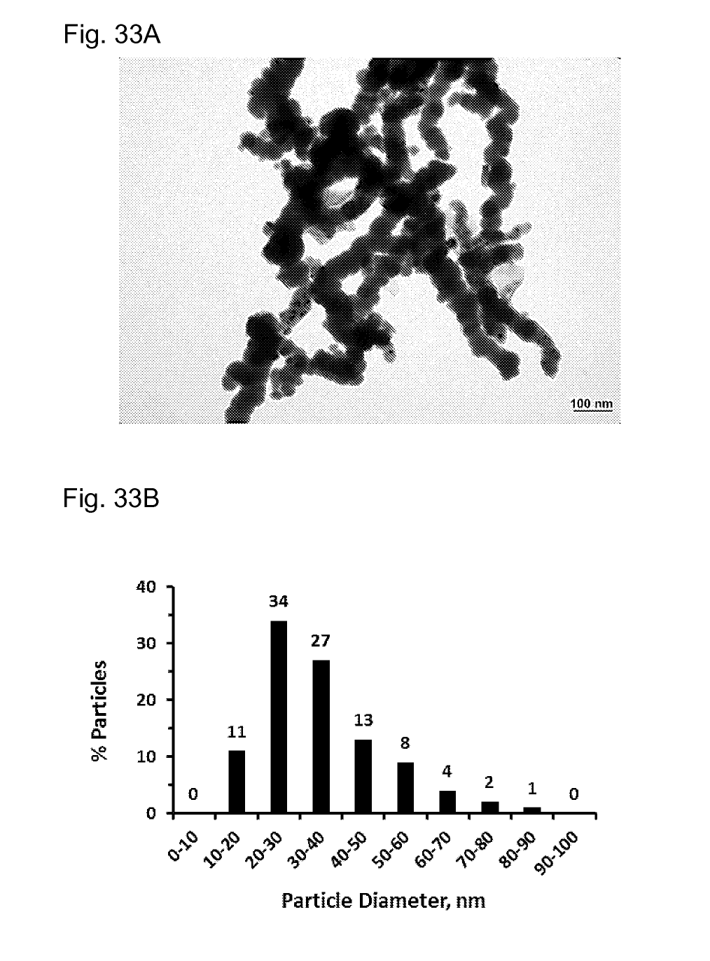

The NZVI produced during this study (FIG. 33a-b) had ˜35 nm average particle size (all particles<100 nm), and an average BET surface area of 25 m²g⁻¹ Characterization of this type of NZVI has been reported earlier by the corresponding author's research group (Bezbaruah et al., 2009 J Hazard Mater 166:1339-1343; Krajangpan et al., 2012 Environ Sci Technol 46:10130-10136; Thompson et al., 2010 Environ Eng Sci 27:227-232).

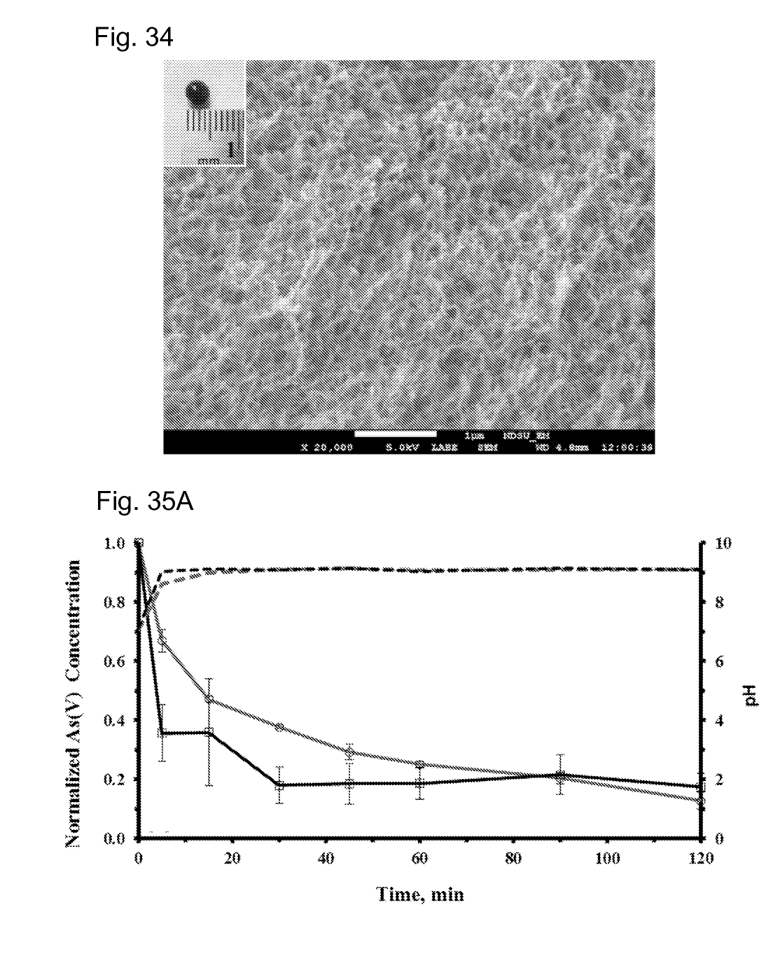

The NZVI entrapped Ca-alginate beads produced during this study had an average size of 3.4±0.13 mm (FIG. 34 inset). The beads were hardened in CaCl₂ for more than 6 h to ensured adequate porosity for contaminant diffusion into the beads (Bezbaruah et al., 2009 J Hazard Mater 166:1339-1343). Scanning electron microscopy image of the beads shows a porous interior (FIG. 34). Earlier Aksu et al. (1998 Process Biochem 33:393-400) reported no problem with diffusion of contaminants into the beads after adequate hardening in CaCl₂ solution. Bezbaruah et al. (2009 J Hazard Mater 166:1339-1343) reported that agglomeration is reduced if NZVI particles are entrapped in Ca-alginate beads.

### Treatability Studies

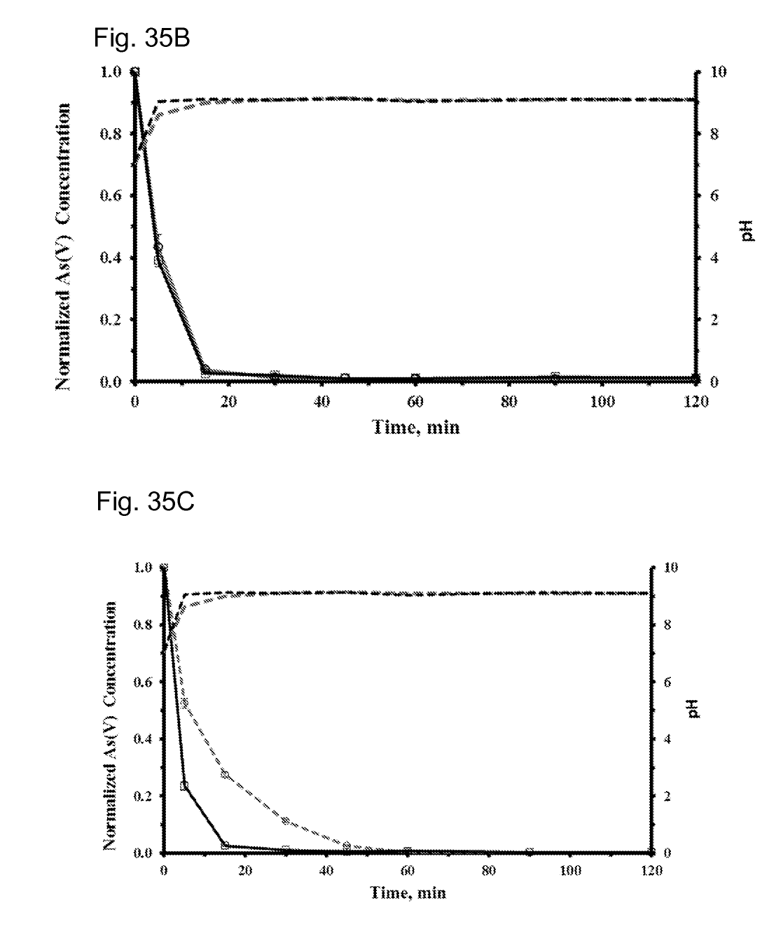

Both bare and entrapped NZVI showed similar As(V) removal characteristics. In a 2-h period bare NZVI (1 gL⁻¹, 0.0179 M Fe⁰) reduced arsenic concentration from 10 mgL⁻¹ (1.33×10⁻⁴ M), 5 mgL⁻¹ (6.66×10⁻⁵ M), and 1 mgL⁻¹ (1.33×10⁻⁵ M) to 0.042 mgL⁻¹ (99.58% reduction), 0.050 mgL⁻¹ (99.00%), and 0.230 mgL⁻¹ (77.00%), respectively (FIG. 35). Kanel et al. (2006 Environ Sci Technol 40:2045-2050) had similar results (37.90-100.00%) with bare NZVI (1 gL⁻¹) for As(V) removal. The entrapped NZVI particles (1 gL⁻¹) used in this study reduced arsenic concentrations from 10, 5, and 1 mgL⁻¹ to 0.042 (99.58% reduction), 0.042 (99.16%), and 0.165 mg L⁻¹ (83.50%), respectively. Controls (with only Ca-alginate beads and no NZVI) had only a slight arsenic reduction (<10.00%) in the first 30 min of the reaction at all concentration levels but no further reduction of arsenic was observed over time (data not shown). The small initial change observed can be attributed to physical sorption to the Ca-alginate bead. Others also have observed similar initial minor reduction of contaminant concentrations with alginate beads (Bezbaruah et al., 2009 J Hazard Mater 166:1339-1343; Hill and Khan, 2008 Water Air Soil Poll 195:23-33). Blanks (only arsenic with no Ca-alginate beads or NZVI) showed no change in arsenic concentration over time (data not shown).

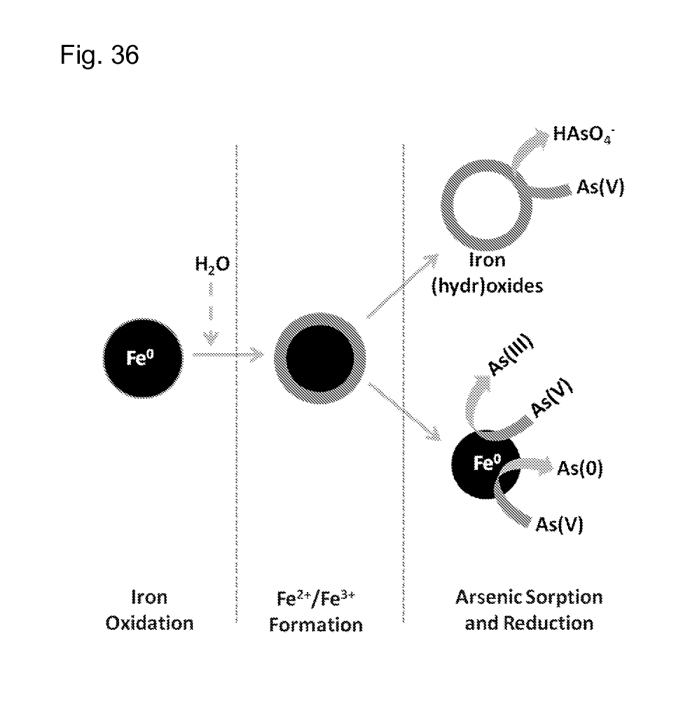

The possible mechanisms of arsenic removal by NZVI have been reported by others. Water oxidizes iron (Fe⁰) to Fe²⁺ even when no dissolved oxygen is present (Eq. 5; Kanel et al., 2006 Environ Sci Technol 40:2045-2050; Su and Puls, 2001 Environ Sci Technol 35:1487-1492). The Fe²⁺ formed then reacts with OH⁻ to produce ferrous hydroxide Fe(OH)₂ (Eq. 6; Kanel et al., 2005 Environ Sci Technol 39:1291-1298). As(V) is possibly removal by NZVI via reduction, and hydrous ferric oxides adsorbs arsenic (Kanel et al., 2006 Environ Sci Technol 40:2045-2050). There is also a possibility of Fe³⁺ formation due to oxidation by water (Han et al., 2011 Water Res 45:593-604). NZVI particles similar to those used in this experiment were found to have a NZVI core and FeOOH shell structure (Martin et al., 2008 Langmuir 24:4329-4334). The corresponding author's group has earlier reported a thin (˜2-5 nm) passivating iron oxide layer on freshly produced NZVI (Bezbaruah et al., 2009 J Hazard Mater 166:1339-1343; Krajangpan et al., 2012 Environ Sci Technol 46:10130-10136; Thompson et al., 2010 Environ Eng Sci 27:227-232). The presence of mixed oxides might have helped in arsenic removal; arsenic might have been reduced from As(V) to As(III) and As(0), and then adsorbed and/or co-precipitated (Bang et al., 2005 Water Res 39:763-770; Ramos et al., 2009 J Phys Chem C 113:14591-14594; Wan et al., 2010 Water Res 44:5098-5108). Recent theory of dual redox functionality of NZVI by Yan et al. (2010 Chem Commun 46:6995-6997) needs special reference here; they suggested that while oxide layer sorbs As(V), the core ZVI reduces As(V) to As(III) and then to As(0). A schematic of possible arsenic removal mechanism in deoxygenated water environment is presented in FIG. 36.

Fe⁰+2H₂O→Fe²⁺+H₂+2OH⁻ (5)

Fe²⁺+2OH⁻→Fe(OH)₂ (6)

### Kinetics

Analysis of the relevant data points indicates that the arsenic reduction reactions followed pseudo first order kinetics for both bare and entrapped NZVI. The observed reaction rate constants (k_{obs}) were found to be in the range 4.74×10⁻² to 11.08×10⁻² min⁻¹ for bare NZVI, and 8.51×10⁻²−14.90×10⁻² min⁻¹ for entrapped NZVI (Table 11). Kanel et al. (2006 Environ Sci Technol 40:2045-2050) reported a k_{obs} value of 7.1×10⁻¹ min⁻¹ for As(V) removal by bare NZVI. In the case of small sized ZVI, the reaction is known to be surface mediated (Matheson and Tratnyek, 1994 Environ Sci Technol 28:2045-2053), and it is, therefore, pertinent to relate the reaction rate constant to the total NZVI surface area. Surface normalized reaction rate constant, kₛₐ (Eq. 7), makes it easier to compare efficacy of nanoparticles produced via different synthesis routes (i.e., having different surface characteristics). It should, however, be noted that the adaptation of kₛₐ is debatable. While Cwiertny and Roberts (2005) did not find linearity of surface area-normalized rate constants with iron loading, Matheson and Tratnyek (1994 Environ Sci Technol 28:2045-2053) did. A surface area normalized rate equation can be proposed after Johnson et al. (1996 Environ Sci Technol 30:2634-2640) as:

dC/dt=−kₛₐC=−k_{obs}aₐₚC (7)

where kₛₐ is the surface area-normalized rate constant (Lm⁻²min⁻¹) and aₙₚ is the iron surface area concentration (m²L⁻¹).

The surface area normalized rate constants (kₛₐ) are calculated here (Table 11) using an iron surface area of 25 m²g⁻¹.

TABLE 11
First order reaction rate constants (k_{obs}) and surface normalized rate
constants (kₛₐ) for arsenic removal with bare and entrapped NZVI

| | Initial As(V) | Observed | Surface | |
|---|---|---|---|---|
| | Concen- | Reaction Rate | Normalized Rate | |
| | tration | Constant, k_{obs} | Constant, kₛₐ | |
| Batch | (mgL⁻¹) | (min⁻¹) | (L m⁻² min⁻¹) | R² |
| Bare NZVI | 1 | 4.74 × 10⁻² | 1.90 × 10⁻³ | 0.7844 |
| | 5 | 9.81 × 10⁻² | 3.92 × 10⁻³ | 0.8174 |
| | 10 | 11.08 × 10⁻² | 4.43 × 10⁻³ | 0.8753 |
| Entrapped | 1 | 14.90 × 10 | 5.96 × 10⁻³ | 0.9137 |
| NZVI | 5 | 10.40 × 10⁻² | 4.16 × 10⁻³ | 0.8569 |
| | 10 | 8.51 × 10⁻² | 3.40 × 10⁻³ | 0.9852 |

The reaction rate constants obtained from bare and entrapped NZVI were compared. Two-way analysis of variance shows no significant difference between the reaction rate constants at 95% confidence (p-value>0.05) with the exception of the 1 mgL⁻¹ arsenic concentration. Entrapped NZVI (1 mgL⁻¹ arsenic) showed a significantly greater removal efficiency than bare NZVI (p-value=0.01). The fact that entrapped NZVI particles removed arsenic as efficiently as bare NZVI has great ramifications in environmental remediation and opens up the possibilities of use of entrapped NZVI in remediation sites (specifically in permeable reactive barriers) and in filters. The entrapped NZVI used in such applications are not expected to be mobile, and, hence, the danger of they reaching undesired recipients (micro and higher organisms) can be ruled out or minimized.

### XRD and FT-IR Analyses

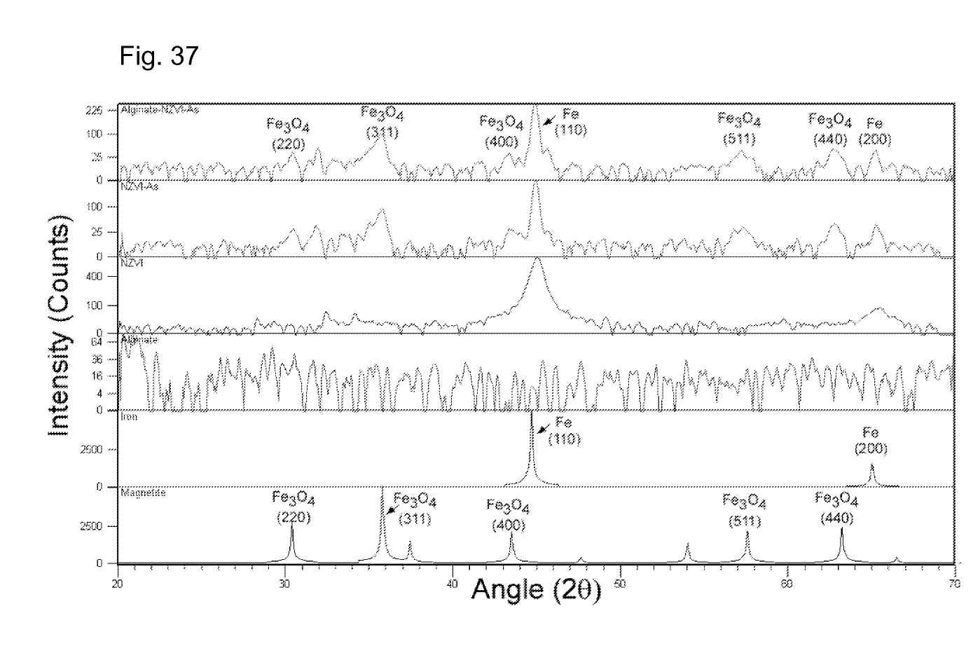

Powder XRD is very powerful and common technique for characterization of crystalline phases in materials. Magnetite and iron are known to crystalize in Fd3m and Im3m space groups, respectively (Downs and Hall-Wallace, 2003 Am Mineral 88:247-250). In order to identify them in the beads, the XRD studies were performed in 2θ range from 2θ to 70 degrees. The five most intensive peaks of Fe₃O₄ in this 2θ range are at: 30.39° (attributed to 220 plane), 35.48° (311), 43.52° (400), 57.57° (511), 63.23° (440). Fe(0) has only two characteristic peaks in this region at 44.68° and 65.03 which are assigned to (110) and (200) planes in Im3m space group. All XRD results and simulated spectra of Fe₃O₄ and Fe(0) are shown in FIG. 37. As can be seen, the alginate-NZVI-As and NZVI-As samples (samples after arsenic removal study was complete) have all characteristic picks of both, Fe₃O₄ and Fe(0) while virgin bare NZVI has only Fe(0). The additional oxide peaks for NZVI after reaction with arsenic is consistent with the theory of arsenic removal by NZVI (FIG. 37). The similarity of the spectra from bare and entrapped NZVI after reaction with arsenic reconfirms that the degradation reactions were same. A few feeble peaks around 32-35° in virgin bare NZVI spectrum are indicative of the presence of the passivating oxide layer around the particles. Obviously these peaks are shifted from the observed magnetite peaks. These peaks can be assigned to the two most intensive peaks of Fe₂O₃ (hematite) at 33.12° (104) and 35.61° (110). The spectrum for only alginate does not show any crystalline materials and is given here for comparison. The two spectra at the bottom are simulated to indicate the exact positions of the peaks of the crystals of interest.

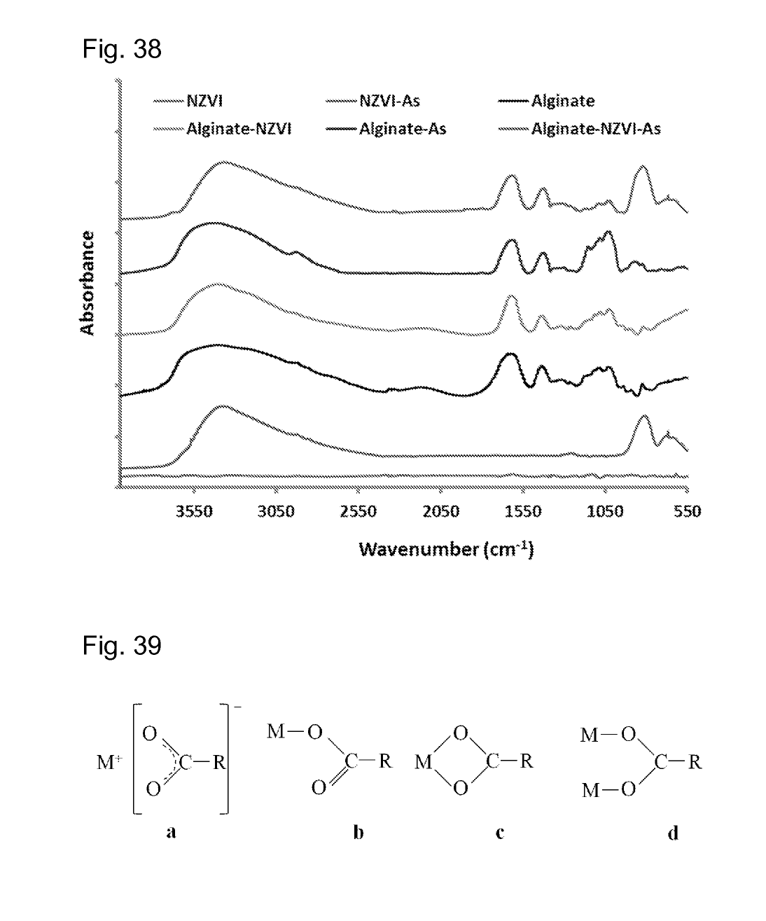

FT-IR analyses were carried out to elucidate the binding of arsenic to Ca-alginate entrapped NZVI. FIG. 38 provides the spectra for the samples of bare NZVI and only alginate bead before reaction with arsenic, and bare NZVI, alginate entrapped NZVI after reaction with arsenic, and only alginate after sorbing arsenic. FT-IR spectra of alginate (only) and bare NZVI were collected to serve as references. There are no significant peaks in the spectra for NZVI. Even though NZVI has a layer of iron oxides, the oxide layer was very thin and concentration is not high enough to get a sharp peak in the FT-IR spectra. The spectra for alginate (only), Alginate-As and Alginate-NZVI-As shows the carboxymethyl group that has two peaks at ˜1620 and ˜1433 cm⁻¹. The spectras have C-O (ether) stretching at ˜1030 cm⁻¹. The additional peaks in NZVI-As and Alginate-NZVI-As at ˜470, and ˜660 cm⁻¹ are As-O stretch vibration, and the peak at ˜809 corresponds to As-O-Fe bond. The absence of sharp peak in Alginate-As at 809 cm⁻¹ shows the absence of binding of arsenic to alginate, and the presence of a weak band at ˜870 cm⁻¹ is for As-O stretching for pure sodium arsenate. This confirms simple absorption of arsenic by alginate beads in the first a few minutes during treatability studies. The observation that Ca-alginate is not participating in any As-alginate is important because the authors wanted to use the alginate the dispersing matrix for NZVI and it is not expected to participate in As removal in a significant way.

### Conclusions

Entrapment of NZVI was successfully done using alginate biopolymer. Ca-alginate entrapped NZVI removed ˜80-100% aqueous arsenic (1-10 mgL⁻¹) within 2 h. While the reaction kinetics differs between bare and entrapped NZVI, the overall reductions of arsenic are comparable. Surface normalized arsenic reduction reaction rate constants for bare and entrapped NZVI were 3.40-5.96×10⁻³ and 1.90-4.43×10⁻³ L m⁻² min⁻¹, respectively. The results indicate that entrapment of NZVI in Ca-alginate does not reduce reactivity of the nanoparticles. By immobilizing the NZVI particles in alginate, it will be easier to retrieve and dispose the nanoparticles with arsenic sorbed onto them. The entrapment process reduces mobility of the nanoparticles by confining them within the benign polymer matrix.

### Environmental Significance

Ca-alginate polymer is an excellent choice for an entrapment material as it is non-toxic and has little solubility in water. It is also important to note that arsenic does not bind with Ca-alginate but only with iron. Ca-alginate entrapped NZVI particles can be used in permeable reactive barriers or point-of-use treatment for arsenic.

### Example 6

### Crosslinked Alginates

The use of a number of biopolymers like alginate, Poly(methyl methacrylate) (PMMA), chitosan, and carrageenan have been explored for environmental remediation applications (Bezbaruah et al., 2009 J Hazard Mat 166:1339-1343; Bezbaruah et al., 2011 J Nanopart 13:6673-6681).

Alginate is a biopolymer derived from seaweeds, and it has been used for entrapment for microbial cells and NZVI (Bezbaruah et al., 2009 J Hazard Mat 166:1339-1343; Kim et al., 2010 J Hazard Mat 176:1038-1043). The entrapped NZVI was found to work very efficiently for contaminants like trichloroethylene (TCE). The entrapment process does not require sophisticated instrumentation and can be performed at ambient temperature and pressure. Ca-alginate is non-toxic, biodegradable, and sparsely soluble in water making it an ideal polymer for use in environmental applications (Bezbaruah et al., 2009 J Hazard Mat 166:1339-1343). The porous nature of Ca-alginate allows solutes to diffuse and come in contact with the entrapped NZVI (Bezbaruah et al., 2009 J Hazard Mat 166:1339-1343).

Ionic cross-linking refers to the ion exchange process between the monovalent ion on the water soluble alginate (e.g., sodium or potassium ions) and the multivalent ion (e.g., Ca²⁺) to give a sol/gel transition (Draget et al., 1998 Carbohydr Polym, 35:1-6). The characteristic chelate-type ion-binding properties of alginates can be explained by ‘egg-box’ model in which electronegative cavities are formed by polyguluronic chains in alginate to host divalent cations (Grant et al., 1973 FEBS Lett. 32:195-198; Morris et al., 1978 Carbohyd Res, 66:145-154). In this model, guluronate sequences are responsible for creating cavities where the multivalent ions coordinate along the alginate chains (Mehrotra et al., in Metal Carboxylates. Academic Press: London, UK, 1983). The coordination of metal—carboxylate can occur in different ways: (a) an ionic or uncoordinated form, (b) unidentate coordination, (c) bidentate chelating coordination, and (d) bidentate bridging coordination (FIG. 39, Papageorgiou et al., 2010 Carbohyd Res 345:469-473).

Sodium alginate is the salt of alginic acid which consists of two uronic acids, b-D-mannuronic acid and a-L-guluronic acid. Ca²⁺ is typically used to replace Na⁺ in alginate to produce Ca-alginate. This stable gels is formed as Ca²⁺ interact ionically with blocks of uronic acid residues to form a three-dimensional network that is usually described by the ‘egg-box’ model (Papageorgiou et al., 2010 Carbohyd Res 345:469-473). Other di-valent ions such as Fe⁺² can also be used to cross-link with alginate. Fe⁺² has been cross-linked with alginate and used in the biomedical research (Machida-Sano et al., 2009 Biomed Mat 4:025008).

The complete disclosures of all patents, patent applications including provisional patent applications, publications including patent publications and nonpatent publications, and electronically available material (e.g., GenBank amino acid and nucleotide sequence submissions) cited herein are incorporated by reference. The foregoing detailed description and examples have been provided for clarity of understanding only. No unnecessary limitations are to be understood therefrom. The invention is not limited to the exact details shown and described; many variations will be apparent to one skilled in the art and are intended to be included within the invention defined by the claims.

1. A method for removing a contaminant from an aqueous medium comprising:
contacting the aqueous medium with a remediation material comprising bare nanoscale zero-valent iron (NZVI) particles or Ca-alginate entrapped NZVI under conditions and for a time effective to sorb the contaminant.

2. The method of claim 1 wherein the remediation material is formulated as a bead.

3. The method of claim 1 wherein the contaminant comprises a phosphorous containing compound, a selenium containing compound, an arsenic containing compound, or any combination thereof.

4. The method of claim 3 wherein the contaminant comprises orthophosphate (PO₄³⁻), hydrogen phosphate (HPO₄²⁻), dihydrogen phosphate, (H₂PO₄⁻), magnesium ammonium phosphate (MgNH₄PO₄·6H₂O, struvite), hydroxyapatite, a polyphosphate, an organic phosphate, a selenate, Se(VI), SeO₄⁻², a selenite, Se(IV), HSeO₃, elemental selenium, a selenide, (Se-II), Se²⁻, HSe⁻, As(III), As(V) or any combination thereof.

5. The method of claim 1 wherein the aqueous medium is a eutrophic lake, municipal and industrial wastewater, agricultural runoff, effluent from water or sewer treatment plants, acid mine drainage, sludge, groundwater, a reservoir, well water, a marsh, swamp, a bay, an estuary, a river, a stream, an aquifer, a tidal or intertidal area, a sea or an ocean.

6. The method of claim 1 wherein the pH of the aqueous medium is higher than 7.5.

7. The method of claim 1 wherein the remediation material is disposed within a stationary treatment medium.

8. The method of claim 7, wherein the stationary treatment medium comprises a permeable reactive barrier, a slurry wall, a filtration bed, or a filter.

9. The method of claim 1 wherein the contacting step comprises contacting the aqueous medium with the remediation material under conditions to yield a used remediation material comprising a sorbed contaminant, wherein the sorbed contaminant comprises a nutrient, the method further comprising:
collecting the used remediation material.

10. The method of claim 9 further comprising;
applying the used remediation material to soil as a fertilizer.

11. The method of claim 10 wherein the nutrient comprises a phosphorous containing compound, a selenium containing compound, or a combination thereof.

12. The method of claim 1, wherein the aqueous medium comprises surface water or groundwater, and wherein the contaminant comprises arsenic.

13. The method of claim 12 wherein the aqueous medium comprises an aquifer or well water.

14. A method for increasing the nutrient content of a soil, the method comprising:
applying a remediation material comprising bare nanoscale zero-valent iron (NZVI) particles or Ca-alginate entrapped NZVI, and at least one sorbed nutrient, to a soil.

15. The method of claim 14 wherein the nutrient comprises a phosphorous containing compound or selenium containing compound, or combination thereof.

16. The method of claim 14 further comprising transporting the remediation material to the soil application site.

17. The method of claim 14, wherein a plant disposed in the soil takes up at least one nutrient from the remediation material, wherein the nutrient is selected from the group consisting of phosphorus, selenium and iron, or a combination thereof.

18. The method of claim 14 wherein the nutrient is released over time as the remediation material degrades.

19. A method for making a fertilizer comprising collecting from a remediation site a remediation material comprising bare nanoscale zero-valent iron (NZVI) particles or Ca-alginate entrapped NZVI, and at least one sorbed contaminant, wherein contaminant comprises a nutrient.

20. The method of claim 19 wherein the nutrient comprises a phosphorous containing compound, a selenium containing compound, or a combination thereof.

21. A fertilizer composition comprising bare nanoscale zero-valent iron (NZVI) particles or Ca-alginate entrapped NZVI, and at least one sorbed contaminant, wherein contaminant comprises a nutrient.

22. The fertilizer composition of claim 21 wherein the nutrient comprises a phosphorous containing compound, a selenium containing compound, or a combination thereof.

23. A method for increasing the amount of bioavailable phosphate, selenium or iron, or combination thereof, in a soil, the method comprising contacting the soil with the fertilizer composition of claim 21.

24. A method for making a fertilizer comprising:
identifying an aqueous medium comprising a phosphorus-containing compound or a selenium containing compound, or both;
contacting the aqueous medium with a remediation material comprising bare nanoscale zero-valent iron (NZVI) particles or Ca-alginate entrapped NZVI, under conditions and for a time effective to sorb the compound onto the remediation material to yield a charged remediation material; and
incorporating the charged remediation material into a fertilizer composition.

25. (canceled)
